(19) United States
(12) Patent Application Publication
(10) Pub. No.: US 2007/0148570 A1
(43) Pub. Date: Jun. 28, 2007

(54) Electrophotographic photoreceptor, process cartridge and image-forming apparatus

(75) Inventors: Masahiro Iwasaki, Kanagawa (JP); Katumi Nukada, Kanagawa (JP); Wataru Yamada, Kanagawa (JP); Kazuya Hongo, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/390,123

(22) Filed: Mar. 28, 2006

(30) Foreign Application Priority Data
Dec. 26, 2005 (JP) 2005-373131

(51) Int. Cl. G03G 5/047; G03G 5/147

(52) U.S. Cl. 430/58.75; 430/58.65; 430/59.6; 430/59.4; 399/159

(57) ABSTRACT

An electrophotographic photoreceptor comprising: a conductive support; and a photosensitive layer, wherein the photosensitive layer comprises a first functional layer comprising a cured product of a composition that contains a compound represented by formula (I):
F [symbol] L-O—R)ₙ (I) wherein in formula (I), F represents a hole-transporting n-valent organic group; R represents a monovalent organic group; L represents an alkylene group; and n indicates an integer of from 1 to 4.

### BACKGROUND OF THE INVENTION

1. Field of the Invention

The present invention relates to an electrophotographic photoreceptor, a process cartridge, and an image-forming apparatus.

2. Description of the Related Art

With the recent technical development of the constitutive members and systems thereof, a xerographic image-forming apparatus that comprises an electrophotographic photoreceptor (hereinafter this may be simply referred to as “photoreceptor”), a charging device, an exposing device, a developing device, a transfer device and a fixing device is being much improved for its higher speed and longer life operability. With that, the requirements for high-speed operability and high reliability of the respective sub-systems of the apparatus are increasing more than before. In particular, the photoreceptor for image writing thereon and the cleaning member for cleaning the photoreceptor receive more stress than any other members owing to their mutual sliding to each other, and are often scratched, worn or cracked to cause image defects. Accordingly, the requirements for high-speed operability and high reliability of these devices are severer than those of any others.

On the other hand, the requirement for high quality image formation is also increasing. To satisfy the requirement, the particle size of toner is reduced, the particle size distribution thereof is unified and the sphericity thereof is increased. As one type of the toner that satisfies the quality level, a chemical toner is being much developed, which is produced in a solvent consisting essentially of water. As a result, toner images that are on a photographic image level have become obtained these days.

For preventing a photoreceptor from being scratched or worn, there is known a method of coating it with a protective layer of high mechanical strength. For example, in JP-A 2002-82469 and JP-A 2003-186234, there is proposed a photoreceptor coated with a protective layer that contains a phenolic resin and a charge-transporting substance for prolonging the life of the photoreceptor.

### SUMMARY OF THE INVENTION

However, the electrophotographic photoreceptor having a surface-protective layer that comprises a phenolic resin, described in JP-A 2002-82469 and JP-A 2003-186234 above, may be problematic in that its electric properties will be extremely worsened depending on the curing condition employed for it. When the photoreceptor of the type is repeatedly charged and exposed to light, then the residual potential of the photoreceptor may increase and the charging potential thereof may attenuate, therefore causing a problem in that it may give image defects in long-term image formation with it. Apart from the photoreceptor described in JP-A 2002-82469 and JP-A 2003-186234 above, others are also required to be able to sufficiently prevent the fluctuation of the residual potential and the charging potential of the photoreceptors while used for long, for the purpose of stably obtaining images of good quality.

The present invention has been made in consideration of the problems with the related art mentioned above, and provides an electrophotographic photoreceptor capable of sufficiently preventing the fluctuation of the residual potential and the charging potential thereof while used for long and capable of stably forming images of good quality for a long period of time, and to provide a process cartridge and an image-forming apparatus comprising the photoreceptor.

The invention provides: an electrophotographic photoreceptor comprising:

a conductive support; and

a photosensitive layer,

wherein the photosensitive layer comprises a first functional layer comprising a cured product of a composition that contains a compound represented by formula (I):
F [symbol] L-O—R)ₙ (I)

wherein in formula (I), F represents a hole-transporting n-valent organic group;

R represents a monovalent organic group;

L represents an alkylene group; and

n indicates an integer of from 1 to 4,

a process cartridge comprising:

an electrophotographic photoreceptor comprising:
a conductive support; and
a photosensitive layer,
wherein the photosensitive layer comprises a first functional layer comprising a cured product of a composition that contains a compound represented by formula (I); and

at least one selected from a charging device that charges the electrophotographic photoreceptor, a developing device that develops an electrostatic latent image formed on the electrophotographic photoreceptor with a toner to thereby form a toner image and a cleaning device that removes a toner that remains on a surface of the electrophotographic photoreceptor:
F [symbol] L-O—R)ₙ (I)

wherein in formula (I), F represents a hole-transporting n-valent organic group;

R represents a monovalent organic group;

L represents an alkylene group; and

n indicates an integer of from 1 to 4, and

an image-forming apparatus comprising:

an electrophotographic photoreceptor comprising:
a conductive support; and
a photosensitive layer,
wherein the photosensitive layer comprises a first functional layer comprising a cured product of a composition that contains a compound represented by formula (I);

a charging device that charges the electrophotographic photoreceptor;

an exposing device that exposes a charged electrophotographic photoreceptor to light to thereby form an electrostatic latent image thereon;

a developing device that develops the electrostatic latent image with a toner to form a toner image; and

a transfer device that transfers the toner image from the electrophotographic photoreceptor onto a transfer medium:
F [symbol] L-O—R)ₙ (I)

wherein in formula (I), F represents a hole-transporting n-valent organic group;

R represents a monovalent organic group;

L represents an alkylene group; and

n indicates an integer of from 1 to 4.

### BRIEF DESCRIPTION OF THE DRAWINGS

Preferred embodiments of the present invention will be described in detail based on the following figures, wherein:

FIG. 1 is a schematic cross-sectional view showing one preferred embodiment of the electrophotographic photoreceptor of the invention;

FIG. 2 is a schematic cross-sectional view showing another preferred embodiment of the electrophotographic photoreceptor of the invention;

FIG. 3 is a schematic cross-sectional view showing still another preferred embodiment of the electrophotographic photoreceptor of the invention;

FIG. 4 is a schematic cross-sectional view showing still another preferred embodiment of the electrophotographic photoreceptor of the invention;

FIG. 5 is a schematic cross-sectional view showing still another preferred embodiment of the electrophotographic photoreceptor of the invention;

FIG. 6 is a schematic view showing one preferred embodiment of the image-forming apparatus of the invention;

FIG. 7 is a schematic view showing another preferred embodiment of the image-forming apparatus of the invention;

FIG. 8 is a schematic view showing still another preferred embodiment of the image-forming apparatus of the invention;

FIG. 9 is a schematic view showing still another preferred embodiment of the image-forming apparatus of the invention;

FIG. 10 is an IR spectrum of compound (I-10);

FIG. 11 is an IR spectrum of compound (I-1);

FIG. 12 is a powdery X-ray diffraction pattern of the I-type hydroxygallium phthalocyanine pigment produced in Example;

FIG. 13 is a powdery X-ray diffraction pattern of the hydroxygallium phthalocyanine pigment HPC-1 produced in Example;

FIG. 14 is an absorption spectrum of the hydroxygallium phthalocyanine pigment HPC-1 produced in Example.

### DETAILED DESCRIPTION OF THE INVENTION

Preferred embodiments of the invention are described below with reference to the drawings attached hereto. In the description of the drawings, the same or the corresponding elements are indicated by the same reference numeral and redundant explanations are omitted.

(Electrophotographic Photoreceptor)

The electrophotographic photoreceptor of the invention is characterized in that it has a first functional layer that contains a cured product of a compound containing a compound of formula (I). Preferably, the outermost layer of the electrophotographic photoreceptor is the first functional layer. Preferred embodiments of the electrophotographic photoreceptor of the invention are described below.

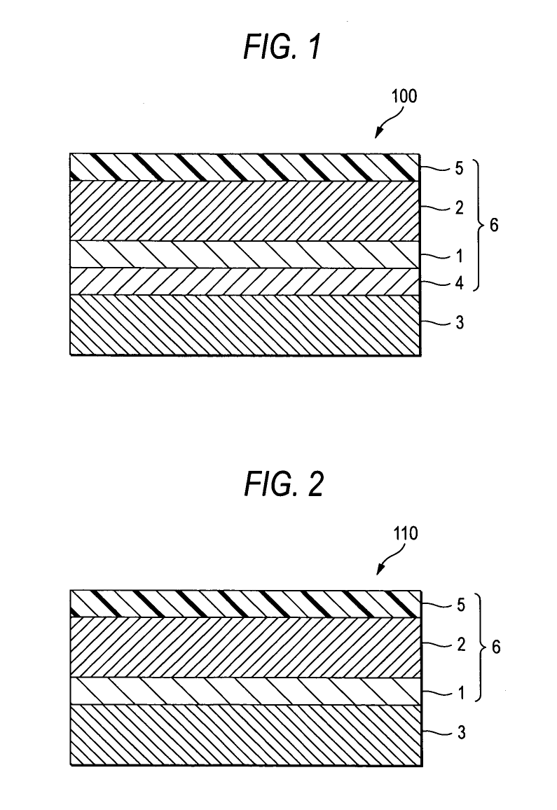

FIG. 1 is a schematic cross-sectional view showing one preferred embodiment of the electrophotographic photoreceptor of the invention. As in FIG. 1, the electrophotographic photoreceptor 100 is a function-separated photoreceptor (or laminate photoreceptor), which comprises an undercoat layer 4, a charge generation layer 1, a charge transport layer 2 and a protective layer 5 laminated on a conductive support in that order. In the electrophotographic photoreceptor 100, the undercoat layer 4, the charge generation layer 1, the charge transport layer 2 and the protective layer 5 constitute a photosensitive layer 6. In the electrophotographic photoreceptor 100, the protective layer 5 is the outermost surface layer disposed remotest from the conductive support 3 , and this is the first functional layer of a cured product of a composition that contains a compound of formula (I). The constitutive elements of the electrophotographic photoreceptor 100 are described below.

The conductive support 3 may be, for example, a metal plate, a metal drum or a metal belt formed of a metal such as aluminium, copper, zinc, stainless, chromium, nickel, molybdenum, vanadium, indium, gold or platinum, or their alloy; or paper, or a plastic film or belt coated, deposited or laminated with a conductive compound such as conductive polymer or indium oxide or with a metal such as aluminium, palladium or gold or their alloy.

When the electrophotographic photoreceptor 100 is used in laser printers, then it is desirable that the surface of the conductive support 3 is roughened to have a centerline average roughness, Ra of from 0.04 μm to 0.5 μm for preventing interference fringes that may occur in irradiation with laser light. If the surface Ra of the conductive support 3 is smaller than 0.04 μm, then it is near to a mirror face condition and its interference-preventing effect will be insufficient. On the other hand, if Ra is larger than 0.5 μm, then the image quality may be poor. When non-interference light is used as a light source, the surface-roughening treatment for interference fringe prevention is not always necessary and defects to be caused by the surface roughness of the substrate may be prevented. Accordingly, this is suitable for life prolongation.

For roughening the surface of the conductive support 3 , for example, preferably employed is a wet-honing method of jetting an abrasive suspension in water to the support; a centerless grinding method of pressing the support against a rotating grindstone for continuously grinding it; or a method of anodic oxidation.

The anodic oxidation for surface roughing treatment comprises processing the aluminium surface of a support in an electrolytic solution in which the aluminium acts as an anode for anodic oxidation to form an oxide film on the aluminium surface. The electrolytic solution includes sulfuric acid solution and oxalic acid solution. As it is, however, the porous oxide film formed through such anodic oxidation is chemically active and is readily polluted, and in addition, its environment-dependent resistance fluctuation is great. Accordingly, the oxide film formed through anodic oxidation is further processed for hydration with pressure steam or in boiling water (optionally a metal salt of nickel or the like may be added to it) to attain volume expansion for sealing up the fine pores of the film, whereby the oxide film is converted into a more stable hydrate oxide film.

Preferably, the thickness of the oxide film in anodic oxidation is from 0.3 to 15 μm. If it is smaller than 0.3 μm, then the barrier property of the film against injection is poor and its effect may be unsatisfactory. On the other hand, if it is larger than 15 μm, then it may cause residual potential increase in repeated use.

The conductive support 3 may be processed with an aqueous acid solution or may be processed for boehmite treatment. The treatment with an acid solution comprising phosphoric acid, chromic acid and hydrofluoric acid may be effected as follows: The acid solution is prepared. The blend ratio of phosphoric acid, chromic acid and hydrofluoric acid to form the acid solution is preferably as follows: Phosphoric acid is from 10 to 11% by weight, chromic acid is from 3 to 5% by weight, and hydrofluoric acid is from 0.5 to 2% by weight The overall acid concentration of these is preferably from 13.5 to 18% by weight. The processing temperature is preferably from 42 to 48° C. At a higher temperature, a thicker film may be formed more rapidly. Preferably, the thickness of the film is from 0.3 to 15 μm. If it is smaller than 0.3 μm, then its barrier property against injection is poor and its effect may be insufficient. On the other hand, if it is larger than 15 μm, then it may cause residual potential increase in repeated use.

The boehmite treatment may be attained by dipping the support in pure water at 90 to 100° C. for 5 to 60 minutes, or by contacting the support with heated steam at 90 to 120° C. for 5 to 60 minutes. Preferably, the thickness of the film is from 0.1 to 5 μm. This may be further processed for anodic oxidation with an electrolytic solution of low film dissolution ability, such as a solution of adipic acid, boric acid, borate, phosphate, phthalate, maleate, benzoate, tartrate or citrate.

The undercoat layer 4 is formed, containing, for example, an organic metal compound and/or a binder resin.

The organic metal compound includes organozirconium compounds such as zirconium chelate compounds, zirconium alkoxide compounds, zirconium coupling agents; organotitanium compounds such as titanium chelate compounds, titanium alkoxide compounds, titanium coupling agents; organoaluminium compounds such as aluminium chelate compounds, aluminium coupling agents, as well as antimony alkoxide compounds, germanium alkoxide compounds, indium alkoxide compounds, indium chelate compounds, manganese alkoxide compounds, manganese chelate compounds, tin alkoxide compounds, tin chelate compounds, aluminium silicon alkoxide compounds, aluminium titanium alkoxide compounds, aluminium zirconium alkoxide compounds. As the organic metal compound, especially preferred are organozirconium compounds, organotitanium compounds and organoaluminium compounds since their residual potential is low and they enable good electrophotographic properties.

The binder resin may be any known one, including, for example, polyvinyl alcohol, polyvinyl methyl ether, poly-N-vinylimidazole, polyethylene oxide, ethyl cellulose, methyl cellulose, ethylene-acrylic acid copolymer, polyamide, polyimide, casein, gelatin, polyethylene, polyester, phenolic resin, vinyl chloride-vinyl acetate copolymer, epoxy resin, polyvinylpyrrolidone, polyvinylpyridine, polyurethane, polyglutamic acid, polyacrylic acid. When two or more of these are combined for use herein, their blend ratio may be suitably determined.

The undercoat layer 4 may contain a silane-coupling agent such as vinyltrichlorosilane, vinyltrimethoxysilane, vinyltriethoxysilane, vinyl-tris-2-methoxyethoxysilane, vinyltriacetoxysilane, γ-glycidoxypropyltrimethoxysilane, γ-methacryloxypropyltrimethoxysilane, γ-aminopropyltriethoxysilane, γ-chloropropyltrimethoxysilane, γ-2-aminoethylaminopropyltrimethoxysilane, γ-mercaptopropyltrimethoxysilane, γ-ureidopropyltriethoxysilane, β-3,4-epoxycyclohexyltrimethoxysilane.

For residual potential reduction and for environmental stability, an electron-transporting pigment may be mixed/dispersed in the undercoat layer 4. The electron-transporting pigment includes organic pigments such as perylene pigments, bisbenzimidazoleperylene pigments, polycyclic quinone pigments, indigo pigments and quinacridone pigments described in JP-A 47-30330; other organic pigments such as bisazo pigments and phthalocyanine pigments that have an electron-attracting substituent such as a cyano group, a nitro group, a nitroso group or a halogen atom; and inorganic pigments such as zinc oxide, titanium oxide. Of those, preferred for use herein are perylene pigments, bisbenzimidazoleperylene pigments, polycyclic quinone pigments, zinc oxide and titanium oxide, as their electron mobility is high.

The pigment surface may be processed with a coupling agent or a binder resin such as those mentioned hereinabove for the purpose of controlling the dispersibility and the charge transportability of the pigment. If too much, the electron-transporting pigment may lower the strength of the undercoat layer and may cause film defects. Therefore, the content of the pigment is preferably at most 95% by weight, more preferably at most 90% by weight.

Various organic compound powder or inorganic compound powder may be added to the undercoat layer 4 for the purpose of improving the electric properties and the light-scatterability of the layer. In particular, inorganic pigments, for example, white pigments such as titanium oxide, zinc oxide, zinc flower, zinc sulfide, lead white or lithopone, or body pigments such as alumina, calcium carbonate or barium sulfate, as well as polytetrafluoroethylene resin particles, benzoguanamine resin particles and styrene particles are effective. Preferably, the particle size of the additive powder is from 0.01 to 2 μm. The additive powder is optionally added to the layer, if desired. Its amount is preferably from 10 to 90% by weight, more preferably from 30 to 80% by weight based on the total solid content by weight of the undercoat layer 4.

Adding an electron-transporting substance and an electron-transporting pigment to the undercoat layer 4 may be effective for residual potential reduction and for environmental stability.

The undercoat layer 4 is formed, using an undercoat layer-forming solution that contains the above-mentioned constitutive materials.

For mixing and/or dispersing the undercoat layer-forming solution, any ordinary method may be employed, using, for example, a ball mill, a roll mill, a sand mill, an attritor, a shaking ball mill, a colloid mill, a paint shaker, or ultrasonic waves. Mixing and/or dispersing it may be effected in an organic solvent. The organic solvent may be any one that can dissolve an organic metal compound and a binder resin not causing gellation or aggregation when an electron-transporting pigment is mixed and/or dispersed in the solution. The organic solvent may be any ordinary one, including, for example, methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, toluene. One or more of these may be used herein either singly or as combined.

The coating method for forming the undercoat layer 4 may be any ordinary one, including, for example, a blade coating method, a Meyer bar coating method, a spraying method, a dipping method, a bead coating method, an air knife coating method, a curtain coating method.

After applied to the substrate, the coating layer is dried to form the intended undercoat layer 4. In general, drying the layer may be effected at a temperature at which the solvent may be evaporated away to form a film. In particular, the conductive support 3 processed with an acid solution or processed for boehmite treatment may have an insufficient ability to cover the defects of the substrate, and it is desirable that the undercoat layer 4 is formed on the support of the type.

Preferably, the thickness of the undercoat layer 4 is from 0.01 to 30 μm, more preferably from 0.05 to 30 μm, even more preferably from 0.1 to 30 μm, still more preferably from 0.2 to 25 μm.

The charge generation layer 1 is formed, containing a charge-generating material or containing both a charge-generating material and a binder resin.

The charge-generating material may be any known one with no specific limitation, including, for example, organic pigments, e.g., azo pigments such as bisazo pigments, trisazo pigments, condensed cyclic aromatic pigments such as dibromoanthanthrone pigments, as well as perylene pigments, pyrrolopyrole pigments, phthalocyanine pigments; and inorganic pigments such as trigonal system selenium, zinc oxide. In particular, when a light source having an exposure wavelength of from 380 to 500 nm is used, then inorganic pigments are preferred for the charge-generating material; but when a light source having an exposure wavelength of from 700 to 800 nm is used, then metal or non-metal phthalocyanine pigments are preferred. Above all, more preferred are hydroxygallium phthalocyanine as in JP-A 5-263007, 5-279591; chlorogallium phthalocyanine as in JP-A 5-98181; dichlorotin phthalocyanine as in JP-A 5-140472, 5-140473; and titanyl phthalocyanine as in JP-A 4-189873, 5-43813.

Preferably, the charge generation layer 1 is a layer (second functional layer) that contains a hydroxygallium phthalocyanine pigment having a maximum peak wavelength within a range of from 810 to 839 nm in its absorption spectrum within a wavelength range of from 600 to 900 nm. The specific hydroxygallium phthalocyanine pigment differs from a conventional V-type hydroxygallium phthalocyanine pigment. More preferably, the hydroxygallium phthalocyanine pigment for use herein has a maximum peak wavelength within a range of from 810 to 835 nm. To that effect, the maximum peak wavelength of the absorption spectrum of the hydroxygallium phthalocyanine pigment for use herein is shifted to the side of a shorter wavelength range than that of a conventional V-type hydroxygallium phthalocyanine pigment, and as a result, the crystal alignment of the pigment particles of the resulting hydroxygallium phthalocyanine pigment may be suitably controlled, and when the pigment is used as a material in the electrophotographic photoreceptor of the invention, then it ensures good dispersibility, sufficient sensitivity and good chargeability of the photoreceptor and suppresses the dark decay of the photoreceptor.

In a phthalocyanine pigment, in general, the phthalocyanine intermolecular interaction changes depending on the molecular alignment in the pigment crystals, and, as a result, the molecular alignment state of the crystal is reflected in the spectrum thereof. When a V-type hydroxygallium phthalocyanine produced according to a conventional method has an absorption maximum within a range of from 840 to 870 nm, then its absorption extends toward the side of longer wavelength. This means that the intermolecular interaction of the pigment is strong, and, accordingly, charges may readily run through the pigment crystals, therefore probably causing dark current increase and fog increase. By controlling the condition in crystal formation so as to control the molecular alignment in the crystal formed, the resulting hydroxygallium phthalocyanine pigment may have an absorption maximum within a range of from 810 to 839 nm, and it has become possible to obtain excellent electrophotographic characteristics and image quality characteristics by the use of the specific hydroxygallium phthalocyanine pigment. It is presumed that the absorption spectrum of the hydroxygallium phthalocyanine pigment of the type may be shifted toward the side of longer wavelength since the crystal alignment of the pigment particles is suitably controlled and since the pigment particles are fine enough for good dispersion thereof.

Preferably, the mean primary particle size of the specific hydroxygallium phthalocyanine pigment for use in the invention is at most 0.10 μm, more preferably at most 0.08 μm. Also preferably, the specific surface area of the pigment according to a BET process is at least 45 m²/g, more preferably at least 50 m²/g, even more preferably at least 55 m²/g. When the mean primary particle size is larger than 0.10 μm or when the specific surface area is slammer than 45 m²/g, then the particles may be coarse or the particles may form aggregates, and if so, there may occur defects in point of the electrophotographic characteristics and the image quality characteristics of the pigment.

For producing the specific hydroxygallium phthalocyanine pigment for use in the invention, herein employable is a method of wet-grinding an I-type hydroxygallium phthalocyanine in a solvent for crystal form conversion. In the production method, the hydroxygallium phthalocyanine pigment being processed is so controlled that its absorption spectrum could have an absorption maximum within a range of from 810 to 839 nm by monitoring the crystal conversion in the wet-ground pigment liquid through determination of the absorption wavelength data of the pigment, whereby the wet-grinding time for the pigment may be determined. Accordingly, in the method, the intended specific hydroxygallium phthalocyanine pigment having an absorption maximum within a range of from 810 to 839 nm may be obtained.

The specific hydroxygallium phthalocyanine pigment obtained in the above-mentioned method may have a sufficiently small and uniform particle size. Accordingly, when the hydroxygallium phthalocyanine pigment is used as a material of the photosensitive layer of an electrophotographic photoreceptor and when the electrophotographic photoreceptor is designed to have a surface protective layer mentioned hereinunder, then the electrophotographic photoreceptor may attain sufficient sensitivity and chargeability and its dark decay may be lowered, and the electrophotographic photoreceptor may produce images of good quality with no defect for a long period of time.

Preferably, the specific hydroxygallium phthalocyanine pigment has diffraction peaks at a Bragg angle (2θ±0.2°) of 7.5°, 9.9°, 12.5°, 16.3°, 18.6°, 25.1° and 28.3° in the X-ray diffraction spectrum thereof with a CuKα characteristic X ray. More preferably, the half-value width of the diffraction peak at 7.5° of the pigment is from 0.35 to 1.20°. If the half-value width of the diffraction peak at 7.5° thereof is not within the range as above, then the hydroxygallium phthalocyanine pigment particles may re-aggregate and their dispersibility may lower, and, as a result, the sensitivity of the electrophotogtaphic photoreceptor comprising the pigment may lower and the photoreceptor may give image defects such as fogging. The high-sensitivity V-type hydroxygallium phthalocyanine that is produced according to a conventional method, as in Journal of Imaging Science and Technology, Vol. 40, No. 3, May/June, 249 (1996), and JP-A 5-263007 and 7-53892, has diffraction peaks at a Bragg angle (2θ±0.2°) of 7.5°, 9.9°, 12.5°, 16.3°, 18.6°, 25.1° and 28.3° in the X-ray diffraction spectrum thereof with a CuKα characteristic X ray, but the half-value width of the characteristic diffraction peak thereof at 7.5° is less than 0.35, and it is obvious that the specific hydroxygallium phthalocyanine pigment for use in the invention differs from the conventional pigment.

In the above-mentioned production method for the hydroxygallium phthalocyanine pigment for use herein, the starting I-type hydroxygallium phthalocyanine may be obtained in any conventional known method. One example is described below.

First, coarse gallium phthalocyanine is produced according to a method of reacting o-phthalodinitrile or 1,3-diiminoisoindoline and gallium trichloride in a predetermined solvent (I-type chlorogallium phthalocyanine method); or a method of reacting o-phthalodinitrile, alkoxygallium and ethylene glycol under heat in a predetermined solvent to produce a phthalocyanine dimer (phthalocyanine dimer method). The solvent for the reaction is preferably an inert and high-boiling-point solvent such as α-chloronaphthalene, β-chloronaphthalene, α-methylnaphthalene, methoxynaphthalene, dimethylaminoethanol, diphenylethane, ethylene glycol dialkyl ether, quinoline, sulforane, dichlorobenzene, dimethylformamide, dimethylsulfoxide, dimethylsulfamide.

Next, the coarse gallium phthalocyanine obtained in the above step is processed for acid pasting, whereby the coarse gallium phthalocyanine is ground into fine particles and is converted into I-type hydroxygallium phthalocyanine pigment. The acid pasting treatment is concretely as follows: The coarse gallium phthalocyanine is dissolved in an acid such as sulfuric acid, or is converted into an acid salt such as sulfate, and then this is poured into an aqueous alkali solution, water or ice-water for recrystallization. The acid for the acid pasting treatment is preferably sulfuric acid, more preferably sulfuric acid having a concentration of from 70 to 100% (even more preferably from 95 to 100%).

The hydroxygallium phthalocyanine pigment for use in the invention may be obtained by wet-grinding the I-type hydroxygallium phthalocyanine pigment that had been produced through the above-mentioned acid pasting treatment, in a solvent for crystal conversion. Preferably, the wet-grinding treatment is effected in a grinding device using spherical media having an outer diameter of from 0.1 to 3.0 mm, more preferably using spherical media having an outer diameter of from 0.2 to 2.5 mm. If the outer diameter of the media is larger than 3.0 mm, then the grinding efficiency may lower and therefore the ground particles could not have a small particle size but may form aggregates. On the other hand, if the outer diameter of the media is smaller than 0.1 mm, then the separation of the media from the hydroxygallium phthalocyanine would be difficult. Further, when the media are not spherical but have any other form, for example, columnar or amorphous, then their grinding efficiency may lower and, in addition, the media may be readily worn during grinding with them, and the worn powder may be an impurity to contaminate the hydroxygallium phthalocyanine pigment to worsen the characteristics of the pigment.

Not specifically defined, the material of the media is preferably one not causing image defects even when it is mixed in the pigment. Its preferred examples are glass, zirconia, alumina, agate.

Also not specifically defined, the material of the wet-grinding chamber is preferably one not causing image defects even when it is mixed in the pigment. Its preferred examples are glass, zirconia, alumina, agate, polypropylene, polytetrafluoroethylene, polyphenylene sulfide. Also usable are iron, stainless or the like metal containers of which the inner surfaces are lined with glass, polypropylene, polytetrafluoroethylene or polyphenylene sulfide.

Though varying depending on the device to be used, the amount of the media to be used is preferably from 1 to 1000 parts by weight relative to 1 part by weight of the I-type hydroxygallium phthalocyanine pigment, more preferably from 10 to 100 parts by weight. The media having the same weight but having a smaller outer diameter may have an increased media density in a device, and therefore the viscosity of the mixture liquid therein may increase to change the grinding efficiency. Accordingly, with the reduction in the outer diameter of the media used, it is desirable that the amount of the media and the amount of the solvent to be used are suitably controlled so that the wet-grinding treatment may be effected in the most suitable blend ratio of the two, media and solvent.

Preferably, the wet-grinding temperature is from 0 to 100° C., more preferably from 5 to 80° C., even more preferably from 10 to 50° C. If the temperature is lower than 0° C., then the crystal transition speed may be low; but if higher than 100° C., then the solubility of the hydroxygallium phthalocyanine pigment may increase and the pigment crystal may readily grow, and, as a result, it would be difficult to grind the pigment into fine particles.

The solvent for use in the wet-grinding treatment includes amides such as N,N-dimethylformamide, N,N-dimethylacetamide, N-methylpyrrolidone; esters such as ethyl acetate, n-butyl acetate, iso-amyl acetate; ketones such as acetone, methyl ethyl ketone, methyl isobutyl ketone; and dimethylsulfoxide. Preferably, the amount of the solvent to be used is from 1 to 200 parts by weight, more preferably from 1 to 100 parts by weight relative to 1 part by weight of the hydroxygallium phthalocyanine pigment.

The wet-grinding device may be any one using dispersion media, such as a shaking mill, an automatic mortar, a sand mill, a Dyno mill, a co-ball mill, an attritor, a planet ball mill, a ball mill.

The crystal conversion speed is significantly influenced by the scale, the stirring speed and the media material in the wet-grinding step. Wet-grinding the starting hydroxygallium phthalocyanine pigment is continued until it is converted into the intended hydroxygallium phthalocyanine pigment having an absorption maximum within a range of from 810 to 839 nm, with monitoring the crystal conversion in the wet-ground pigment liquid through determination of the absorption wavelength data of the pigment so that the ground pigment may have an absorption maximum within a range of from 810 to 839 nm. In general, the wet-grinding time is preferably from 5 to 500 hours, more preferably from 7 to 300 hours. If the grinding time is shorter than 5 hours, then the crystal conversion could not be completed, and there may occur some problems in that the electrophotographic characteristics of the pigment may worsen, especially in that the sensitivity thereof may be insufficient. If the grinding time is longer than 500 hours, then the sensitivity of the ground pigment may lower owing to the influence of the grinding stress thereon, and there may occur other problems in that the producibility may lower and that the ground powder of the media may mix in the pigment. When the wet-grinding time is defined to fall within the range as above, then the hydroxygallium phthalocyanine pigment particles may be ground uniformly within the range of the thus-defined period of time, and it may be possible to inhibit quality fluctuation of pigment products in different lots when the pigment products are produced in repeated wet-grinding treatment in plural lots.

Preferably, the specific hydroxygallium phthalocyanine pigment mentioned above is incorporated into the charge generation layer 1, but may be incorporated into any other layer.

The binder resin for use in the charge generation layer 1 may be selected from a broad range of insulating resins. It may also be selected from organic photoconductive polymers such as poly-N-vinylcarbazole, polyvinylanthracene, polyvinylpyrene and polysilane. Preferred examples of the binder resin are polyvinylbutyral resins, polyarylate resins (e.g., bisphenol A/phthalic acid polycondensates), polycarbonate resins, polyester resins, phenoxy resins, vinyl chloride-vinyl acetate copolymers, polyamide resins, acrylic resins, polyacrylamide resins, polyvinylpyridine resins, cellulose resins, urethane resins, epoxy resins, casein, polyvinyl alcohol resins, polyvinylpyrrolidone resins, to which, however, the invention should not be limited. One or more such binder resins may be used herein either singly or as combined.

The charge generation layer 1 may be formed in a mode of vapor deposition with the above-mentioned charge-generating material or in a mode of coating with a charge generation layer-forming coating liquid that contains the above-mentioned charge-generating material and binder resin.

In the charge generation layer-forming coating liquid, the blend ratio (by weight) of the charge-generating material to the binder resin is preferably from 10/1 to 1/10. When the above-mentioned specific hydroxygallium phthalocyanine pigment is used as the charge-generating material, then the blend ratio (by weight) of the hydroxygallium phthalocyanine pigment to the binder resin is preferably from 40/1 to 1/4, more preferably from 20/1 to 1/2 from the viewpoint of the pigment dispersibility in the dispersion and of the sensitivity of the electrophotographic photoreceptor. The charge generation layer 1 may contain any other charge-generating material than the hydroxygallium phthalocyanine pigment, such as azo pigment, perylene pigment or condensed cyclic aromatic pigment, from the viewpoint of the sensitivity control and the dispersibility control. The other charge-generating material usable in the invention is preferably metal-containing or metal-free phthalocyanine. More preferred for it are other hydroxygallium phthalocyanine pigments than the specific hydroxygallium phthalocyanine pigment having an absorption maximum within a range of from 810 to 839 nm, and chlorogallium phthalocyanine pigments, dichlorotin phthalocyanine pigments and oxytitanylphthalocyanine pigments. Preferably, the amount of the other charge-generating material to be combined with the specific pigment is at most 50% by weight based on the overall amount by weight of the constitutive materials of the charge generation layer 1.

For dispersing the constitutive materials, employable is any ordinary method such as a ball mill dispersion method, an attritor dispersion method, or a sand mill dispersion method. In these methods, it is indispensable that the crystal form of the pigment does not change through the dispersion treatment. It has been confirmed that the crystal form of the pigment does not change before and after the dispersion according to any of the above-mentioned methods. Preferably, the dispersed particles have a particle size of at most 0.5 μm, more preferably at most 0.3 μm, even more preferably at most 0.15 μm for more effective results.

Any ordinary organic solvent may be used for the dispersion, including, for example, methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, toluene. One or more of these may be used herein either singly or as combined.

For forming the charge generation layer 1 by the use of such a charge generation layer-forming coating liquid, any ordinary coating method may be employed, including, for example, a blade coating method, a Meyer bar coating method, a spraying method, a dipping method, a bead coating method, an air knife coating method, a curtain coating method.

Preferably, the thickness of the charge generation layer 1 is from 0.1 to 5 μm, more preferably from 0.2 to 2.0 μm.

The charge transport layer 2 contains a charge-transporting material and a binder resin, or contains a charge-transporting polymer material.

The charge-transporting material includes electron-transporting compounds such as quinone compounds, e.g., p-benzoquinone, chloranil, bromanil, anthraquinone, tetracyanoquinodimethane compounds, fluorenone compounds e.g., 2,4,7-trinitrofluorenone, xanthone compounds, benzophenone compounds, cyanovinyl compounds, ethylene compounds; and hole-transporting compounds such as triarylamine compounds, benzidine compounds, arylalkane compounds, aryl-substituted ethylene compounds, stilbene compounds, anthracene compounds, hydrazone compounds. However, the invention should not be limited to these. One or more such charge-transporting materials may be used herein either singly or as combined.

In view of its mobility, the charge-transporting material is preferably a compound of the following formula (V-1), (V-2) or (V-3):

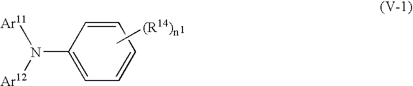

In formula (V-1), R¹⁴ represents a hydrogen atom or a methyl group; n¹ indicates 1 or 2; Ar¹¹ and Ar¹² each independently represent a substituted or unsubstituted aryl group, —C₆H₄—C(R¹⁸)═C(R¹⁹)(R²⁰) or —C₆H₄—CH═CH—CH═C(Ar)₂, and the substituent for these is a halogen atom, an alkyl group having from 1 to 5 carbon atoms, an alkoxy group having from 1 to 5 carbon atoms, or a substituted amino group substituted with an alkyl group having from 1 to 3 carbon atoms; R¹⁸, R¹⁹ and R²⁰ each independently represent a hydrogen atom, a substituted or unsubstituted alkyl group, or a substituted or unsubstituted aryl group; and Ar represents a substituted or unsubstituted aryl group.

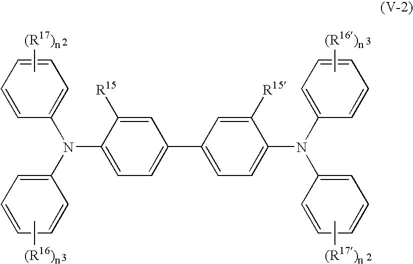

In formula (V-2), R¹⁵ and R^{15′} may be the same or different, each independently representing a hydrogen atom, a halogen atom, an alkyl group having from 1 to 5 carbon atoms, or an alkoxy group having from 1 to 5 carbon atoms; R¹⁶, R^{16′}, R¹⁷ and R^{17′} may be the same or different, each independently representing a halogen atom, an alkyl group having from 1 to 5 carbon atoms, an alkoxy group having from 1 to 5 carbon atoms, an amino group substituted with an alkyl group having 1 or 2 carbon atoms, a substituted or unsubstituted aryl group, —C₆H₄—C(R¹⁸)═C(R¹⁹)(R²⁰) or —C₆H₄—CH═CH—CH═C(Ar)₂; R¹⁸, R¹⁹ and R²⁰ each independently represent a hydrogen atom, a substituted or unsubstituted alkyl group, or a substituted or unsubstituted aryl group; Ar represents a substituted or unsubstituted aryl group; and n² and n³ each independently indicate an integer of from 0 to 2.

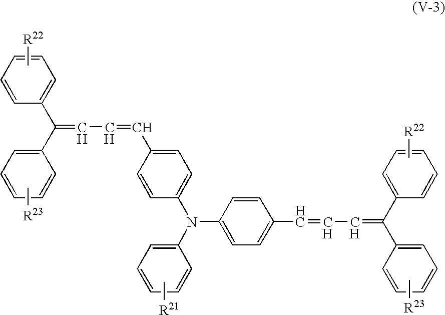

In formula (V-3), R²¹ represents a hydrogen atom, an alkyl group having from 1 to 5 carbon atoms, an alkoxy group having from 1 to 5 carbon atoms, a substituted or unsubstituted aryl group, or —C₆H₄—CH═CH—CH═C(Ar)₂; Ar represents a substituted or unsubstituted aryl group; R²² and R²³ each independently represent a hydrogen atom, a halogen atom, an alkyl group having from 1 to 5 carbon atoms, an alkoxy group having from 1 to 5 carbon atoms, an amino group substituted with an alkyl group having 1 or 2 carbon atoms, or a substituted or unsubstituted aryl group.

The binder resin includes polycarbonate resins, polyester resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, and charge-transporting polymer materials such as poly-N-vinylcarbazole, polysilane, polyester-type charge-transporting polymer materials as in JP-A 8-176293 and 8-208820. One or more such binder resins may be used herein either singly or as combined. Preferably, the blend ratio (by weight) of the charge-transporting material to the binder resin is from 10/1 to 1/5.

A charge-transporting polymer material may be used alone. The charge-transporting polymer material may be any known one having a capability of charge transportation, such as poly-N-vinylcarbazole and polysilane. In particular, polyester-type charge-transporting polymer materials as in JP-A 8-176293 and 8-208820 are especially preferred for use herein as having a high capability of charge transportation. The charge-transporting polymer material may be used by itself for the constitutive material of the charge transport layer, but may be combined with a binder resin such as that mentioned hereinabove for forming a film for the layer.

The charge transport layer 2 may be formed by the use of the charge transport layer-forming coating liquid that contains the above-mentioned constitutive materials. The solvent for the charge transport layer-forming coating liquid may be any ordinary organic solvent, including, for example, aromatic hydrocarbons such as benzene, toluene, xylene, chlorobenzene; ketones such as acetone, 2-butanone; halogenated aliphatic hydrocarbons such as methylene chloride, chloroform, ethylene chloride; cyclic or linear ethers such as tetrahydrofuran, ethyl ether. One or more such solvents may be used herein either singly or as combined. For dispersing the above-mentioned constitutive materials, any known method is employable herein.

For applying the charge transport layer-forming coating liquid onto the charge generation layer 1, employable is any ordinary method such as a blade coating method, a Meyer bar coating method, a spraying method, a dipping method, a bead coating method, an air knife coating method or a curtain coating method.

Preferably, the thickness of the charge transport layer 2 is from 5 to 50 μm, more preferably from 10 to 30 μm.

The protective layer 5 is the outermost surface layer of the electrophotographic photoreceptor 100, and this is provided for making the surface layer resistant to abrasion and scratching and for increasing the toner transfer efficiency to the photoreceptor. The protective layer 5 is a layer of a cured product of a composition that contains a compound of the following formula (I):
F [symbol] L-O—R)ₙ (I)
[In formula (I), F represents a hole-transporting n-valent organic group; R represents a monovalent organic group; L represents an alkylene group; and n indicates an integer of from 1 to 4.]

A preferred example of the compound of formula (I) is a compound of the following formula (II): 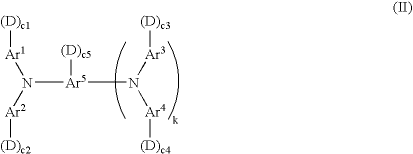
[In formula (II), Ar¹ to Ar⁴ each independently represent a substituted or unsubstituted aryl group; Ar⁵ represents a substituted or unsubstituted aryl or arylene group; c1, c2, c3, c4 an c5 each independently indicate 0 or 1; k indicates 0 or 1; D represents a monovalent organic group of the following formula (III); and the sum total of c1, c2, c3, c4 and c5 is from 1 to 4.]
-L-O—R (III)
[In formula (III), R represents a monovalent organic group; and L represents an alkylene group.]

In formulae (I) and (II), R represents a monovalent organic group, preferably a monovalent organic group having from 1 to 18 carbon atoms, more preferably a monovalent hydrocarbon group having from 1 to 18 carbon atoms and optionally substituted with a halogen atom, or a group of —(CH₂)r-O—R⁴, even more preferably an alkyl group having from 1 to 4 carbon atoms, or a group of —(CH₂)r-O—R⁴, still more preferably a methyl group. R⁴ represents a hydrocarbon group having from 1 to 6 carbon atoms, and it may form a ring, but preferably it is an aliphatic hydrocarbon group such as a methyl group, an ethyl group, a propyl group or a butyl group. r indicates an integer of from 1 to 12, preferably an integer of from 1 to 4. In formulae (I) and (II), L is preferably an optionally-branched alkylene group having from 1 to 18-carbon atoms, more preferably a methylene group. In formulae (I) and (II), plural R's or L's, if any, may be the same or different.

The substituted or unsubstituted aryl group for Ar¹ to Ar⁴ in formula (II) is preferably an aryl group of the following formulae (1) to (7):

TABLE 1

| | |
|---|---|
| | (1) |
| 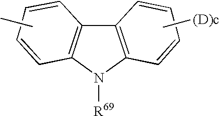 | |
| | (2) |
| 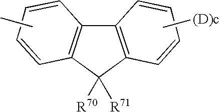 | |
| | (3) |
| 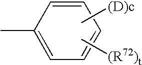 | |
| | (4) |
| 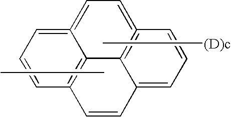 | |
| | (5) |
| 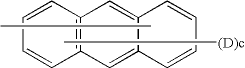 | |
| | (6) |
| 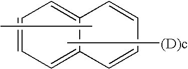 | |
| | (7) |
| —Ar-(Z′)s-Ar-(D)c | |

In formulae (1) to (7), R⁶⁹ represents a hydrogen atom, an alkyl group having from 1 to 4 carbon atoms, an alkyl group having from 1 to 4 carbon atoms, an alkoxy group having from 1 to 4 carbon atoms, a phenyl group unsubstituted or substituted with any of these, or an aralkyl group having from 7 to 10 carbon atoms; R⁷⁰ to R⁷² each represent a hydrogen atom, an alkyl group having from 1 to 4 carbon atoms, an alkoxy group having from 1 to 4 carbon atoms, an alkoxy group having from 1 to 4 carbon atoms, a phenyl group unsubstituted or substituted with any of these, an aralkyl group having from 7 to 10 carbon atoms, or a halogen atom; Ar represents a substituted or unsubstituted arylene group; D represents a group of formula (III); c corresponds to c1, c2, c3 or c4 in formula (II), indicating 0 or 1; s indicates 0 or 1; and t indicates an integer of from 1 to 3.

Ar in the aryl group of formula (7) is preferably an arylene group of the following formula (8) or (9):

TABLE 2

| | |
|---|---|
| | (8) |
| 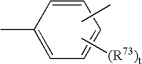 | |
| | (9) |
| 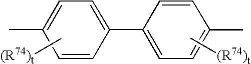 | |

In formulae (8) and (9), R⁷³ and R⁷⁴ each represent a hydrogen atom, an alkyl group having from 1 to 4 carbon atoms, an alkoxy group having from 1 to 4 carbon atoms, a phenyl group substituted with an alkoxy group having from 1 to 4 carbon atoms, an unsubstituted phenyl group, an aralkyl group having from 7 to 10 carbon atoms, or a halogen atom; and t indicates an integer of from 1 to 3.

Z′ in the aryl group of formula (7) is preferably a divalent group of the following formulae (10) to (17):

TABLE 3

| | |
|---|---|
| | (10) |
| —(CH₂)ᵥ— | |
| | (11) |
| —(CH₂CH₂O)_{w}— | |
| | (12) |
| 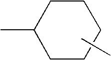 | |
| | (13) |
| 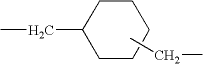 | |
| | (14) |
| 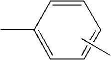 | |
| | (15) |
| 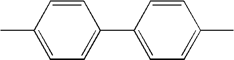 | |
| | (16) |
| 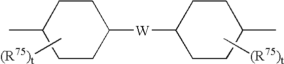 | |
| | (17) |
| 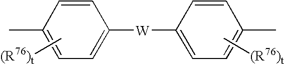 | |

In formulae (10) to (17), R⁷⁵ and R⁷⁶ each represent a hydrogen atom, an alkyl group having from 1 to 4 carbon atoms, an alkoxy group having from 1 to 4 carbon atoms, a phenyl group substituted with an alkoxy group having from 1 to 4 carbon atoms, an unsubstituted phenyl group, an aralkyl group having from 7 to 10 carbon atoms, or a halogen atom; W represents a divalent group; v and w each indicate an integer of from 1 to 10; and t indicates an integer of from 1 to 3.

In formulae (16) and (17), W is preferably a divalent group of the following formulae (18) to (26). In formula (25), u indicates an integer of from 0 to 3.

TABLE 4

| | |
|---|---|
| | (18) |
| —CH₂— | |
| | (19) |
| —C(CH₃)₂— | |
| | (20) |
| —O— | |
| | (21) |
| —S— | |
| | (22) |
| —C(CF₃)₂— | |
| | (23) |
| —Si(CH₃)₂— | |
| | (24) |
| 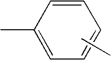 | |
| | (25) |
| 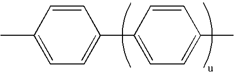 | |
| | (26) |
| 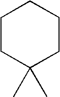 | |

Regarding the concrete structure of Ar⁵ in formula (II), it may be the same as the aryl group concretely mentioned hereinabove for Ar¹ to Ar⁴ when k is 0; but when k is 1, it is an arylene group derived from the aryl group for Ar¹ to Ar⁴ by removing a predetermined hydrogen atom from it. c in the aryl group or the arylene group for Ar⁵ corresponds to c5 in formula (II).

Examples of the compounds of formula (I) are the following compounds (I-1) to (I-59), to which, however, the compounds of formula (I) should not be limited. In the following Tables, the chemical bonds shown with no substituent at the terminal thereof are terminated with a methyl group. Herein, Me represents methyl group.

TABLE 5

| | |
|---|---|
| | (I-1) |
| 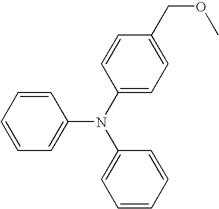 | |
| | (I-2) |
| 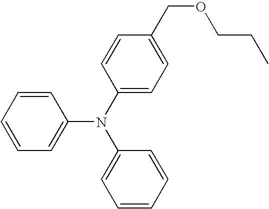 | |
| | (I-3) |
| 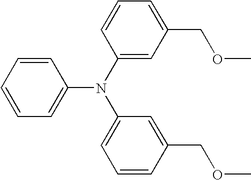 | |
| | (I-4) |
| 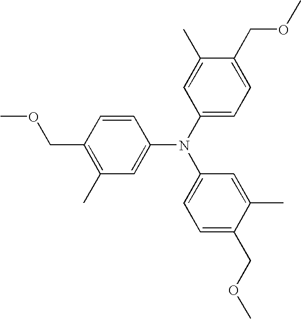 | |
| | (I-5) |
| 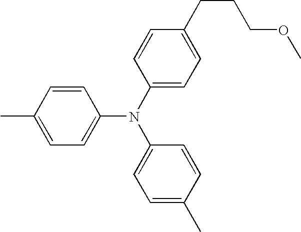 | |
| | (I-6) |
| 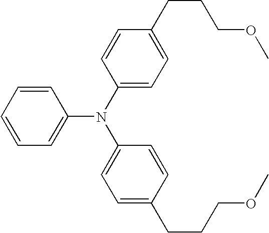 | |
| | (I-7) |
| 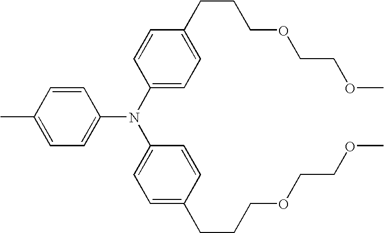 | |
| | (I-8) |
| 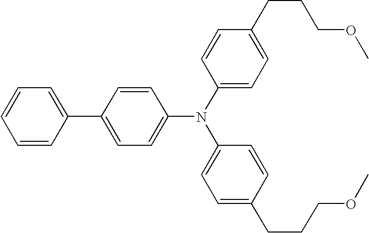 | |

TABLE 6

| | |
|---|---|
| | (I-9) |
| 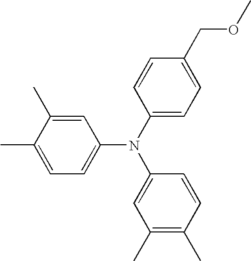 | |
| | (I-10) |
| 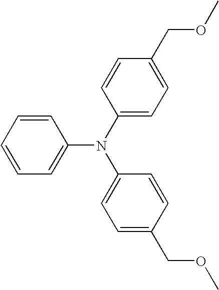 | |
| | (I-11) |
| 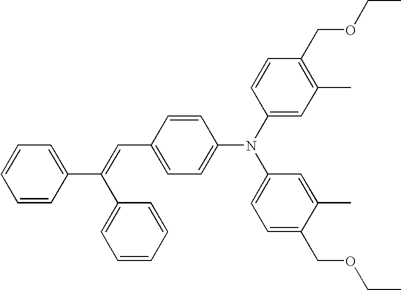 | |
| | (I-12) |
| 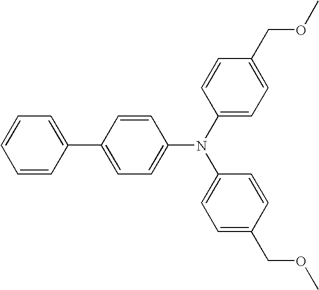 | |
| | (I-13) |
| 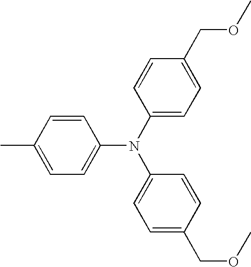 | |
| | (I-14) |
| 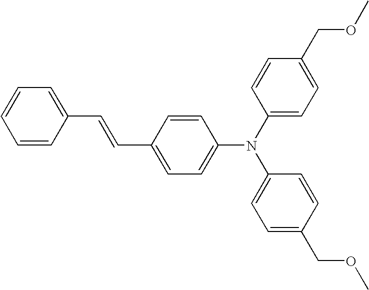 | |
| | (I-15) |
| 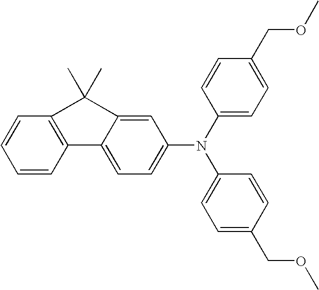 | |
| | (I-16) |

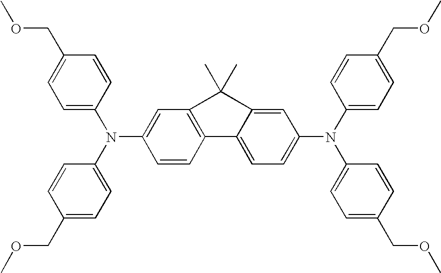

TABLE 7

(I-17)

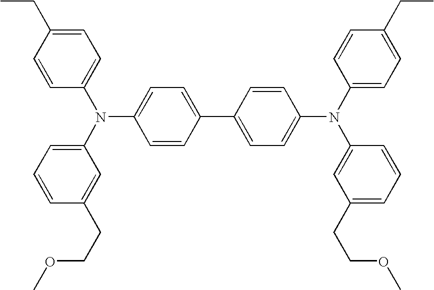

| | (I-18) |
|---|---|
| 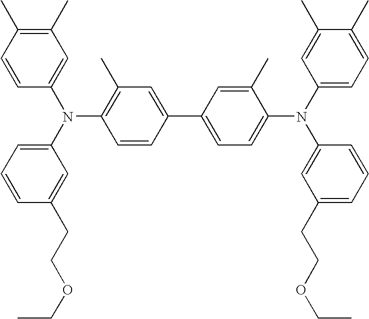 | |
| | (I-19) |

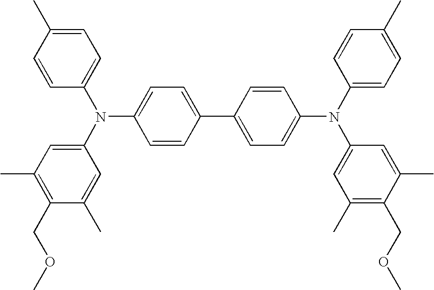

(I-20)

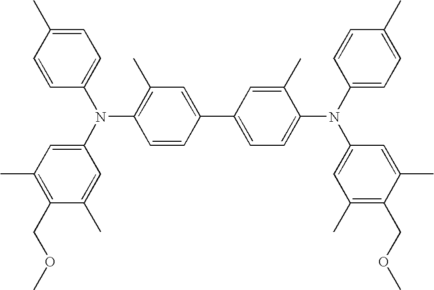

(I-21)

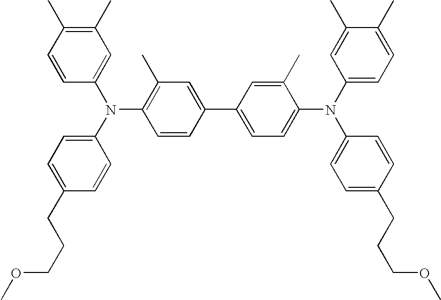

(I-22)

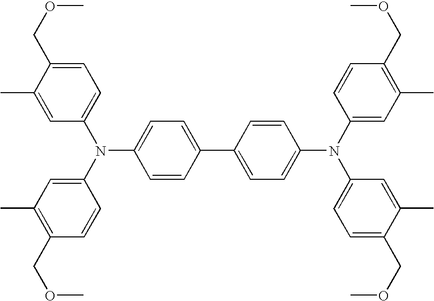

(I-23)

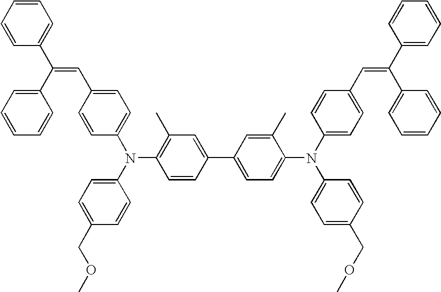

| | |
|---|---|
| | (I-24) |
| 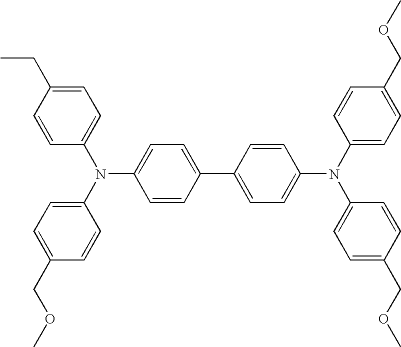 | |

TABLE 8

| | (I-25) |
|---|---|
| 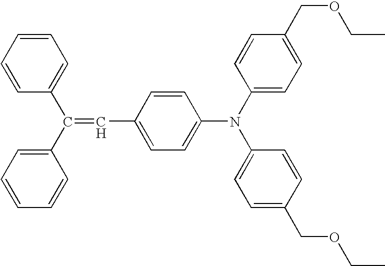 | |
| | (I-26) |

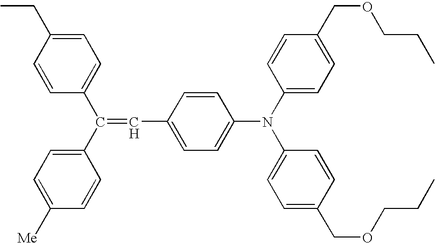

(I-27)

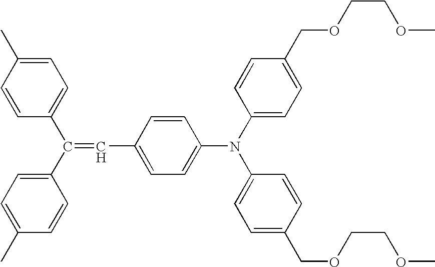

| | |
|---|---|
| | (I-28) |
| 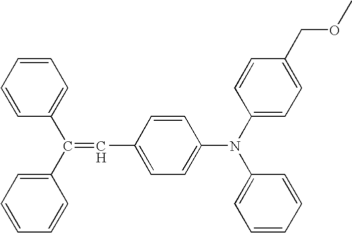 | |
| | (I-29) |
| 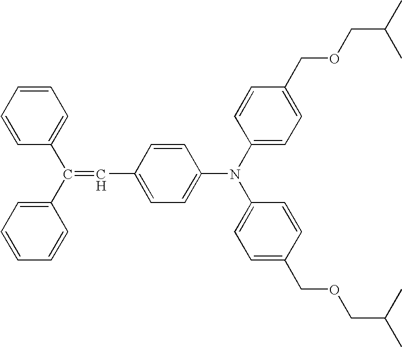 | |
| | (I-30) |
| 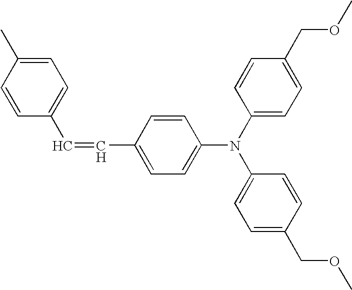 | |
| | (I-31) |
| 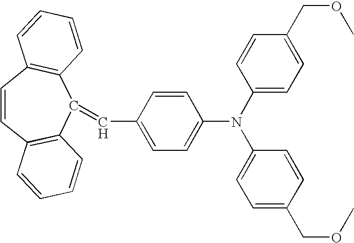 | |
| | (I-32) |
| 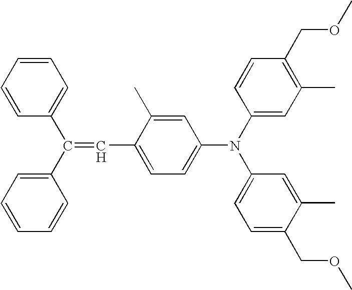 | |

TABLE 9

| | (I-33) |
|---|---|
| 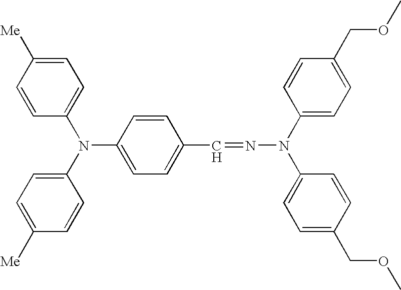 | |
| | (I-34) |
| 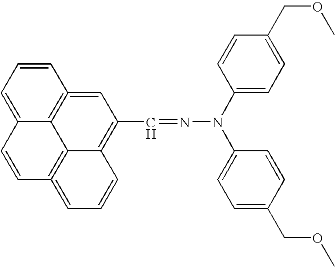 | |
| | (I-35) |

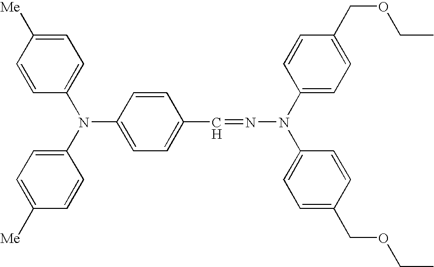

| | |
|---|---|
| | (I-36) |
| 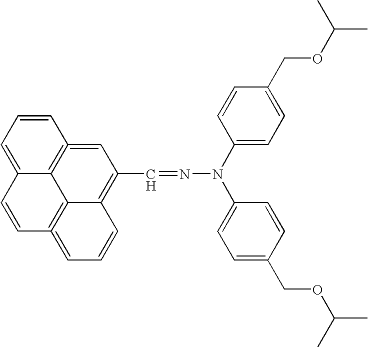 | |
| | (I-37) |
| 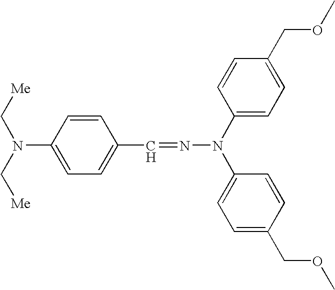 | |
| | (I-38) |
| 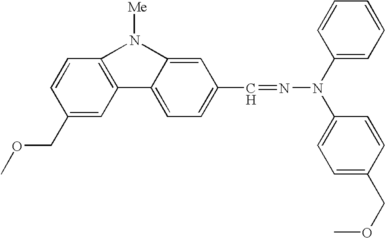 | |
| | (I-39) |
| 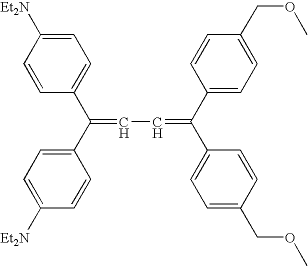 | |
| | (I-40) |
| 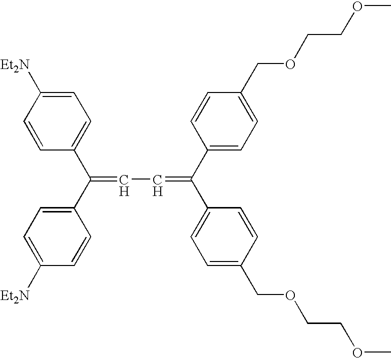 | |

TABLE 10

| | (I-41) | | (I-42) |
|---|---|---|---|
| 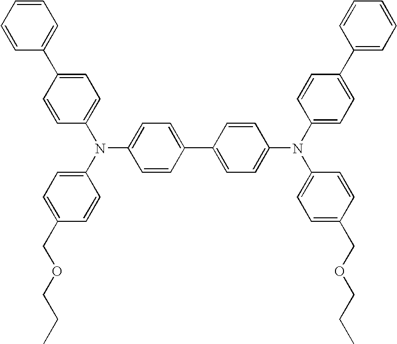 | | 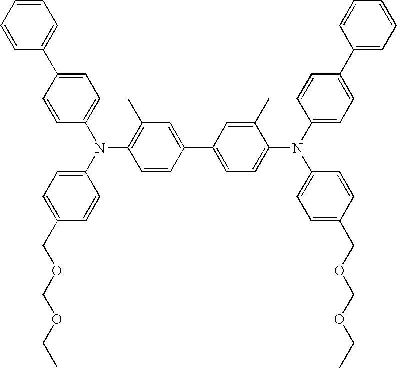 | |
| | | | (I-43) |
| 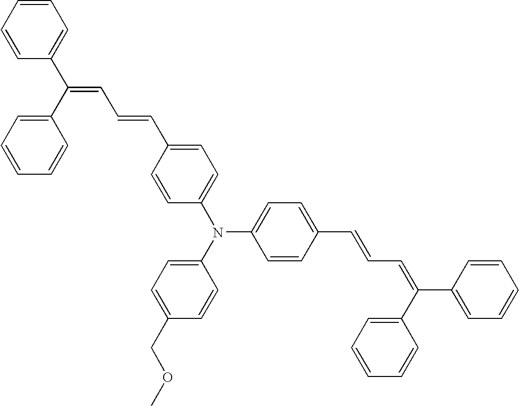 | | | |
| | | | (I-44) |
| 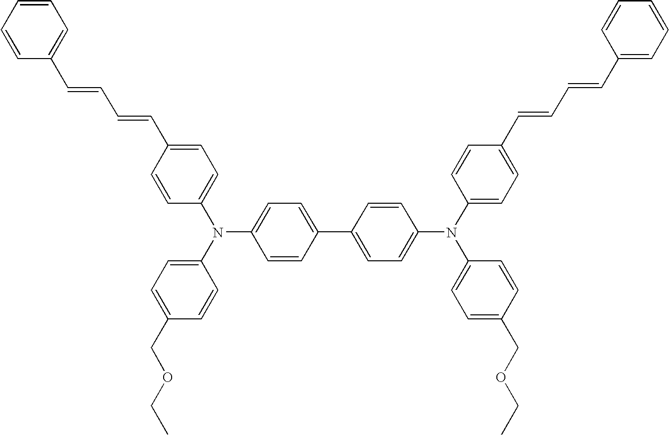 | | | |
| | (I-45) | | (I-46) |
| 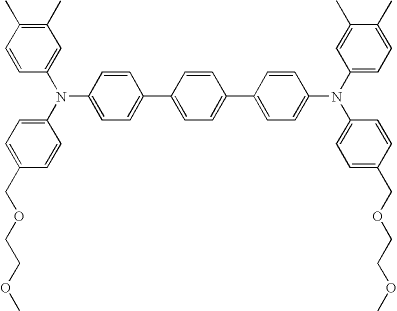 | | 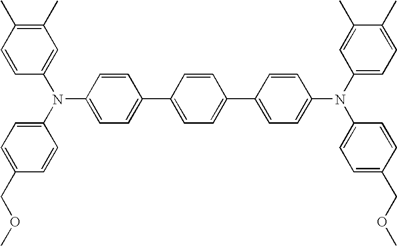 | |

TABLE 11

| | (I-47) |
|---|---|
| 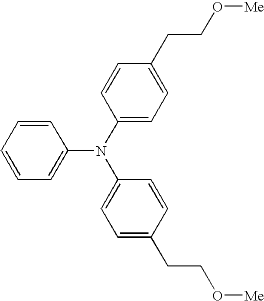 | |
| | (I-48) |
| 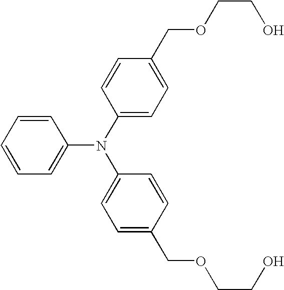 | |
| | (I-49) |
| 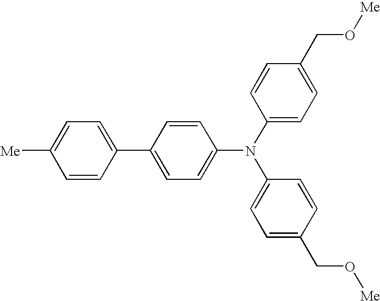 | |
| | (I-50) |
| 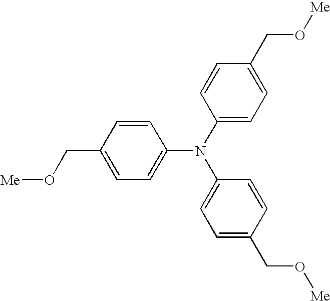 | |
| | (I-51) |

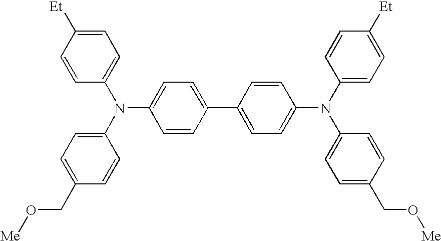

| | |
|---|---|
| | (I-52) |
| 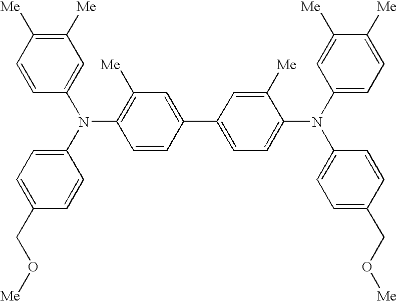 | |

TABLE 12

| | |
|---|---|
| | (I-53) |
| 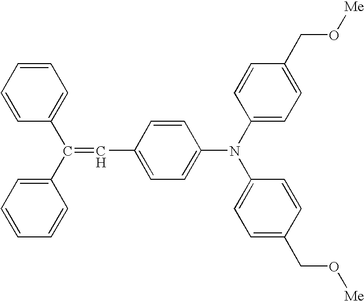 | |
| | (I-54) |
| 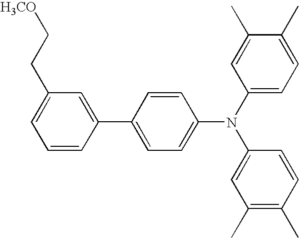 | |
| | (I-55) |
| 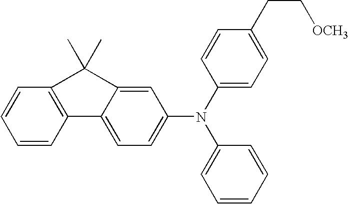 | |
| | (I-56) |
| 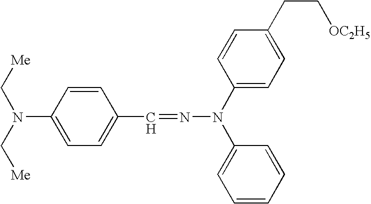 | |
| | (I-57) |
| 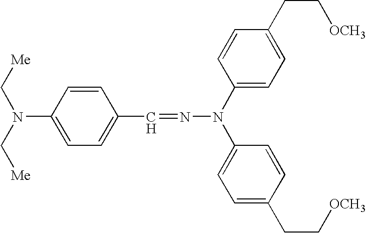 | |
| | (I-58) |
| 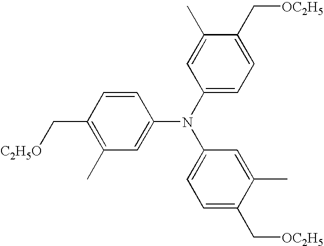 | |
| | (I-59) |
| 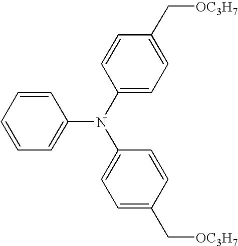 | |

Preferably, the compounds of formula (I) are those of the following formula (IV): 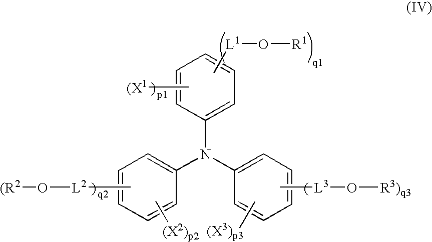
[In formula (IV), X¹, X² and X³ each independently represent a halogen atom, an alkyl group having from 1 to 10 carbon atoms, an alkoxyl group having from 1 to 10 carbon atoms, a substituted or unsubstituted aryl group, an aralkyl group having from 7 to 10 carbon atoms, a substituted or unsubstituted styryl group, a substituted or unsubstituted butadiene group, or a substituted or unsubstituted hydrazone group; R¹, R² and R³ each independently represent a monovalent organic group having from 1 to 18 carbon atoms; L¹, L² and L³ each independently represent an alkylene group; p1, p2 and p3 each independently indicate an integer of from 0 to 2; q1, q2 and q3 each independently indicate 0 or 1, satisfying (q1+q2+q3)≧1.]

Preferably in formula (IV), R¹, R² and R³ each independently represent a monovalent hydrocarbon group having from 1 to 18 carbon atoms and optionally substituted with a halogen atom, or a group of —(CH₂)r-O—R⁴, more preferably an alkyl group having from 1 to 4 carbon atoms, or a group of —(CH₂)r-O—R⁴, even more preferably a methyl group. R⁴ represents a hydrocarbon group having from 1 to 6 carbon atoms, and it may form a ring, but preferably it is an aliphatic hydrocarbon group such as a methyl group, an ethyl group, a propyl group or a butyl group. r indicates an integer of from 1 to 12, preferably an integer of from 1 to 4.

Preferably in formula (IV), L¹, L² and L³ each independently represent an optionally-branched alkylene group having from 1 to 18 carbon atoms, more preferably a methylene group.

Preferably in formula (VI), X¹, X² and X³ each independently represent an alkyl group having from 1 to 10 carbon atoms, more preferably an alkyl group having from 1 to 4 carbon atoms.

Preferably in formula (VI), q1, q2 and q3 satisfy (q1+q2+q3)≧2.

Concretely, the charge-transporting compounds of formula (IV) include, for example, the following compounds (Nos. 1 to 125). The compounds 1 to 125 are combinations of X¹, X², X³, R¹, R², R³, L¹, L², L³, p1, p2, p3, q1, q2 and q3 as in the following Tables.

TABLE 13

| No. | X¹ | X² | X³ | p1 | p2 | p3 | L¹ | L² | L³ | R¹ | R² | R³ | q1 | q2 | q3 |
|---|---|---|---|---|---|---|---|---|---|---|---|---|---|---|---|
| 1 | — | — | — | 0 | 0 | 0 | 4,—CH₂— | — | — | —CH(CH₃)₂ | — | — | 1 | 0 | 0 |
| 2 | — | — | — | 0 | 0 | 0 | 3,—CH₂— | — | — | —CH₃ | — | — | 1 | 0 | 0 |
| 3 | — | — | — | 0 | 0 | 0 | 4,—CH₂— | — | — | —CH₂CH₃ | — | — | 1 | 0 | 0 |
| 4 | — | — | — | 0 | 0 | 0 | 4,—CH₂— | — | — | —(CH₂)₃CH₃ | — | — | 1 | 0 | 0 |
| 5 | — | — | — | 0 | 0 | 0 | 4,—CH₂CH₂CH₂— | 4,—CH₂CH₂CH₂— | — | —CH₃ | —CH₃ | — | 1 | 1 | 0 |
| 6 | — | — | — | 0 | 0 | 0 | 4,—CH₂CH₂— | — | — | —CH₃ | — | — | 1 | 0 | 0 |
| 7 | — | 4,—CH₃ | — | 0 | 1 | 0 | 4,—CH₂— | — | — | —CH₃ | — | — | 1 | 0 | 0 |
| 8 | — | 4,—CH₃ | — | 0 | 1 | 0 | 4,—CH₂— | — | — | —CH₂CH₃ | — | — | 1 | 0 | 0 |
| 9 | — | 4,—CH₃ | — | 0 | 1 | 0 | 4,—CH₂— | — | — | —CH₂CH₂CH₃ | — | — | 1 | 0 | 0 |
| 10 | — | 4,—CH₃ | — | 0 | 1 | 0 | 4,—CH₂— | — | — | —(CH₂)₄CH₃ | — | — | 1 | 0 | 0 |
| 11 | — | 4,—OCH₃ | — | 0 | 1 | 0 | 4,—CH₂— | — | — | —CH₃ | — | — | 1 | 0 | 0 |
| 12 | — | 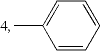 | — | 0 | 1 | 0 | 4,—CH₂— | — | — | —CH₂CH₂OCH₃ | — | — | 1 | 0 | 0 |
| 13 | — | 4,—CH₃ | 4,—CH₃ | 0 | 1 | 1 | 4,—CH₂— | — | — | —CH₃ | — | — | 1 | 0 | 0 |
| 14 | — | 4,—CH₃ | 4,—CH₃ | 0 | 1 | 1 | 4,—CH₂— | — | — | —CH₂CH₃ | — | — | 1 | 0 | 0 |
| 15 | — | 4,—CH₃ | 4,—CH₃ | 0 | 1 | 1 | 4,—CH₂— | — | — | —CH₂CH₂CH₃ | — | — | 1 | 0 | 0 |
| 16 | — | 4,—CH₃ | 4,—CH₃ | 0 | 1 | 1 | 4,—CH₂— | — | — | —(CH₂)₄CH₃ | — | — | 1 | 0 | 0 |
| 17 | — | 4,—CH₃ | 4,—CH₃ | 0 | 1 | 1 | 4,—CH₂— | — | — | —CH₂CH(CH₃)₂ | — | — | 1 | 0 | 0 |
| 18 | — | 4,—CH₃ | 4,—CH₃ | 0 | 1 | 1 | 4,—CH₂— | — | — | —CH₂CH₂OCH₃ | — | — | 1 | 0 | 0 |
| 19 | — | 4,—CH₃ | 4,—CH₃ | 0 | 1 | 1 | 4,—CH₂— | — | — | —CH₂CH₂Cl | — | — | 1 | 0 | 0 |
| 20 | — | 4,—CH₃ | 4,—CH₃ | 0 | 1 | 1 | 4,—CH(CH₃)— | — | — | —CH₃ | — | — | 1 | 0 | 0 |

In the table, the number shown in each column along with a group indicates the substituted position with the group.

TABLE 14

| No. | X¹ | X² | X³ | p1 | p2 | p3 | L¹ | L² | L³ | R¹ | R² | R³ | q1 | q2 | q3 |
|---|---|---|---|---|---|---|---|---|---|---|---|---|---|---|---|
| 21 | — | 4, —CH₃ | 4, —CH₃ | 0 | 1 | 1 | 4, —CH(CH₃)— | — | — | —CH₂CH₂OCH₃ | — | — | 1 | 0 | 0 |
| 22 | — | 4, —OCH₃ | 4, —OCH₃ | 0 | 1 | 1 | 4, —CH₂— | — | — | —CH₃ | — | — | 1 | 0 | 0 |
| 23 | — | 4, —OCH₃ | 4, —OCH₃ | 0 | 1 | 1 | 4, —CH₂— | — | — | —CH₂CH₃ | — | — | 1 | 0 | 0 |
| 24 | — | 4, —OCH₃ | 4, —OCH₃ | 0 | 1 | 1 | 4, —CH₂— | — | — | —CH₂CH₂CH₃ | — | — | 1 | 0 | 0 |
| 25 | — | 4, —OCH₃ | 4, —OCH₃ | 0 | 1 | 1 | 4, —CH₂— | — | — | —(CH₂)₄CH₃ | — | — | 1 | 0 | 0 |
| 26 | — | 4, —OCH₃ | 4, —OCH₃ | 0 | 1 | 1 | 4, —CH₂— | — | — | —CH₂CH(CH₃)₂ | — | — | 1 | 0 | 0 |
| 27 | — | 4, —OCH₃ | 4, —OCH₃ | 0 | 1 | 1 | 4, —CH₂— | — | — | —CH₂CH₂OCH₃ | — | — | 1 | 0 | 0 |
| 28 | — | 4, —OCH₃ | 4, —OCH₃ | 0 | 1 | 1 | 4, —CH₂— | — | — | —CH₂CH₂Cl | — | — | 1 | 0 | 0 |
| 29 | — | 4, —OCH₃ | 4, —OCH₃ | 0 | 1 | 1 | 4, —CH(CH₃)— | — | — | —CH₃ | — | — | 1 | 0 | 0 |
| 30 | — | 4, —OCH₃ | 4, —OCH₃ | 0 | 1 | 1 | 4, —CH(CH₃)— | — | — | —CH₂CH₂OCH₃ | — | — | 1 | 0 | 0 |
| 31 | — | 3,4, —CH₃ | 3,4, —CH₃ | 0 | 2 | 2 | 4, —CH₂— | — | — | —CH₃ | — | — | 1 | 0 | 0 |
| 32 | — | 3,4, —CH₃ | 3,4, —CH₃ | 0 | 2 | 2 | 4, —CH₂— | — | — | —CH₂CH₃ | — | — | 1 | 0 | 0 |
| 33 | — | 3,4, —CH₃ | 3,4, —CH₃ | 0 | 2 | 2 | 4, —CH₂— | — | — | —CH₂CH₂CH₃ | — | — | 1 | 0 | 0 |
| 34 | — | 3,4, —CH₃ | 3,4, —CH₃ | 0 | 2 | 2 | 4, —CH₂— | — | — | —(CH₂)₄CH₃ | — | — | 1 | 0 | 0 |
| 35 | — | 3,4, —CH₃ | 3,4, —CH₃ | 0 | 2 | 2 | 4, —CH₂— | — | — | —CH₂CH(CH₃)₂ | — | — | 1 | 0 | 0 |
| 36 | — | 3,4, —CH₃ | 3,4, —CH₃ | 0 | 2 | 2 | 4, —CH₂— | — | — | —CH₂CH₂OCH₃ | — | — | 1 | 0 | 0 |
| 37 | — | 3,4, —CH₃ | 3,4, —CH₃ | 0 | 2 | 2 | 4, —CH₂— | — | — | —CH₂CH₂Cl | — | — | 1 | 0 | 0 |
| 38 | — | 3,4, —CH₃ | 3,4, —CH₃ | 0 | 2 | 2 | 4, —CH(CH₃)— | — | — | —CH₃ | — | — | 1 | 0 | 0 |
| 39 | — | 3,4, —CH₃ | 3,4, —CH₃ | 0 | 2 | 2 | 4, —CH(CH₃)— | — | — | —CH₂CH₂OCH₃ | — | — | 1 | 0 | 0 |
| 40 | — | — | — | 0 | 0 | 0 | 4, —CH₂CH₂— | — | — | —CH₃ | — | — | 1 | 0 | 0 |

In the table, the number shown in each column along with a group indicates the substituted position with the group.

TABLE 15

| No. | X¹ | X² | X³ | p1 | p2 | p3 | L¹ | L² | L³ | R¹ | R² | R³ | q1 | q2 | q3 |
|---|---|---|---|---|---|---|---|---|---|---|---|---|---|---|---|
| 41 | — | — | — | 0 | 0 | 0 | 4, —CH₂— | 4, —CH₂— | — | —CH(CH₃)₂ | —CH(CH₃)₂ | — | 1 | 1 | 0 |
| 42 | — | — | — | 0 | 0 | 0 | 4, —CH₂— | 4, —CH₂— | — | —CH₂CH₃ | —CH₂CH₃ | — | 1 | 1 | 0 |
| 43 | — | — | — | 0 | 0 | 0 | 4, —CH₂— | 4, —CH₂— | — | —CH₂CH₂CH₃ | —CH₂CH₂CH₃ | — | 1 | 1 | 0 |
| 44 | — | — | — | 0 | 0 | 0 | 4, —CH₂— | 4, —CH₂— | — | —(CH₂)₄CH₃ | —(CH₂)₄CH₃ | — | 1 | 1 | 0 |
| 45 | — | — | — | 0 | 0 | 0 | 4, —CH₂— | 4, —CH₂— | — | —CH₂CH(CH₃)₂ | —CH₂CH(CH₃)₂ | — | 1 | 1 | 0 |
| 46 | — | — | — | 0 | 0 | 0 | 4, —CH₂— | 4, —CH₂— | — | —CH₂CH₂OCH₃ | —CH₂CH₂OCH₃ | — | 1 | 1 | 0 |
| 47 | — | — | 4, —CH₃ | 0 | 0 | 1 | 4, —CH₂— | 4, —CH₂— | — | —CH₃ | —CH₃ | — | 1 | 1 | 0 |
| 48 | — | — | 4, —CH₃ | 0 | 0 | 1 | 4, —CH₂— | 4, —CH₂— | — | —CH₂CH₃ | —CH₂CH₃ | — | 1 | 1 | 0 |
| 49 | — | — | 4, —CH₃ | 0 | 0 | 1 | 4, —CH₂— | 4, —CH₂— | — | —CH₂CH₂CH₃ | —CH₂CH₂CH₃ | — | 1 | 1 | 0 |
| 50 | — | — | 4, —CH₃ | 0 | 0 | 1 | 4, —CH₂— | 4, —CH₂— | — | —(CH₂)₄CH₃ | —(CH₂)₄CH₃ | — | 1 | 1 | 0 |
| 51 | — | — | 4, —CH₃ | 0 | 0 | 1 | 4, —CH₂— | 4, —CH₂— | — | —CH₂CH(CH₃)₂ | —CH₂CH(CH₃)₂ | — | 1 | 1 | 0 |
| 52 | — | — | 4, —CH₃ | 0 | 0 | 1 | 4, —CH₂— | 4, —CH₂— | — | —CH₂CH₂OCH₃ | —CH₂CH₂OCH₃ | — | 1 | 1 | 0 |
| 53 | — | — | 4, —CH₃ | 0 | 0 | 1 | 4, —CH₂— | 4, —CH₂— | — | —CH₂CH₂Cl | —CH₂CH₂Cl | — | 1 | 1 | 0 |
| 54 | — | — | 4, —CH₃ | 0 | 0 | 1 | 4, —CH(CH₃)— | 4, —CH(CH₃)— | — | —CH₃ | —CH₃ | — | 1 | 1 | 0 |
| 55 | — | — | 4, —CH₃ | 0 | 0 | 1 | 4, —CH(CH₃)— | 4, —CH(CH₃)— | — | —CH₂CH₂OCH₃ | —CH₂CH₂OCH₃ | — | 1 | 1 | 0 |
| 56 | — | — | 4, —OCH₃ | 0 | 0 | 1 | 4, —CH₂— | 4, —CH₂— | — | —CH₃ | —CH₃ | — | 1 | 1 | 0 |
| 57 | — | — | 4, —OCH₃ | 0 | 0 | 1 | 4, —CH₂— | 4, —CH₂— | — | —CH₂CH₃ | —CH₂CH₃ | — | 1 | 1 | 0 |
| 58 | — | — | 4, —OCH₃ | 0 | 0 | 1 | 4, —CH₂— | 4, —CH₂— | — | —CH₂CH₂CH₃ | —CH₂CH₂CH₃ | — | 1 | 1 | 0 |
| 59 | — | — | 4, —OCH₃ | 0 | 0 | 1 | 4, —CH₂— | 4, —CH₂— | — | —(CH₂)₄CH₃ | —(CH₂)₄CH₃ | — | 1 | 1 | 0 |
| 60 | — | — | 4, —OCH₃ | 0 | 0 | 1 | 4, —CH₂— | 4, —CH₂— | — | —CH₂CH(CH₃)₂ | —CH₂CH(CH₃)₂ | — | 1 | 1 | 0 |

In the table, the number shown in each column along with a group indicates the substituted position with the group.

TABLE 16

| No. | X¹ | X² | X³ | p1 | p2 | p3 | L¹ | L² | L³ | R¹ | R² | R³ | q1 | q2 | q3 |
|---|---|---|---|---|---|---|---|---|---|---|---|---|---|---|---|
| 61 | — | — | 4,—OCH₃ | 0 | 0 | 1 | 4,—CH₂— | 4,—CH₂— | — | —CH₂CH₂OCH₃ | —CH₂CH₂OCH₃ | — | 1 | 1 | 0 |
| 62 | — | — | 4,—OCH₃ | 0 | 0 | 1 | 4,—CH₂— | 4,—CH₂— | — | —CH₂CH₂Cl | —CH₂CH₂Cl | — | 1 | 1 | 0 |
| 63 | — | — | 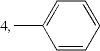 | 0 | 0 | 1 | 4,—CH₂— | 4,—CH₂— | — | —CH₃ | —CH₃ | — | 1 | 1 | 0 |
| 64 | — | — | 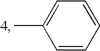 | 0 | 0 | 1 | 4,—CH₂— | 4,—CH₂— | — | —CH₂CH₃ | —CH₂CH₃ | — | 1 | 1 | 0 |
| 65 | — | — | 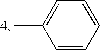 | 0 | 0 | 1 | 4,—CH₂— | 4,—CH₂— | — | —CH₂CH₂CH₃ | —CH₂CH₂CH₃ | — | 1 | 1 | 0 |
| 66 | — | — | 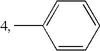 | 0 | 0 | 1 | 4,—CH₂— | 4,—CH₂— | — | —(CH₂)₄CH₃ | —(CH₂)₄CH₃ | — | 1 | 1 | 0 |
| 67 | — | — | 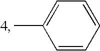 | 0 | 0 | 1 | 4,—CH₂— | 4,—CH₂— | — | —CH₂CH(CH₃)₂ | —CH₂CH(CH₃)₂ | — | 1 | 1 | 0 |
| 68 | — | — | 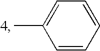 | 0 | 0 | 1 | 4,—CH₂— | 4,—CH₂— | — | —CH₂CH₂OCH₃ | —CH₂CH₂OCH₃ | — | 1 | 1 | 0 |
| 69 | — | — | 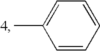 | 0 | 0 | 1 | 4,—CH₂— | 4,—CH₂— | — | —CH₂CH₂Cl | —CH₂CH₂Cl | — | 1 | 1 | 0 |
| 70 | — | — | 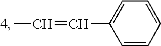 | 0 | 0 | 1 | 4,—CH₂— | 4,—CH₂— | — | —CH(CH₃)₂ | —CH(CH₃)₂ | — | 1 | 1 | 0 |
| 71 | — | — | 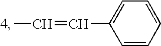 | 0 | 0 | 1 | 4,—CH₂— | 4,—CH₂— | — | —CH₂CH₃ | —CH₂CH₃ | — | 1 | 1 | 0 |
| 72 | — | — | 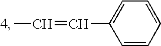 | 0 | 0 | 1 | 4,—CH₂— | 4,—CH₂— | — | —CH₂CH₂CH₃ | —CH₂CH₂CH₃ | — | 1 | 1 | 0 |
| 73 | — | — | 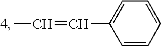 | 0 | 0 | 1 | 4,—CH₂— | 4,—CH₂— | — | —(CH₂)₄CH₃ | —(CH₂)₄CH₃ | — | 1 | 1 | 0 |

In the table, the number shown in each column along with a group indicates the substituted position with the group.

TABLE 17

| No. | X¹ | X² | X³ | p1 | p2 | p3 | L¹ |
|---|---|---|---|---|---|---|---|
| 74 | — | — | 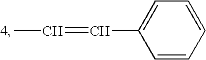 | 0 | 0 | 1 | 4,—CH₂— |
| 75 | — | — | 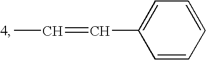 | 0 | 0 | 1 | 4,—CH₂— |
| 76 | — | — | 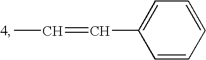 | 0 | 0 | 1 | 4,—CH₂— |
| 77 | — | — | 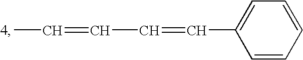 | 0 | 0 | 1 | 4,—CH₂— |
| 78 | — | — | 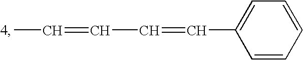 | 0 | 0 | 1 | 4,—CH₂— |
| 79 | — | — | 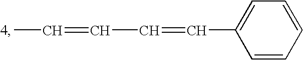 | 0 | 0 | 1 | 4,—CH₂— |
| 80 | — | — | 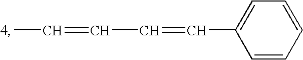 | 0 | 0 | 1 | 4,—CH₂— |
| 81 | — | — | 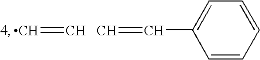 | 0 | 0 | 1 | 4,—CH₂— |
| 82 | — | — | 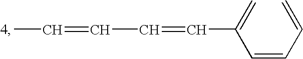 | 0 | 0 | 1 | 4,—CH₂— |
| 83 | — | — | 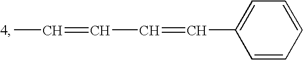 | 0 | 0 | 1 | 4,—CH₂— |
| 84 | — | — | 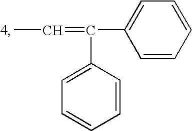 | 0 | 0 | 1 | 4,—CH₂— |

| No. | L² | L³ | R¹ | R² | R³ | q1 | q2 | q3 |
|---|---|---|---|---|---|---|---|---|
| 74 | 4,—CH₂— | — | —CH₂CH(CH₃)₂ | —CH₂CH(CH₃)₂ | — | 1 | 1 | 0 |
| 75 | 4,—CH₂— | — | —CH₂CH₂OCH₃ | —CH₂CH₂OCH₃ | — | 1 | 1 | 0 |
| 76 | 4,—CH₂— | — | —CH₂CH₂Cl | —CH₂CH₂Cl | — | 1 | 1 | 0 |
| 77 | 4,—CH₂— | — | —CH₃ | —CH₃ | — | 1 | 1 | 0 |
| 78 | 4,—CH₂— | — | —CH₂CH₃ | —CH₂CH₃ | — | 1 | 1 | 0 |
| 79 | 4,—CH₂— | — | —CH₂CH₂CH₃ | —CH₂CH₂CH₃ | — | 1 | 1 | 0 |
| 80 | 4,—CH₂— | — | —(CH₂)₄CH₃ | —(CH₂)₄CH₃ | — | 1 | 1 | 0 |
| 81 | 4,—CH₂— | — | —CH₂CH(CH₃)₂ | —CH₂CH(CH₃)₂ | — | 1 | 1 | 0 |
| 82 | 4,—CH₂— | — | —CH₂CH₂OCH₃ | —CH₂CH₂OCH₃ | — | 1 | 1 | 0 |
| 83 | 4,—CH₂— | — | —CH₂CH₂Cl | —CH₂CH₂Cl | — | 1 | 1 | 0 |
| 84 | 4,—CH₂— | — | —CH(CH₃)₂ | —CH(CH₃)₂ | — | 1 | 1 | 0 |

In the table, the number shown in each column along with a group indicates the substituted position with the group.

TABLE 18

| No. | X¹ | X² | X³ | p1 | p2 | p3 | L¹ | L² | L³ | R¹ | R² | R³ | q1 | q2 | q3 |
|---|---|---|---|---|---|---|---|---|---|---|---|---|---|---|---|
| 85 | — | — | 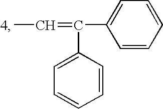 | 0 | 0 | 1 | 4,—CH₂— | 4,—CH₂— | — | —CH₂CH₃ | —CH₂CH₃ | — | 1 | 1 | 0 |
| 86 | — | — | 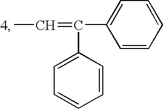 | 0 | 0 | 1 | 4,—CH₂— | 4,—CH₂— | — | —CH₂CH₂CH₃ | —CH₂CH₂CH₃ | — | 1 | 1 | 0 |
| 87 | — | — | 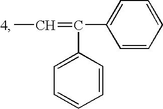 | 0 | 0 | 1 | 4,—CH₂— | 4,—CH₂— | — | —(CH₂)₄CH₃ | —(CH₂)₄CH₃ | — | 1 | 1 | 0 |
| 88 | — | — | 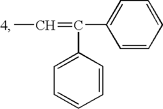 | 0 | 0 | 1 | 4,—CH₂— | 4,—CH₂— | — | —CH₂CH(CH₃)₂ | —CH₂CH(CH₃)₂ | — | 1 | 1 | 0 |
| 89 | — | — | 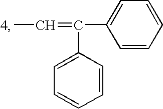 | 0 | 0 | 1 | 4,—CH₂— | 4,—CH₂— | — | —CH₂CH₂OCH₃ | —CH₂CH₂OCH₃ | — | 1 | 1 | 0 |
| 90 | — | — | 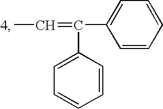 | 0 | 0 | 1 | 4,—CH₂— | 4,—CH₂— | — | —CH₂CH₂Cl | —CH₂CH₂Cl | — | 1 | 1 | 0 |
| 91 | — | — | 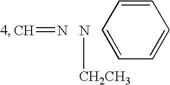 | 0 | 0 | 1 | 4,—CH₂— | 4,—CH₂— | — | —CH₃ | —CH₃ | — | 1 | 1 | 0 |

In the table, the number shown in each column along with a group indicates the substituted position with the group.

TABLE 19

| No. | X¹ | X² | X³ | p1 | p2 | p3 | L¹ | L² | L³ | R¹ | R² | R³ | q1 | q2 | q3 |
|---|---|---|---|---|---|---|---|---|---|---|---|---|---|---|---|
| 92 | — | — | 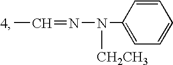 | 0 | 0 | 1 | 4,—CH₂— | 4,—CH₂— | — | —CH₂CH₃ | —CH₂CH₃ | — | 1 | 1 | 0 |
| 93 | — | — | 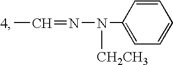 | 0 | 0 | 1 | 4,—CH₂— | 4,—CH₂— | — | —CH₂CH₂CH₃ | —CH₂CH₂CH₃ | — | 1 | 1 | 0 |
| 94 | — | — | 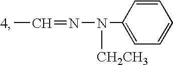 | 0 | 0 | 1 | 4,—CH₂— | 4,—CH₂— | — | —(CH₂)₄CH₃ | —(CH₂)₄CH₃ | — | 1 | 1 | 0 |
| 95 | — | — | 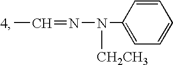 | 0 | 0 | 1 | 4,—CH₂— | 4,—CH₂— | — | —CH₂CH(CH₃)₂ | —CH₂CH(CH₃)₂ | — | 1 | 1 | 0 |
| 96 | — | — | 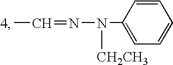 | 0 | 0 | 1 | 4,—CH₂— | 4,—CH₂— | — | —CH₂CH₂OCH₃ | —CH₂CH₂OCH₃ | — | 1 | 1 | 0 |
| 97 | — | — | 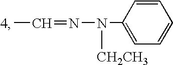 | 0 | 0 | 1 | 4,—CH₂— | 4,—CH₂— | — | —CH₂CH₂Cl | —CH₂CH₂Cl | — | 1 | 1 | 0 |
| 98 | — | — | 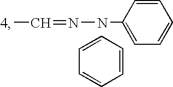 | 0 | 0 | 1 | 4,—CH₂— | 4,—CH₂— | — | —CH₃ | —CH₃ | — | 1 | 1 | 0 |
| 99 | — | — | 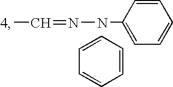 | 0 | 0 | 1 | 4,—CH₂— | 4,—CH₂— | — | —CH₂CH₃ | —CH₂CH₃ | — | 1 | 1 | 0 |

In the table, the number shown in each column along with a group indicates the substituted position with the group.

TABLE 20

| No. | X¹ | X² | X³ | p1 | p2 | p3 | L¹ | L² | L³ | R¹ | R² | R³ | q1 | q2 | q3 |
|---|---|---|---|---|---|---|---|---|---|---|---|---|---|---|---|
| 100 | — | — | 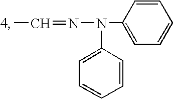 | 0 | 0 | 1 | 4,—CH₂— | 4,—CH₂— | — | —CH₂CH₂CH₃ | —CH₂CH₂CH₃ | — | 1 | 0 | 0 |
| 101 | — | — | 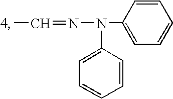 | 0 | 0 | 1 | 4,—CH₂— | 4,—CH₂— | — | —(CH₂)₄CH₃ | —(CH₂)₄CH₃ | — | 1 | 0 | 0 |
| 102 | — | — | 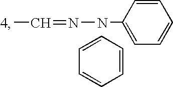 | 0 | 0 | 1 | 4,—CH₂— | 4,—CH₂— | — | —CH₂CH(CH₃)₂ | —CH₂CH(CH₃)₂ | — | 1 | 0 | 0 |
| 103 | — | — | 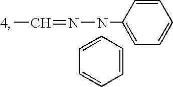 | 0 | 0 | 1 | 4,—CH₂— | 4,—CH₂— | — | —CH₂CH₂OCH₃ | —CH₂CH₂OCH₃ | — | 1 | 0 | 0 |
| 104 | — | — | 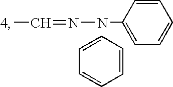 | 0 | 0 | 1 | 4,—CH₂— | 4,—CH₂— | — | —CH₂CH₂Cl | —CH₂CH₂Cl | — | 1 | 0 | 0 |

In the table, the number shown in each column along with a group indicates the substituted position with the group.

TABLE 21

| No. | X¹ | X² | X³ | p1 | p2 | P3 | L¹, L², L³ | R¹, R², R³ | q1 | q2 | q3 |
|---|---|---|---|---|---|---|---|---|---|---|---|
| 105 | — | — | — | 0 | 0 | 0 | 4, —CH₂CH₂CH₂— | —CH₃ | 1 | 1 | 1 |
| 106 | — | — | — | 0 | 0 | 0 | 4, —CH₂— | —CH₂CH₃ | 1 | 1 | 1 |
| 107 | — | — | — | 0 | 0 | 0 | 4, —CH₂— | —CH₂CH₂CH₃ | 1 | 1 | 1 |
| 108 | — | — | — | 0 | 0 | 0 | 4, —CH₂— | —(CH₂)₄CH₃ | 1 | 1 | 1 |
| 109 | — | — | — | 0 | 0 | 0 | 4, —CH₂— | —CH₂CH(CH₃)₂ | 1 | 1 | 1 |
| 110 | — | — | — | 0 | 0 | 0 | 4, —CH₂— | —CH₂CH₂OCH₃ | 1 | 1 | 1 |
| 111 | — | — | — | 0 | 0 | 0 | 4, —CH₂— | —CH₂CH₂Cl | 1 | 1 | 1 |
| 112 | — | 3, —CH₃ | 3, —CH₃ | 0 | 1 | 1 | 4, —CH₂— | —CH₃ | 1 | 1 | 1 |
| 113 | — | 3, —CH₃ | 3, —CH₃ | 0 | 1 | 1 | 4, —CH₂— | —CH₂CH₃ | 1 | 1 | 1 |
| 114 | — | 3, —CH₃ | 3, —CH₃ | 0 | 1 | 1 | 4, —CH₂— | —CH₂CH₂CH₃ | 1 | 1 | 1 |
| 115 | — | 3, —CH₃ | 3, —CH₃ | 0 | 1 | 1 | 4, —CH₂— | —(CH₂)₄CH₃ | 1 | 1 | 1 |
| 116 | — | 3, —CH₃ | 3, —CH₃ | 0 | 1 | 1 | 4, —CH₂— | —CH₂CH(CH₃)₂ | 1 | 1 | 1 |
| 117 | — | 3, —CH₃ | 3, —CH₃ | 0 | 1 | 1 | 4, —CH₂— | —CH₂CH₂OCH₃ | 1 | 1 | 1 |
| 118 | — | 3, —CH₃ | 3, —CH₃ | 0 | 1 | 1 | 4, —CH₂— | —CH₂CH₂Cl | 1 | 1 | 1 |
| 119 | 3,5, —CH₃ | 3,5, —CH₃ | 3,5, —CH₃ | 2 | 2 | 2 | 4, —CH₂— | —CH₃ | 1 | 1 | 1 |
| 120 | 3, —CH₃ | 3, —CH₃ | 3, —CH₃ | 1 | 1 | 1 | 4, —CH₂— | —CH₂CH₃ | 1 | 1 | 1 |
| 121 | 3, —CH₃ | 3, —CH₃ | 3, —CH₃ | 1 | 1 | 1 | 4, —CH₂— | —CH₂CH₂CH₃ | 1 | 1 | 1 |
| 122 | 3, —CH₃ | 3, —CH₃ | 3, —CH₃ | 1 | 1 | 1 | 4, —CH₂— | —(CH₂)₄CH₃ | 1 | 1 | 1 |
| 123 | 3, —CH₃ | 3, —CH₃ | 3, —CH₃ | 1 | 1 | 1 | 4, —CH₂— | —CH₂CH(CH₃)₂ | 1 | 1 | 1 |
| 124 | 3, —CH₃ | 3, —CH₃ | 3, —CH₃ | 1 | 1 | 1 | 4, —CH₂— | —CH₂CH₂OCH₃ | 1 | 1 | 1 |
| 125 | 3, —CH₃ | 3, —CH₃ | 3, —CH₃ | 1 | 1 | 1 | 4, —CH₂— | —CH₂CH₂Cl | 1 | 1 | 1 |

In the table, the number shown in each column along with a group indicates the substituted position with the group.

The compounds of formula (I) may be readily produced, for example, by reacting a hydroxyalkyl group-having triphenylamine compound with a dialkyl sulfate or an alkyl iodide so as to etherify the hydroxyalkyl group in the starting compound. In this case, the reagent to be used may be suitably selected from dimethyl sulfate, diethyl sulfate, methyl iodide or ethyl iodide, and its amount may be from 1 to 3 equivalents, preferably from 1 to 2 equivalents to the hydroxyalkyl group. A basic catalyst may be used for the reaction, which may be suitably selected from sodium hydroxide, potassium hydroxide, sodium methoxide, sodium ethoxide, sodium t-butoxide, potassium t-butoxide, sodium hydride or sodium metal. Its amount may be from 1 to 3 equivalents, preferably from 1 to 2 equivalents to the hydroxyalkyl group. The reaction temperature may fall within a range of from 0° C. to the boiling point of the solvent used.

The reaction solvent includes benzene, toluene, methylene chloride, tetrahydrofuran, N,N′-dimethylformamide, dimethylsulfoxide, N-methylpyrrolidone, 1,3-dimethyl-2-imidazolidinone. A single solvent or a mixed solvent of two or three selected from those may be used. Depending on the reaction mode, an interlayer transfer catalyst of a quaternary ammonium salt such as tetra-n-butylammonium iodide may be used.

The protective layer 5 may further contain a binder resin. The binder resin includes polycarbonate resins, polyester resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenolic resins, styrene-alkyd resins, and charge-transporting polymer materials such as poly-N-vinylcarbazole, polysilane, polyester-type charge-transporting polymer materials as in JP-A 8-176293 and 8-208820.

For the binder resin, also preferably used are thermosetting resins such as phenolic resins, thermosetting acrylic resin, thermosetting silicone resins, epoxy resins, melamine resins, urethane resins, polyimide resins and polybenzimidazole resins. In view of their mechanical strength, especially preferred are crosslinking resins such as phenolic resins, epoxy resins, melamine resins, benzoguanamine resins, siloxane resins, urethane resins. Of those, more preferred are phenolic resins and epoxy resins.

For the phenolic resins, usable are monomers of monomethylolphenols, dimethylolphenols or trimethylolphenols or their mixtures or oligomers, or mixtures of such monomers and oligomers, which are produced through reaction of resorcinol or bisphenol or other phenol structure-having compounds such as substituted phenols having one hydroxyl group, e.g., phenol, cresol, xylenol, paraalkylphenol or paraphenylphenol, substituted phenols having two hydroxyl groups, e.g., catechol, resorcinol or hydroquinone, bisphenols or biphenols such as bisphenol A or bisphenol Z, with formaldehyde or paraformaldehyde, in the presence of an acid catalyst or an alkali catalyst. Of the compounds, those having from about 2 to 20 repetitive molecular structure units and therefore having a relatively large molecular weight are oligomers, and those smaller than such oligomers are monomers.

The acid catalyst includes, for example, sulfuric acid, paratoluenesulfonic acid, phenolsulfonic acid, phosphoric acid. The alkali catalyst includes, for example, alkali metal or alkaline earth metal hydroxides and oxides such as NaOH, KOH, Ca(OH)₂, Mg(OH)₂, Ba(OH)₂, CaO, MgO; amine catalysts; and acetates such as zinc acetate and sodium acetate. The amine catalysts include ammonia, hexamethylenetetramine, triethylamine, triethylamine, triethanolamine. When a basic catalyst is used, then the remaining catalyst may noticeably trap carriers and may therefore often worsen the electrophotographic properties of the photoreceptor. In such a case, therefore, the basic catalyst used is preferably inactivated or removed, for example, it is evaporated away under reduced pressure or is neutralized with an acid, or it is inactivated through contact with an adsorbent such as silica gel or with ion-exchange resin.

All types of melamine resins and benzoguanamine resins are usable herein, including, for example, methylol-type resins where free methylol groups remain as they are, full-ether-type resins where methylol groups are all alkyletherified, full-imino-type resins, and mixed-type resins having both methylol and imino groups. In view of the stability of coating liquids, preferred are ether-type resins.

For the urethane resins, herein usable are polyfunctional isocyanates or isocyanurates, as well as blocked isocyanates prepared by blocking them with alcohols or ketones. In view of the stability of coating liquids, preferred are blocked isocyanates or isocyanurates. The resin is mixed with a compound of formula (I), and the resulting mixture is applied and crosslinked under heat to form the protective layer.

For the silicone resins, herein usable are resins derived from compounds of a formula (VI) or (VII) mentioned below.

One or more binder resins mentioned above may be used herein either singly or as combined. The blend ratio (by weight) of the compound of formula (I) to the resin is preferably from 10/1 to 1/5.

When an insulating resin of, for example, polyvinylbutyral resins, polyarylate resins (e.g., bisphenol A/phthalic acid polycondensates), polycarbonate resins, polyester resins, phenoxy resins, vinyl chloride-vinyl acetate copolymers, polyamide resins, acrylic resins, polyacrylamide resins, polyvinylpyridine resins, cellulose resins, urethane resins, epoxy resins, casein, polyvinyl alcohol resins or polyvinylpyrrolidone resins is mixed in the protective layer 5 in a desired ratio, then the adhesiveness of the resin to the charge transport layer 2 may be good, and the layer may be free from coating film defects to be caused by thermal shrinkage or coating repellence.

A compound of the following formula (VI) may be added to the protective layer 5 for controlling various properties such as the strength and the film resistance of the layer.
Si(R³⁰)_{(4-g)}Q_{g} (VI)
[In formula (VI), R³⁰ represents a hydrogen atom, an alkyl group, or a substituted or unsubstituted aryl group; Q represents a hydrolyzable group; and g indicates an integer offrom 1 to 4.]

Examples of the compound of formula (VI) are silane coupling agents mentioned below. The silane coupling agents are tetrafunctional alkoxysilanes (g=4) such as tetramethoxysilane, tetraethoxysilane; trifunctional alkoxysilanes (g=3) such as methyltrimethoxysilane, methyltriethoxysilane, ethyltrimethoxysilane, methyltrimethoxyethoxysilane, vinyltrimethoxysilane, vinyltriethoxysilane, phenyltrimethoxysilane, γ-glycidoxypropylmethyldiethoxysilane, γ-glycidoxypropyltrimethoxysilane, γ-glycidoxypropyltrimethoxysilane, γ-aminopropyltriethoxysilane, γ-aminopropyltrimethoxysilane, γ-aminopropylmethyldimethoxysilane, N-β-(aminoethyl)-γ-aminopropyltriethoxysilane, (tridecafluoro-1,1,2,2-tetrahydrooctyl)triethoxysilane, (3,3,3-trifluoropropyl)trimethoxysilane, 3-(heptafluoroisopropoxy)propyltriethoxysilane, 1H, 1H,2H,2H-perfluoroalkyltriethoxysilane, 1H, 1H,2H,2H-perfluorodecyltriethoxysilane, 1H,1H,2H,2H-perfluorooctyltriethoxysilane; difunctional alkoxysilanes (g=2) such as dimethyldimethoxysilane, diphenyldimethoxysilane, methylphenyldimethoxysilane; monofunctional alkoxysilanes (g=1) such as trimethylmethoxysilane. For improving the film strength, preferred are tri and tetrafunctional alkoxysilanes; and for improving the flexibility and the film-formability, preferred are mono and difunctional alkoxysilanes.

A silicone-based hard-coating agent consisting essentially of such a coupling agent may also be used herein. Also usable herein are commercially-available hard-coating agents such as KP-85, X-40-9740, X-40-2239 (all from Shin-Etsu Silicone Co., Ltd); and AY42-440, AY42-441, AY49-208 (all from Dow-Corning Toray).

Preferably, a compound having at least two silicon atoms of the following formula (VII) is added to the protective layer 5 for increasing the strength of the layer.
B—(Si(R⁴⁰)₍₃₋ₐ₎Qₐ)₂ (VII)
[In formula (VII), B represents a divalent organic group; R⁴⁰ represents a hydrogen atom, an alkyl group, or a substituted or unsubstituted aryl group; Q represents a hydrolyzable group; and a indicates an integer of from 1 to 3.

Concretely, preferred examples of the compound of formula (VII) are the following compounds (VII-1) to (VII-16).

TABLE 22

| | |
|---|---|
| VII-1 | (MeO)₃Si—(CH₂)₂—Si(OMe)₃ |
| VII-2 | (MeO)₂MeSi—(CH₂)₂—SiMe(OMe)₂ |
| VII-3 | (MeO)₂MeSi—(CH₂)₆—SiMe(OMe)₂ |
| VII-4 | (MeO)₃Si—(CH₂)₆—Si(OMe)₃ |
| VII-5 | (EtO)₃Si—(CH₂)₆—Si(OEt)₃ |
| VII-6 | (MeO)₂MeSi—(CH₂)₁₀—SiMe(OMe)₂ |
| VII-7 | (MeO)₃Si—(CH₂)₃—NH—(CH₂)₃—Si(OMe)₃ |
| VII-8 | (MeO)₃Si—(CH₂)₃—NH—(CH₂)₂—NH—(CH₂)₃—Si(OMe)₃ |
| VII-9 | 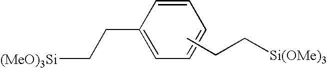 |
| VII-10 | 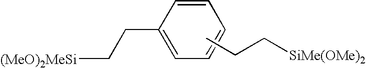 |
| VII-11 | 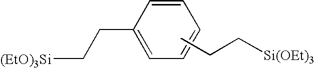 |
| VII-12 | 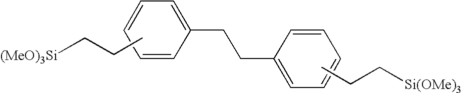 |
| VII-13 | 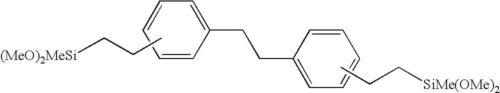 |
| VII-14 | 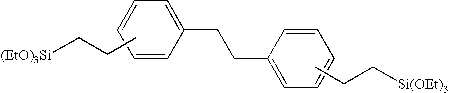 |
| VII-15 | (MeO)₃SiC₃H₆—O—CH₂CH{—O—C₃H₆Si(OMe)₃}—CH₂{—O—C₃H₆Si(OMe)₃} |
| VII-16 | (MeO)₃SiC₂H₄—SiMe₂—O—SiMe₂—C₂H₄Si(OMe)₃ |

Preferably, at least one of cyclic compounds having repetitive structural units of the following formula (VIII) or their derivatives is added to the protective layer 5 for pot life prolongation, control of film properties, and torque reduction.

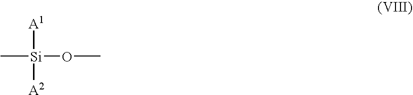

In formula (VIII), A¹ and A² each independently represent a monovalent organic group.

The cyclic compound having repetitive structural units of formula (VIII) includes commercially-available cyclic siloxanes. Concretely, they are cyclic dimethylcyclosiloxanes such as hexamethylcyclotrisiloxarie, octamethylcyclotetrasiloxane, decamethylcyclopentasiloxane, dodecamethylcyclohexasiloxane; cyclic methylphenylcyclosiloxanes such as 1,3,5-trimethyl-1,3,5-triphenylcyclotrisiloxane, 1,3,5,7-tetramethyl-1,3,5,7-tetraphenylcyclotetrasiloxane, 1,3,5,7,9-pentamethyl-1,3,5,7,9-pentaphenylcyclopentasiloxane; cyclic phenylcyclosiloxanes such as hexaphenylcyclotrisiloxane; fluorine atom-containing cyclosiloxanes such as 3-(3,3,3-trifluoropropyl)methylcyclotrisiloxane; methylhydrosiloxane mixtures, pentamethylcyclopentasiloxane; hydrosilyl group-containing cyclosiloxanes such as phenylhydrocyclosiloxane; vinyl group-containing cyclosiloxanes such as pentavinylpentamethylcyclopentasiloxane. One or more such cyclic siloxane compounds may be used herein either singly or as combined.

Conductive particles may be added to the protective layer 5 for reducing the residual potential of the layer. The conductive particles include metals, metal oxides, and carbon black. Of those, preferred are metals and metal oxides. The metals include aluminium, zinc, copper, chromium, nickel, silver and stainless; and plastic particles coated with such metal through vapor deposition. The metal oxides include zinc oxide, titanium oxide, tin oxide, antimony oxide, indium oxide, bismuth oxide, tin-doped indium oxide, antimony or tantalum-doped tin oxide, antimony-doped zirconium oxide. One or more of these may be used herein either singly or as combined. When two or more of them are combined, they may be merely mixed or may be formed into solid solution or fused melt. Preferably, the mean particle size of the conductive particles is at most 0.3 μm, more preferably at most 0.1 μm in view of the transparency of the protective layer 5.

Various other particles may be added to the protective layer 5 for controlling the pollutant deposition resistance, the lubricity and the hardness of the surface of the electrophotographic photoreceptor. One or more different types of such particles may be used herein either singly or as combined. One example of the additional particles is silicon atom-containing particles. The silicon atom-containing particles are those containing a silicon atom as the constitutive element. Concretely, they are colloidal silica and silicone particles. Preferably, the colloidal silica herein usable for the silicon atom-containing particles has a mean particle size of from 1 to 100 nm, more preferably from 10 to 30 nm. It may be selected from an acid or alkaline aqueous dispersion, or a dispersion in an organic solvent such as alcohol, ketone or ester. Ordinary commercial products of such colloidal silica are usable herein. Though not specifically defined, the solid content of the colloidal silica in the outermost surface layer is preferably from 0.1 to 50% by weight, more preferably from 0.1 to 30% by weight based on the total solid content of the protective layer 5 in view of the film-formability, the electric properties and the strength of the layer.

The silicone particles of the silicon atom-containing particles are spherical particles preferably having a mean particle size of from 1 to 500 nm, more preferably from 10 to 100 nm, and they are selected from silicon resin particles, silicon rubber particles, and silica particles surface-treated with silicone. Ordinary commercial products of such silicone particles are usable herein. Silicone particles are chemically-inactive fine particles of good dispersibility in resin. Since their amount necessary for giving sufficient properties may be small, they may well improve the surface condition of the electrophotographic photoreceptor not interfering with the crosslinking reaction in the surface layer of the photoreceptor. Specifically, the particles may be uniformly trapped in a strong crosslinked structure, and they may improve the surface lubricity and water-repellency of the electrophotographic photoreceptor, whereby the photoreceptor may keep good abrasion resistance and pollutant deposition resistance for a long period of time. The content of the silicone particles in the protective layer 5 is preferably from 0.1 to 30% by weight, more preferably from 0.5 to 10% by weight based on the total solid content of the protective layer 5.

Examples of other particles are fluorine-containing particles of ethylene tetrafluoride, ethylene trifluoride, propylene hexafluoride, vinyl fluoride or vinylidene fluoride; resin particles of a copolymer of the above fluororesin and a hydroxyl group-having monomer, as in Preprint for 8th Polymer Material Forum Meeting, p. 89; and semiconductive metal oxides such as ZnO—Al₂O₃, SnO₂—Sb₂O₃, In₂O₃—SnO₂, ZnO—TiO₂, MgO—Al₂O₃, FeO—TiO₂, TiO₂, SnO₂, In₂O₃, ZnO, MgO.

For the same purpose, oil such as silicone oil may also be added to the layer. The silicone oil includes, for example, ordinary silicone oils such as dimethylpolysiloxane, diphenylpolysiloxane, phenylmethylsiloxane; and reactive silicone oils such as amino-modified polysiloxanes, epoxy-modified polysiloxanes, carboxyl-modified polysiloxanes, carbinol-modified polysiloxanes, methacryl-modified polysiloxanes, mercapto-modified polysiloxanes, phenol-modified polysiloxanes. These may be previously added to the protective layer-forming coating composition, or may be applied to the constructed photoreceptor by dipping the photoreceptor in such silicone oil under reduced pressure or increased pressure.

Also if desired, other additives such as plasticizer, surface modifier, antioxidant and light deterioration inhibitor may be added to the protective layer 5. The plasticizer includes, for example, biphenyl, chlorobiphenyl, terphenyl, dibutyl phthalate, diethylene glycol phthalate, dioctyl phthalate, triphenyl phosphate, methylnaphthalene, benzophenone, chloroparaffin, polypropylene, polystyrene, various fluorohydrocarbons. An antioxidant having a partial structure of hindered phenol, hindered amine, thioether or phosphite may be added to the protective layer 5, and it is effective for improving the potential stability and the image quality in environmental fluctuation.

The antioxidant includes the following compounds. For example, they are hindered phenol-type compounds such as Sumilizer BHT-R, Sumilizer MDP-S, Sumilizer BBM-S, Sumilizer WX-R, Sumilizer NW, Sumilizer BP-76, Sumilizer BP-101, Sumilizer GA-80, Sumilizer GM, Sumilizer GS (all from Sumitomo Chemical Co., Ltd.), Irganox 1010, Irganox 1035, Irganox 1076, Irganox 1098, Irganox 1135, Irganox 1141, Irganox 1222, Irganox 1330, Irganox 1425WL, Irganox 1520L, Irganox 245, Irganox 259, Irganox 3114, Irganox 3790, Irganox 5057, Irganox 565 (all from Ciba Speciality Chemicals K.K), Adekastab AO-20, Adekastab AO-30, Adekastab AO-40, Adekastab AO-50, Adekastab AO-60, Adekastab AO-70, Adekastab AO-80, Adekastab AO-330 (all from Asahi Denka Co., Ltd); hindered amine-type compounds such as Sanol LS2626, Sanol LS765, Sanol LS770, Sanol LS744 (all from Sankyo Lifetec Co., Ltd.), Tinuvin 144, Tinuvin 622LD (both from Ciba Specialty Chemicals K.K), Mark LA57, Mark LA67, Mark LA62, Mark LA68, Mark LA63 (all from Asahi Denka Co., Ltd), Sumilizer TPS (from Sumitomo Chemical Co., Ltd); thioether-type compounds such as Sumilizer TP-D (from Sumitomo Chemical Co., Ltd); phosphite-type compounds such as Mark 2112, Mark PEP.8, Mark PEP.24G, Mark PEP.36, Mark 329K, Mark HP.10 (all by Asahi Denka Co., Ltd). In particular, hindered phenol-type and hindered amine-type antioxidants are preferred. These may be modified with a substituent such as an alkoxysilyl group crosslinkable with a material that forms a crosslinked film.

The protective layer 5 may be formed by curing the composition containing the above-mentioned constitutive materials.

When phenolic resin, melamine resin or benzoguanamine resin is used as the crosslinking resin, the catalyst used for producing the resin is removed. Preferably, for this, the resin is dissolved in a suitable solvent such as methanol, ethanol, toluene or ethyl acetate, and washed with water or re-precipitated with a bad solvent, or the resin is processed with an ion-exchange resin or an inorganic solid.

The ion-exchange resin includes, for example, cation-exchange resins such as Amberlite 15, Amberlite 200C, Amberlite 15E (all from Rohm & Haas Company), Dowex NWC-1-H, Dowex 88, Dowex HCR-W2 (all from Dow Chemical Company), Levazitte SPC-108, Levazitte SPC-118 (both from Bayer), Diaion RCP-150H (from Mitsubishi Chemical Corporation), Sumikaion KC-470, Duolite C26-C, Duolite C-433, Duolite 464 (all from Sumitomo Chemical Co., Ltd.), Nafion-H (from DuPont); and anion-exchange resins such as Amberlite IRA-400, Amberlite IRA-45 (both from Rohm & Haas Company).

The inorganic solid includes inorganic solids with a proton acid group-containing group bonded to the surface thereof, such as Zr(O₃PCH₂CH₂SO₃H)₂, Th(O₃PCH₂CH₂COOH)₂; polyorganosiloxanes having a proton acid group such as polyorganosiloxanes having a sulfonic acid group; heteropolyacids such as cobalt-tungstic acid, phosphorus-molybdic acid; isopolyacids such as niobic acid, tantalic acid, molybdic acid; single metal oxides such as silica gel, alumina, chromia, zirconia, CaO, MgO; composite metal oxides such as silica-alumina, silica-magnesia, silica-zirconia, zeolite; clay minerals such as acid clay, active clay, montmorillonite, kaolinite; metal sulfates such as LiSO₄, MgSO₄; metal phosphates such as zirconia phosphate, lanthanum phosphate; metal nitrates such as LiNO₃, Mn(NO₃)₂; inorganic solids with an amino group-containing group bonded to the surface thereof, such as a solid obtained through reaction of silica gel with aminopropyltriethoxysilane; and amino group-containing polyorganosiloxanes such as amino-modified silicone resins.

If desired, a solvent may be added to the composition of forming the protective layer 5. The solvent includes, for example, alcohols such as methanol, ethanol, propanol, butanol; ketones such as acetone, methyl ethyl ketone; ethers such as tetrahydrofuran, diethyl ether, dioxane. Apart from these, any other various solvents may also be used. For employing an ordinary dipping method generally used in producing electrophotographic photoreceptors, preferred are alcohol solvents, ketone solvents and their mixed solvents. Also preferably, the solvents have a boiling point of from 50 to 150° C. Desired solvents may be mixed in any desired manner for use herein. The amount of the solvent for use herein may be suitably determined, but if too small, then the compound of formula (I) may deposit in the coating liquid, or the coating liquid may undergo liquid-solid separation, or a desired film thickness may be difficult to obtain. Preferably, therefore, the solvent amount is from 0.5 to 30 parts by weight, more preferably from 1 to 20 parts by weight relative to 1 part by weight of the total solid content of the composition of forming the protective layer 5.

For curing the compound of formula (I) and the crosslinking resin to be in the composition of forming the protective layer 5, a curing catalyst such as an acid compound is preferably used. Though not always clear, the mechanism of curing the compound of formula (I) may be as follows: When a composition containing the compound and an acid compound is heated, then the crosslinking of the compounds is promoted to form a cured film (protective layer 5) having good electric properties and mechanical strength. In this, when a crosslinking resin such as a phenolic resin is added to the composition, then a denser crosslinked structure may be formed and a cured film having especially good mechanical strength may be formed.

The curing temperature may be defined in any desired manner, but is preferably from room temperature to 200° C., more preferably from 100° C. to 150° C.

The acid compound to be used for curing includes Lewis acids such as aluminium chloride, iron chloride, zinc chloride; hydrochloric acid, sulfuric acid, acetic acid, phenol; and other organic acids such as benzoic acid, toluenesulfonic acid, phenolsulfonic acid, methanesulfonic acid, trifluoroacetic acid, to which, however; the invention should not be limited. Of those, preferred are phenol and sulfonic acids from the viewpoint of their film-formability and electric properties.

The amount of the acid compound to be added to the composition may be suitably defined within a range of from 0.0001 to 300 parts by weight relative to 100 parts by weight of the compound of formula (I), but is preferably from 0.001 to 150 parts by weight. One or more compounds of formula (I) may be in the composition either singly or as combined.

Any other curing catalyst than the above-mentioned acid compound may be further added to the composition. Preferred examples of the curing catalyst are mentioned. They are an optical acid generator, for example, bissulfonyldiazomethanes such as bis(isopropylsulfonyl)diazomethane; bissulfonylmethanes such as methylsulfonyl-p-toluenesulfonylmethane; sulfonylcarbonyldiazomethanes such as cyclohexylsulfonylcyclohexylcarbonyldiazomethane; sulfonylcarbonylalkanes such as 2-methyl-2-(4-methylphenylsulfonyl)propiophenone; nitrobenzyl sulfonates such as 2-nitrobenzyl p-toluenesulfonate; alkyl and aryl sulfonates such as pyrogallol trismethanesulfonate; benzoin sulfonates such as benzoin tosylate; N-sulfonyloxyimides such as N-(trifluoromethylsulfonyloxy)phthalimide; pyridones such as (4-fluorobenzenesulfonyloxy)-3,4,6-trimethyl-2-pyridone; sulfonates such as 2,2,2-trifluoro-1-trifluoromethyl-1-(3-vinylphenyl)-ethyl 4-chlorobenzenesulfonate; onium salts such as triphenylsulfonium methanesulfonate, diphenyliodonium trifluoromethanesulfonate; as well as compounds prepared through neutralization of a proton acid or a Lewis acid with a Lewis base, mixtures of Lewis acid and trialkyl phosphate, sulfonates, phosphates, onium compounds, and anhydrous carboxylic acid compounds.

The compounds prepared through neutralization of a proton acid or a Lewis acid with a Lewis base are, for example, those prepared by neutralizing halogenocarboxylic acids, sulfonic acids, sulfuric monoesters, phosphoric mono or diesters, polyphosphates or boric mono or diesters with various amines such as ammonia, monoethylamine, triethylamine, pyridine, piperidine, aniline, morpholine, cyclohexylamine, n-butylamine, monoethanolamine, diethanolamine, triethanolamine, or with trialkyl phosphine, triaryl phosphine, trialkyl phosphite, triaryl phosphite; and commercial products of acid-base blocking catalysts such as Nacure 2500X, 4167, X-47-110, 3525, 5225 (King Industries' INC, trade names). The compounds prepared through neutralization of a Lewis acid with a Lewis base are, for example, those prepared by neutralizing a Lewis acid such as BF₃, FeCl₃, SnCl₄, AlCl₃ or ZnCl₂ with any of the above-mentioned Lewis bases.

Examples of the onium compound are triphenylsulfonium methanesulfonate, diphenyliodonium trifluoromethanesulfonate.

Examples of the anhydrous carboxylic acid compound are acetic anhydride, propionic anhydride, butyric anhydride, isobutyric anhydride, lauric anhydride, oleic anhydride, stearic anhydride, n-caproic anhydride, n-caprylic anhydride, n-capric anhydride, palmitic anhydride, myristic anhydride, trichloroacetic anhydride, dichloroacetic anhydride, monochloroacetic anhydride, trifluoroacetic anhydride, heptafluorobutyric anhydride.

Examples of the Lewis acid are metal halides such as boron trifluoride, aluminium trichloride, titanous chloride, titanic chloride, ferrous chloride, ferric chloride, zinc chloride, zinc bromide, stannous chloride, stannic chloride, stannous bromide, stannic bromide; organic metal compounds such as trialkylboron, trialkylaluminium, dialkyl-halogenoaluminium, monoalkyl-halogenoaluminium, tetraalkyltin; metal chelate compounds such as diisopropxyethyl acetacetatoaluminium, tris(ethylacetacetato)aluminium, tris(acetylacetonato)aluminium, diisopropoxy-bis(ethylacetacetato)titanium, diisopropxy-bis(acetylacetonato)titanium, tetrakis(n-propylacetacetato)zirconium, tetrakis(acetylacetonato)zirconium, tetrakis(ethylacetacetato)zirconium, dibutyl-bis(acetylacetonato)tin, tris(acetylacetonato)iron, tris(acetylacetonato)rhodium, bis(acetylacetonato)zinc, tris(acetylacetonato)cobalt; metal soaps such as dibutyltin dilaurate, dioctyltin maleate, magnesium naphthenate, calcium naphthenate, manganese naphthenate, iron naphthenate, cobalt naphthenate, copper naphthenate, zinc naphthenate, zirconium naphthenate, lead naphthenate, calcium octylate, manganese octylate, iron octylate, cobalt octylate, zinc octylate, zirconium octylate, tin octylate, lead octylate, zinc laurate, magnesium stearate, aluminium stearate, calcium stearate, cobalt stearate, zinc stearate, lead stearate. One or more of these may be used herein either singly or as combined.

Though not specifically defined, the amount of the catalyst to be used is preferably from 0.1 to 20 parts by weight, more preferably from 0.3 to 10 parts by weight relative to 100 parts by weight of the total solid content of the layer-forming composition.

If desired, any of epoxy-containing compounds such as polyglycidyl methacrylate, glycidyl bisphenols, phenol-epoxy resins, as well as terephthalic acid, maleic acid, pyromellitic acid, biphenyltetracarboxylic acid or their anhydrides may be added to the layer for controlling the film properties such as the hardness, the adhesiveness and the flexibility of the layer. The amount of the additive may be from 0.05 to 1 part by weight, preferably from 0.1 to 0.7 parts by weight relative to 1 part by weight of the compound of formula (I).

For applying the protective layer-forming composition onto the charge transport layer 2, employable is any ordinary method such as a blade coating method, a Meyer bar coating method, a spraying method, a dipping method, a bead coating method, an air knife coating method or a curtain coating method. After applied, the coating film is dried to form the protective layer 5.

In forming the layer, when the necessary film thickness could not be obtained in single coating, then the coating operation may be repeated plural times to obtain the necessary film thickness. In such repeated coating, heating may be effected after every coating but may be effected only once after the final coating.

When the protective layer 5 is formed by crosslinking the above-mentioned composition, then the curing temperature is preferably from 100° C. to 170° C., more preferably from 100 to 160° C. The curing time is preferably from 30 minutes to 2 hours, more preferably from 30 minutes to 1 hour. The heating temperature may be stepwise varied.

For the crosslinking reaction, preferred is a gas atmosphere inert to oxidation, such as nitrogen, helium or argon, as it prevents the electric properties of the film from being worsened. When the crosslinking reaction is effected in such an inert gas atmosphere, then the curing temperature may be higher than in an air atmosphere. Preferably, the curing temperature is from 100 to 180° C., more preferably from 110 to 160° C. The curing time is preferably from 30 minutes to 2 hours, more preferably from 30 minutes to 1 hour.

Preferably, the thickness of the protective layer 5 is from 0.5 to 15 μm, more preferably from 1 to 10 μm, even more preferably from 1 to 5 μm.

Preferably, the oxygen transmission coefficient at 25° C. of the protective layer 5 is at most 4×10¹² fm/s·Pa, more preferably at most 3.5×10¹² fm/s·Pa, even more preferably at most 3×10¹² fin/s·Pa.

The oxygen transmission coefficient is a criterion that indicates the easiness of oxygen gas transmission through the layer, but on the other hand, it may be considered as a characteristic factor substitutive for the physical porosity of the layer. When the type of the gas that passes through the layer varies, then the absolute value of the gas transmittance of the layer may vary. In any case, however, there is almost no inversion in the level of gas transmission between the layers tested. Accordingly, the gas transmission coefficient may be interpreted as a criterion that indicates the easiness of ordinary gas transmission through a layer.

Oxidation-degraded substances that are problematic in point of their adhesion to the surface of a long-life photoreceptor may form as follows: For example, NOx or ozone gas penetrates into the photosensitive layer of a photoreceptor, and a part of the layer is chemically degraded to give such oxidation-degraded substances. Accordingly, when gas transmission occurs more hardly through the outermost surface layer of a photoreceptor, or that is, when the oxygen transmission coefficient of the outermost surface layer thereof is smaller, then oxidation-degraded substances form more hardly on the layer and therefore the photoreceptor of the type is more advantageous for high-quality image formation and for long-life operation. On the other hand, when oxidation-degraded substances have formed and when they are kept adhering to the outermost surface of an electrophotographic photoreceptor, then they may have some negative influences on the quality of the image formed by the use of the photoreceptor. Accordingly, such oxidation-degraded substances must be removed by any method of using a cleaning blade or a brush. In order to stabilize the function of such a cleaning member for a long period of time, it is effective to apply a lubricant such as metal soap, higher alcohol, wax or silicone oil to the member.

For the purpose of preventing the photoreceptor from being deteriorated by ozone or oxidizing gas generated in an image-forming apparatus or by light or heat, additives such as antioxidant, light stabilizer or heat stabilizer may be added to the photosensitive layer 6. The additive may be added to at least one layer of the undercoat layer 4, the charge generation layer 1, the charge transport layer 2 and the protective layer 5 constituting the photosensitive layer 6.

The antioxidant includes, for example, hindered phenols, hindered amines, paraphenylenediamine, arylalkanes, hydroquinone, spirochroman, spiroindanone and their derivatives, organic sulfur compounds and organic phosphorus compounds.

The light stabilizer includes, for example, derivatives of benzophenone, benzotriazole, dithiocarbamate, tetramethylpiperidine.

The photosensitive layer may contain at least one electron-accepting substance for the purpose of increasing the sensitivity, reducing the residual potential and reducing the fatigue thereof in repeated use. The electron-accepting substance includes, for example, succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, phthalic acid. Of those, especially preferred are fluorenone compounds, quinone compounds, and benzene derivatives having an electron-attracting substituent such as Cl, CN or NO₂.

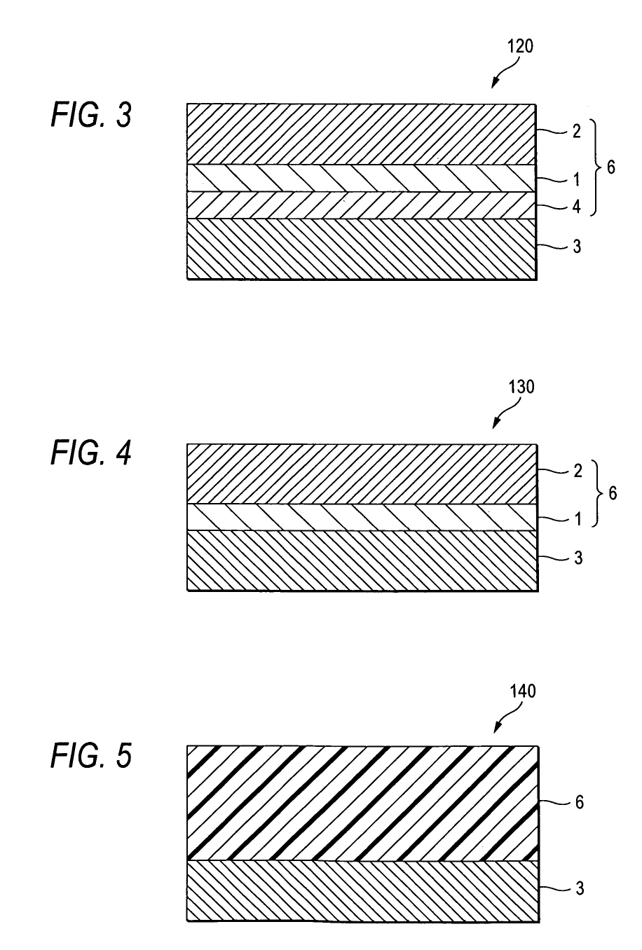

One preferred embodiment of the electrophotographic photoreceptor that comprises a charge transport film of the invention is described hereinabove, to which, however, the invention should not be limited. For example, the electrophotographic photoreceptor 100 in FIG. 1 has a structure of an undercoat layer 4, a charge generation layer 1, a charge transport layer 2 and a protective layer 5 laminated in that order on a conductive support 3 . However, the electrophotographic photoreceptor may not have the undercoat layer, like the electrophotographic photoreceptor 110 of FIG. 2. The electrophotographic photoreceptor may not have the protective layer, like the electrophotographic photoreceptor 120 of FIG. 3. The electrophotographic photoreceptor may not have both the undercoat layer and the protective layer, like the electrophotographic photoreceptor 130 of FIG. 4. In the electrophotographic photoreceptors of FIGS. 1 to 4, the lamination order of the charge generation layer 1 and the charge transport layer 2 is not defined, or that is, any of these layers may be an upper layer.

When the electrophotographic photoreceptor does not have a protective layer like the electrophotographic photoreceptors 120 and 130, then the charge transport layer 2 may be the first functional layer of a cured product of a composition that contain the compound of formula (I). In this case, the charge-transporting material for the charge transport layer 2 may be the compound of formula (I) alone, but may be a combination of the compound with any of the charge-transporting materials mentioned hereinabove for the charge transport layer 2. Further, any desired thermosetting resin or thermoplastic resin may be mixed in the layer-forming composition for controlling the strength, the film formability and the electric properties of layer.

In the electrophotographic photoreceptor of the invention, any one of the layers constituting the photosensitive layer 6 may be the first functional layer of a cured product of a composition that contains the compound of formula (I). This means that the electrophotographic photoreceptor may have the protective layer 5 like the electrophotographic photoreceptors 100 and 110; or, for example, the charge transport layer 2 may be the first functional layer in place of the protective layer 5; or plural layers of constituting the photosensitive layer 6 may be the first functional layer; or, for example, both the protective layer 5 and the charge transport layer 2 may be the first functional layer.

The electrophotographic photoreceptor may be a single-layered photoreceptor, like the electrophotographic photoreceptor 140 of FIG. 5. In this case, the photosensitive layer has a single-layered structure comprising both a charge-generating material and a binder resin, and the single-layered photosensitive layer is the first functional layer of a cured product of a composition that contains the compound of formula (I). The charge-generating material may be the same as that used in the charge generation layer of the function-separated photosensitive layer; and the binder resin may be the same as that used in the charge generation layer and the charge transport layer of the function-separated photosensitive layer. The content of the charge-generating material to be in the single-layered photosensitive layer is preferably from 10 to 85% by weight, more preferably from 20 to 50% by weight based on the total solid content of the single-layered photosensitive layer. For improving the photoelectric properties thereof, the single-layered photosensitive layer may contain a charge-transporting material or a charge-transporting polymer material added thereto. The amount of the material is preferably from 5 to 50% by weight based on the total solid content of the single-layered photosensitive layer. The solvent for the coating liquid and the coating method for the single-layered photosensitive layer may be the same as those mentioned hereinabove. Preferably, the thickness of the single-layered photosensitive layer is from 5 to 50 μm or so, more preferably from 10 to 40 μm or so.

(Image-Forming Apparatus and Process Cartridge)

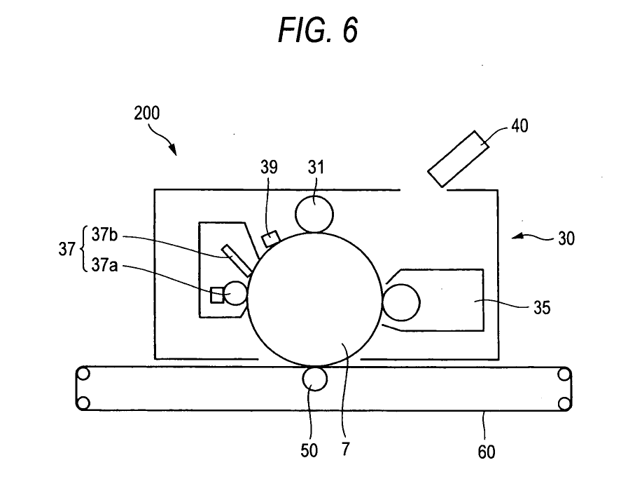

FIG. 6 is a schematic view showing one preferred embodiment of the image-forming apparatus of the invention. The image-forming apparatus 200 of FIG. 6 comprises a process cartridge 30 comprising the electrophotographic photoreceptor 7 of the invention, an exposing device 40, a transfer device 50 and an intermediate transfer medium 60, provided on an image-forming apparatus body (not shown). In the image-forming apparatus 200, the exposing device 40 is disposed in the position where the electrophotographic photoreceptor 7 may be exposed to light via the opening of the process cartridge 30; and the transfer device 50 is disposed in the position where it may face to the electrophotographic photoreceptor 7 via the intermediate transfer medium 60 therebetween; and the intermediate transfer medium 60 is disposed partly in contact with the electrophotographic photoreceptor 7.

The process cartridge 30 comprises a charging device 31, a developing device 35, a cleaning device 37 and a fibrous member (tooth brush-like member) 39 combined and integrated along with the electrophotographic photoreceptor 7 by a fitting rail in a case. The case has an opening for exposure to light.

The charging device 31 is for charging the electrophotographic photoreceptor 7 in a contact mode. The developing device 35 is for developing the electrostatic latent image on the electrophotographic photoreceptor 7 to form a toner image.

The toner for use in the developing device 35 is described below. Preferably, the toner has a mean sphericity coefficient (ML²/A) of from 100 to 150, more preferably from 100 to 140. Also preferably, the toner has a volume-average particle size of from 2 to 12 μm, more preferably from 3 to 9 μm. Using the toner that satisfies the mean sphericity coefficient and the volume-average particle size ensures good developability and transferability and gives high-quality images.

So far as it satisfies the mean sphericity coefficient and the volume-average particle size as above, the toner is not specifically defined in point of its production method. For example, the toner for use herein may be produced according to a kneading and grinding method of kneading a binder resin, a colorant and a lubricant and optionally an antistatic agent, then grinding the mixture and classifying it; a method of further processing the particles obtained according to the kneading and grinding method, by applying mechanical shock or thermal energy thereto to change their shape; an emulsion polymerization aggregation method of mixing a dispersion that is formed through emulsion polymerization of a polymerizing monomer for a binder resin, with a colorant and a lubricant and optionally an antistatic agent, and aggregating and fusing it under heat to obtain toner particles; a suspension polymerization method of suspending a solution of a polymerizing monomer for a binder resin, and a colorant and a lubricant, and optionally an antistatic agent, in an aqueous solvent and polymerizing it; or a solution suspension method of suspending a solution of a binder resin, a colorant and a lubricant and optionally an antistatic agent, in an aqueous solvent and granulating it.

In addition, any other known method is also employable herein, for example, a method of producing core/shell toner particles that comprises adhering aggregated particles to the core toner particles obtained according to the method as above, and heating and fusing them to give toner particles having a core/shell structure. For producing the toner for use herein, especially preferred are the suspension polymerization method, the emulsion polymerization aggregation method and the solution suspension method in which the toner particles are produced in an aqueous solvent, since the methods facilitate sphericity control and particle size distribution control; and more preferred is the emulsion polymerization aggregation method.

The toner base particles comprise a binder resin, a colorant and a lubricant, and optionally contain silica and an antistatic agent.

The binder resin for the toner base particles includes homopolymers and copolymers of styrenes such as styrene, chlorostyrene; monoolefins such as ethylene, propylene, butylene, isobutylene; vinyl esters such as vinyl acetate, vinyl propionate, vinyl benzoate, vinyl butyrate; α-methylene-aliphatic monocarboxylates such as methyl acrylate, ethyl acrylate, butyl acrylate, dodecyl acrylate, octyl acrylate, phenyl acrylate, methyl methacrylate, ethyl methacrylate, butyl methacrylate, dodecyl methacrylate; vinyl ethers such as vinyl methyl ether, vinyl ethyl ether, vinyl butyl ether; vinyl ketones such as vinyl methyl ketone, vinyl hexyl ketone, vinyl isopropenyl ketone; and polyester resins formed through copolymerization of dicarboxylic acids and diols.

Typical examples of the binder resin are polystyrene, styrene-alkyl acrylate copolymers, styrene-alkyl methacrylate copolymers, styrene-acrylonitrile copolymers, styrene-butadiene copolymers, styrene-maleic anhydride copolymers, polyethylene, polypropylene, polyester resins. In addition, polyurethane, epoxy resins, silicone resins, polyamides, modified rosins, and paraffin wax are also usable as the binder resin.

Typical examples of the colorant are magnetic powders such as magnetite, ferrite; and carbon black, aniline blue, chrome yellow, ultramarine blue, DuPont oil red, quinoline yellow, methylene blue chloride, phthalocyanine blue, malachite green oxalate, lamp black, rose bengal, C.I. Pigment Red 48:1, C.I, Pigment Red 122, C.I. Pigment Red 57:1, C.I. Pigment Yellow 97, C.I. Pigment Yellow 17, C.I. Pigment Blue 15:1, C.I. Pigment Blue 15:3.

Typical examples of the lubricant are low-molecular polyethylene, low-molecular polypropylene, Fischer-Tropsch wax, montan wax, carnauba wax, rice wax, candelilla wax.

The antistatic agent may be any known one, for which, for example, usable are azo-type metal complex compounds, salicylate metal complex compounds, and polar group-having resin-type antistatic agents. When the toner is produced according to a wet process, then it is desirable to use hardly water-soluble materials from the viewpoint of ionic strength control and reduction in waste pollution. The toner may be either a magnetic toner that contains a magnetic material or a non-magnetic toner not containing a magnetic material.

The toner for use in the developing device 35 may be produced by mixing the toner base particles and the external additives mentioned above, in a Henschel mixer or a V blender. When the toner base particles are produced in a wet process, then the external additives may be added thereto also in a wet process.

Lubricant particles may be added to the toner for use in the developing device 35. For the lubricant particles, herein usable are solid lubricants such as graphite, molybdenum disulfide, talc, fatty acids, metal salts of fatty acids; low-molecular-weight polyolefins such as polypropylene, polyethylene, polybutene; silicones having a softening point under heat; fatty acid amides such as oleamide, erucamide, ricinoleamide, stearamide; vegetable waxes such as carnauba wax, rice wax, candelilla wax, haze wax, jojoba oil; animal waxes such as bees wax; mineral petroleum waxes such as montan wax, ozokerite wax, ceresine, paraffin wax, microcrystalline wax, Fisher-Tropsch wax; and their modified derivatives. One or more these may be used herein either singly or as combined. Preferably, the lubricant particles have a mean particle size of from 0.1 to 10 μm. The substances having the above-mentioned chemical structure may be ground and dressed into particles having a uniform particle size. The amount of the lubricant particles to be added to the toner is preferably from 0.05 to 2.0% by weight, more preferably from 0.1 to 1.5% by weight.

Inorganic particles, organic particles, or composite particles prepared by adhering inorganic particles to organic particles may be added to the toner for use in the developing device 35, for the purpose of removing sticky substances or degraded substances from the surface of the electrophotographic photoreceptor.

For the inorganic particles, preferably used are various inorganic oxides, nitrides and borides such as silica, alumina, titania, zirconia, barium titanate, altiminium titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride, boron nitride.

The inorganic particles may be processed with a titanium coupling agent such as tetrabutyl titanate, tetraoctyl titanate, isopropyltriisostearyl titanate, iropropyltridecyl benenesulfonyltitanate, bis(dioctylpyrophosphate)oxyacetate titanate; or a silane coupling agent such as γ-(2-aminoethyl)aminopropyltrimethoxysilane, γ-(2-aminoethyl)aminopropylmethyldimethoxysilane, γ-methacryloxypropyltrimethoxysilane, N-β-(N-vinylbenzylaminoethyl)-γ-aminopropyltrimethoxysilane hydrochloride, hexamethyldisilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, p-methylphenyltrimethoxysilane. Those processed for hydrophobication with silicone oil or a higher fatty acid metal salt such as aluminium stearate, zinc stearate or calcium stearate are also preferably used herein.

The organic particles include styrene resin particles, styrene-acrylic resin particles, polyester particles, urethane particles.

Preferably, the mean particle size of the additive particles is from 5 nm to 1000 nm, more preferably from 5 nm to 800 nm, even more preferably from 5 nm to 700 nm. If the mean particle size thereof is smaller than the lowermost limit, then the abrasive capability of the particles may be poor; but if larger than the uppermost limit, then the particles may scratch the surface of the electrophotographic photoreceptor. Preferably, the total amount of the above-mentioned additive particles and the lubricant particles is at least 0.6% by weight.

Regarding other inorganic oxides to be added to the toner, it is desirable that small-size inorganic oxide particles having a primary particle size of at most 40 nm are added thereto for powdery flowability and charge control and those larger than the former are added for stickiness reduction and charge control. For such inorganic oxide particles, any known ones may be used. For these, preferred is a combination of silica and titanium oxide for precision charge control. Surface treatment of the small-size inorganic particles increases the dispersibility of the particles, and the resulting particles are more effective for enhancing the powdery flowability of toner. In addition, carbonates such as calcium carbonate and magnesium carbonate, as well as inorganic minerals such as hydrotalcite are also preferred for use in the toner for the purpose of removing discharged substances.

For its use, the electrophotographic color toner is mixed with a carrier. The carrier includes iron powder, glass beads, ferrite powder, nickel powder, and those coated with resin. The blend ratio of the toner and the carrier may be suitably defined.

The cleaning device 37 comprises a fibrous member (roll) 37a and a cleaning blade 37b.

The cleaning device 37 comprises both the fibrous member 37a and the cleaning blade 37b. However, the cleaning device for use in the invention may have any one of these. The fibrous member 37a is a roll, but it may also be a tooth brush-like member. The fibrous member 37a may be fixed to the body of the cleaning device, or may be rotatably supported by the body, or may be supported by it in such a manner that it can oscillate in the axial direction of the photoreceptor. The fibrous member 37a may be formed of a cloth of polyester, nylon, acryl, or a cloth of ultrafine fibers such as Tracy (by Toray), or may have a brush-like structure formed by planting resin fibers of nylon, acryl, polyolefin, polyester or the like on a substrate or a carpet. The fibrous member 37a as above may be conductive as containing a conductive powder or an ion-conductive agent therein, or may be so designed that every constitutive fiber has a conductive layer formed inside or outside it. The conductive fibrous member of the type is preferably so designed that its constitutive fibers have a resistance of from 10² to 10⁹Ω. Also preferably, the thickness of the constitutive fibers of the fibrous member 37a is at most 30 d (denier), more preferably at most 20 d; and the fiber density of the member is preferably at least 20,000/inch², more preferably at least 30,000/inch².

Comprising the cleaning blade and the cleaning brush, the cleaning device 37 is required to remove the adhered substances (e.g., discharged substances) from the surface of the photoreceptor. For satisfying the object for a long period of time and for stabilizing the function of the cleaning members, it is desirable that a lubricant substance (lubricant component) such as metal soap, higher alcohol, wax or silicone oil is applied to the cleaning members.

For example, when the fibrous member 37a is a roll, then it is desirable that the roll member is contacted with a lubricant substance such as metal soap or wax and the lubricant component is supplied to the surface of the electrophotographic photoreceptor. The cleaning blade 37b may be an ordinary rubber blade. When the cleaning blade 37b is such an ordinary rubber blade, it is especially effective to supply a lubricant component to the surface of the electrophotographic photoreceptor for the purpose of preventing the blade from being cracked or worn.

The process cartridge 30 described above is detachably fitted to the image-forming apparatus body, therefore constituting an image-forming apparatus along with the image-forming apparatus body.

The exposing device 40 may be any one capable of exposing the charged electrophotographic photoreceptor 7 to light so as to form an electrostatic latent image thereon. The light source of the exposing device 40 may be any of semiconductor laser or LED array. Preferred for it is a multi-beam surface-emitting laser in view of its recording speed.

The transfer device 50 may be any one capable of transferring the toner image formed on the electrophotographic photoreceptor 7 onto a transfer medium (e.g., intermediate transfer medium 60). For it, for example, ordinary transfer rolls may be used.

For the intermediate transfer medium 60, herein usable is a belt of polyimide, polyamidimide, polycarbonate, polyarylate, polyester or rubber (intermediate transfer belt). Apart from such a belt, a drum may also be used for the intermediate transfer medium 60.

In practical use of the above-mentioned electrophotographic photoreceptor, paper dust or talc may be released from printing paper and it may often adhere to the electrophotographic photoreceptor. Since the electrophotographic photoreceptor has high abrasion resistance, it is difficult to remove the paper dust or talc from it. Accordingly, for preventing the adhesion of paper power and talc and for obtaining stable images, the intermediate transfer medium 60 is favorably used.

The transfer medium is not specifically defined so far as it may receive the toner image from the electrophotographic photoreceptor onto it. For example, when the image is directly transferred onto paper from the electrophotographic photoreceptor 7, then the paper is the transfer medium; and when the intermediate transfer medium 60 is used, then the intermediate transfer medium is the transfer medium.

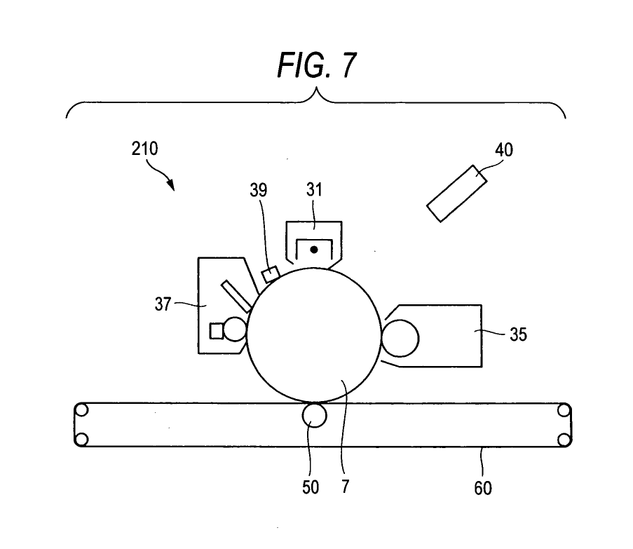

FIG. 7 is a schematic view showing another embodiment of the image-forming apparatus of the invention. In the image-forming apparatus 210 of FIG. 7, the electrophotographic photoreceptor 7 is fixed to the body of the image-forming apparatus, and the charging device 32, the developing device 35 and the cleaning device 37 are independently formed as cartridges. Thus the charger cartridge, the developer cartridge, and the cleaner cartridge are fitted to the photoreceptor independently of each other. The charging device 32 is equipped with a corona discharging-type charging unit.

In the image-forming apparatus 210, the electrophotographic photoreceptor 7 is separated from the other devices, and the charging device 32, the developing device 35 and the cleaning device 37 are fitted to the image-forming apparatus body so as to be detachable from it by pulling them out or pushing them in, not fixed thereto by screwing, calking, bonding or welding.

Since the electrophotographic photoreceptor of the invention has good abrasion resistance, it may be unnecessary to set it in a cartridge. Accordingly, the charging device 32, the developing device 35 and the cleaning device 37 may be fitted to the body so as to be detachable from it by pulling them out or pushing them in, not fixed thereto by screwing, calking, bonding or welding, and the apparatus cost per one print with it may be reduced. Two or more of these devices may be integrated and set in one cartridge, and the cartridge may be detachably fitted to the body of the image-forming apparatus, and with it, the apparatus cost per one print may also be reduced.

The image-forming apparatus 210 has the same constitution as that of the image-forming apparatus 200, except that the charging device 32, the developing device 35 and the cleaning device 37 are independently formed as cartridges in the former.

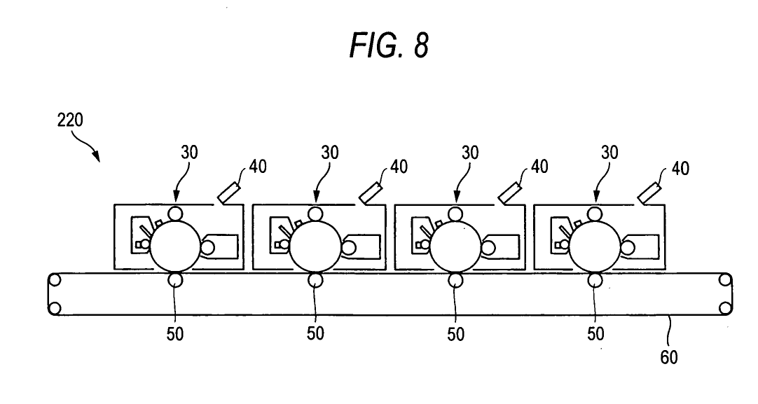

FIG. 8 is a schematic view showing still another embodiment of the image-forming apparatus of the invention. The image-forming apparatus 220 is a tandem-type full-color image-forming apparatus equipped with four process cartridges 30. The image-forming apparatus 220 is so designed that four process cartridges 30 are disposed in parallel to each other on an intermediate transfer medium 60 and one electrophotographic photoreceptor is used for one color. Except that it is a tandem-system apparatus, the image-forming apparatus 220 has the same constitution as that of the image-forming apparatus 200.

In the tandem-type image-forming apparatus 220, the electrophotograpliic photoreceptors differ from each other in point of the degree of abrasion thereof depending on the ratio of the respective color toners used, and therefore the electrophtographic photoreceptors may also differ from each other in point of the electric properties thereof. With that, the toner developability may gradually change from the original stage and the color tone of the printed image may also change, and, as a result, stable images could not be obtained. In particular, since downsized image-forming apparatus are desired these days, the electrophotographic photoreceptor to be in such downsized apparatus tends to be also downsized, and when a photoreceptor having a size of 30 mmφ or smaller is used, then the problem as above may be remarkable. In that condition, when the electrophotographic photoreceptor of the invention is used in such a down-sized image-forming apparatus and even when its diameter is 30 mmφ or smaller, the surface of the photoreceptor may be prevented from being worn. Accordingly, the electrophotographic photoreceptor of the invention is especially effective in tandem-type image-forming apparatus.

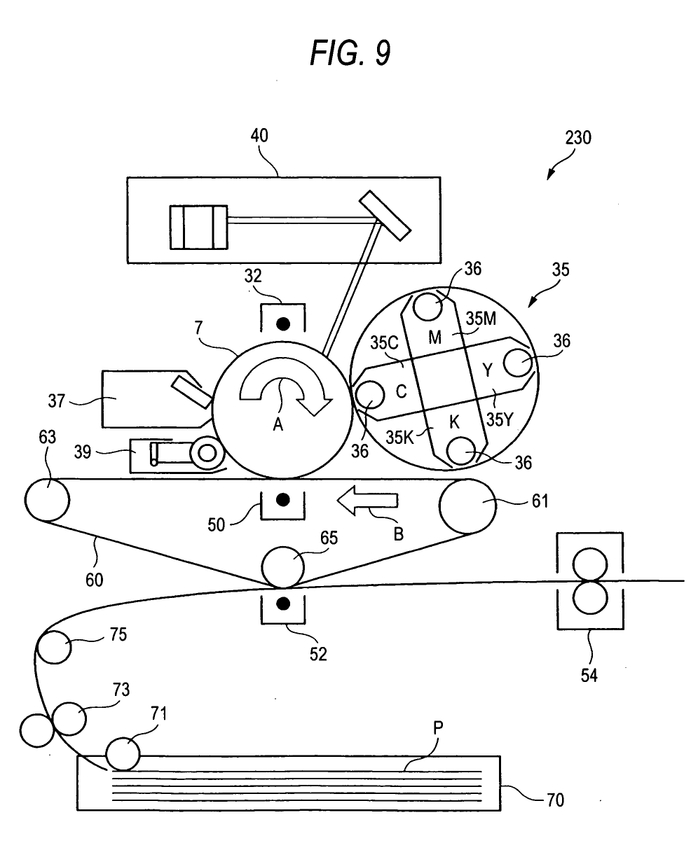

FIG. 9 is a schematic view showing still another embodiment of the image-forming apparatus of the invention. The image-forming apparatus 230 of FIG. 9 is a four-cycle image-forming apparatus in which plural color toner images are formed with one electrophotographic photoreceptor. The image-forming apparatus 230 is equipped with a photoreceptor drum 7, which is rotated in the direction of the arrow A in the drawing at a predetermined revolution speed by a driving device (not shown), and above the photoreceptor drum 7, a charging device 32 is provided which charges the outer peripheral surface of the photoreceptor drum 7.

Above the charging device 32, an exposing device 40 is disposed which comprises a surface-emitting laser array as an exposure light source. The exposing device 40 modulates the plural laser beams emitted by the light source in accordance with the image to be formed while deflecting them in the main scanning direction, and scan them on the outer peripheral surface of the photoreceptor drum 7 in the direction parallel to the axial line of the photoreceptor drum 7. As a result, an electrostatic latent image is formed on the outer peripheral surface of the charged photoreceptor drum 7.

On the side of the photoreceptor drum 7, disposed is a developing device 35. The developing device 35 has a roller housing rotatably fitted to the drum. Inside the housing, four chambers are formed, and the chambers separately have developing units 35Y, 35M, 35C and 35K. The developing units 35Y, 35M, 35C and 35K each are equipped with a developing roller 26, and they each contain the respective Y, M, C and K toners therein.

Full color image formation in the image-forming apparatus 230 is attained while the photoreceptor drum 7 rotates 4 times. Specifically, while the photoreceptor drum 7 rotates 4 times, the charging device 32 charges the outer peripheral surface of the photoreceptor drum 7, and the exposing device 30 scans the laser beams modulated in accordance with any of the image data of Y, M, C and K that indicate the color image to be formed, on the outer peripheral surface of the photoreceptor drum 7. At every rotation of the photoreceptor drum 7, the image data for the modulation of the laser beams are changed, and the operation is repeated four times. The developing device 35 is driven as follows: While the developing roller 36 of any of the developing units 35Y, 35M, 35C and 35K is kept in contact with the outer peripheral surface of the photoreceptor drum 7, the developing unit that is in contact with the outer peripheral surface of the drum is driven so as to develop the electrostatic latent image formed on the outer peripheral surface of the photoreceptor drum 7 in a specific color, whereby a toner image of the specific color is formed on the outer peripheral surface of the photoreceptor drum 7. At every rotation of the photoreceptor drum 7, the housing of the developing device is so rotated that the developing unit for the development of the electrostatic latent image may be changed. Accordingly, at every rotation of the photoreceptor drum 7, any one of Y, M, C and K toner images is successively formed on the outer peripheral surface of the photoreceptor drum 7, overlapping with the underlying image; and after four rotations of the photoreceptor drum 7, a full-color toner image is thus formed on the outer peripheral surface of the photoreceptor drum 7.

Nearly below the photoreceptor drum 7, an endless intermediate transfer belt 60 is disposed. The intermediate transfer belt 60 is hung to run around rollers 61, 63 and 65, and its outer peripheral surface is kept in contact with the outer peripheral surface of the photoreceptor drum 7. The rollers 61, 63 and 65 rotate, receiving a driving power from motors (not shown), and they rotate the transfer intermediate belt 60 in the direction of the arrow B in FIG. 9.

On the opposite side of the photoreceptor drum 7 via the intermediate transfer belt 60 therebetween, a transfer device (transfer unit) 50 is disposed. The transfer device 50 is for transferring the toner image formed on the outer peripheral surface of the photoreceptor drum 7 onto the image-forming surface of the intermediate transfer belt 60.

On the opposite side of the developing device 35 via the photoreceptor drum 7 therebetween, a lubricant-feeding device 39 and a cleaning device 37 are disposed while kept in contact with the outer surface of the photoreceptor drum 7. When the toner image formed on the outer peripheral surface of the photoreceptor drum 7 is transferred onto the intermediate transfer belt 60, then a lubricant is fed to the outer peripheral surface of the photoreceptor drum 7 from the lubricant-feeding device 39, and the region of the outer peripheral surface of the drum having carried the toner image is cleaned by the cleaning device 37.

Below the intermediate transfer belt 60, a tray 70 is disposed, and a large number of sheets of copying paper P, as a recording material, are piled up in the tray 70. On the left oblique upper side of the tray 70, a take-up roller 71 is disposed, and a pair of rollers 73 and a roller 75 are disposed in that order downstream the traveling direction of the paper P from the take-up roller 71. The recording paper on the uppermost position in the pile thereof is taken out of the tray 70 at every rotation of the take-up roller 71, and is then conveyed by the pair rollers 73 and the roller 75.

On the opposite side of the roller 65 via the intermediate transfer belt 60 therebetween, a transfer device 52 is disposed. The copying paper P conveyed by the pair rollers 73 and the roller 75 is led between the intermediate transfer belt 60 and the transfer device 52, and the toner image formed on the image-forming surface of the intermediate transfer belt 60 is thus transferred onto the paper P by the transfer device 52. On the side downstream the traveling direction of the paper P from the transfer device 52, a fixing device 54 with a pair of fixing rollers therein is disposed, in which in the copying paper P with the toner image transferred thereon, the toner image is fused and fixed on the paper P by the fixing device 54, and then the paper P is led out of the image-forming apparatus 230 and put on a paper tray (not shown).

### EXAMPLES

The invention is described in more detail with reference to the following Examples, to which, however, the invention should not be limited.

[Preparation of Developer]

In the following description of developers, the physical data of the samples are determined according to the methods mentioned below. Concretely, the particle size distribution of the toner and the composite particles is determined by the use of Multisizer (by Nikkaki) having an aperture diameter of 100 μm. The mean sphericity coefficient ML²/A of the toner and the composite particles is meant to indicate the value calculated according to the following formula.
ML²/A=(maximum length)²×π×100/(area×4).
A true sphere has ML²/A=100. Concretely, the mean sphericity coefficient is determined as follows: Each projected toner particle image is inputted into an image analyzer (Luzex-III, by Nireco) through an optical microscope, and its circle-corresponding diameter is measured. The maximum length and the area of 10 toner particles is introduced into the above formula ML²/A, and the mean sphericity coefficient of the toner particles is thus obtained.
<Production of Toner Base Particles>
(Preparation of Dispersion of Resin Particles)

370 parts by weight of styrene, 30 parts by weight of n-butyl acrylate, 8 parts by weight of acrylic acid, 24 parts by weight of dodecanethiol, and 4 parts by weight of carbon tetrabromide are mixed and dissolved. The resulting solution is added to a mixture of 6 parts by weight of a nonionic surfactant (Nonipol 400 by Sanyo Chemical Industry, Ltd), 10 parts by weight of an anionic surfactant (Neogen SC by Daiichi Kogyo Seiyaku Co., Ltd.) and 550 parts by weight of ion-exchanged water in a flask, and polymerized in a mode of emulsion polymerization. Then, with gradually stirring for 15 minutes, 50 parts by weight of ion-exchanged water with 4 parts by weight of ammonium persulfate dissolved therein is put into it. After the flaks is purged with nitrogen, the mixture therein is heated up to 70° C. in an oil bath with stirring, and then the emulsion polymerization is further continued for 5 hours as it is. As a result, a dispersion of resin particles is obtained in which the resin particles have a mean particle size of 150 nm, a glass transition temperature (Tg) of 57° C., and a weight-average molecular weight (Mw) of 10900. The solid concentration of the dispersion is 40% by weight.

(Preparation of Colorant Dispersion (1))

60 parts by weight of carbon black (Mogul L by Cabot Corporation), 6 parts by weight of a nonionic surfactant (Nonipol 400 by Sanyo Chemical Industry, Ltd), and 240 parts by weight of ion-exchanged water are mixed and stirred in a homogenizer (Ultratalax T50 by IKA) for 10 minutes. Next, this is dispersed in an ultimizer to give a colorant dispersion (1) in which the colorant (carbon black) particles have a volume-average particle size of 250 nm.

(Preparation of Colorant Dispersion (2))

60 parts by weight of a cyan pigment (B15:3 by Dainichi Seika), 5 parts by weight of a nonionic surfactant (Nonipol 400 by Sanyo Chemical Industry, Ltd), and 240 parts by weight of ion-exchanged water are mixed and stirred in a homogenizer (Ultratalax T50 by IKA LABORTECHNIK) for 10 minutes, and then dispersed in an ultimizer to give a colorant dispersion (2) in which the colorant (cyan pigment) particles have a volume-average particle size of 250 nm.

(Preparation of Colorant Dispersion (3))

60 parts by weight of a magenta pigment (R122 by Dainichiseika Color & Chemicals Mfg. Co., Ltd), 5 parts by weight of a nonionic surfactant (Nonipol 400 by Sanyo Chemical Industry. Ltd), and 240 parts by weight of ion-exchanged water are mixed and stirred in a homogenizer (Ultratalax T50 by IKA LABORTECHNIK) for 10 minutes, and then dispersed in an ultimizer to give a colorant dispersion (3) in which the colorant (magenta pigment) particles have a volume-average particle size of 250 nm.

(Preparation of Colorant Dispersion (4))

90 parts by weight of an yellow pigment (Y180 by Dainichiseika Color & Chemicals Mfg. Co., Ltd), 5 parts by weight of a nonionic surfactant (Nonipol 400 by Sanyo Chemical Industry. Ltd), and 240 parts by weight of ion-exchanged water are mixed and stirred in a homogenizer (Ultratalax T50 by IKA LABORTECHNIK) for 10 minutes, and then dispersed in an ultimizer to give a colorant dispersion (4) in which the colorant (magenta pigment) particles have a volume-average particle size of 250 nm.

(Preparation of Lubricant Dispersion)

100 parts by weight of paraffin wax (HNP0190 by Nippon Seiro Co., Ltd, having a melting point of 85° C.), 5 parts by weight of a cationic surfactant (Sunnysol B50 by Kao Corporation) and 240 parts by weight of ion-exchanged water are mixed, and dispersed in a rounded stainless steel flask by the use of a homogenizer (Ultratalax T50 by IKA LABORTECHNIK) for 10 minutes. This is further dispersed by the use of a jet homogenizer to give a lubricant dispersion in which the lubricant particles have a volume-average particle size of 540 nm.

(Preparation of Toner Base Particles K)

235 parts by weight of the resin particles dispersion, 30 parts by weight of the colorant dispersion (1), 40 parts by weight of the lubricant dispersion, 0.5 parts by weight of polyaluminium hydroxide (Paho 2S by Asada Chemical), and 600 parts by weight of ion-exchanged water are put into a rounded stainless steel flask, and mixed and dispersed therein by the use of a homogenizer (Ultratalax T50 by IKA LABORTECHNIK). This is heated up to 45° C. in a heating oil bath with stirring the mixture in the flask, and this is kept at 45° C. for 25 minutes. In this stage, the presence of aggregated particles having a volume-average particle size D50 of 4.5 μm is confirmed in the mixture. The temperature of the heating oil bath is further elevated, and the flask in the bath is kept at 58° C. for 1 hour, whereupon D50 of the particles became 5.3 μm. Next, 26 parts by weight of the resin particles dispersion is added to the dispersion of the aggregated particles, and then this is kept heated at 50° C. for 30 minutes in the heating oil bath. 1 N sodium hydroxide is added to the dispersion of the aggregated particles so as to make the dispersion have a pH of 7.0, and then the stainless flask is closed. This is heated up to 80° C. with stirring by the use of a magnetic seal, and kept as such for 4 hours. After the dispersion is cooled, the toner base particles formed in the dispersion are filtered out and washed five times with ion-exchanged water. After freeze-dried, this is toner base particles K1. The toner base particles K1 have a volume-average particle size D50 of 5.9 μm and a mean sphericity coefficient ML²/A of 134.

(Preparation of Toner Base Particles C)

Toner base particles C are prepared in the same manner as that for the toner base particles K, for which, however, the colorant dispersion (2) is used in place of the colorant dispersion (1). The toner base particles C have a volume-average particle size D50 of 5.7 μm and a mean sphericity coefficient ML²/A of 130.

(Preparation of Toner Base Particles M)

Toner base particles M are prepared in the same manner as that for the toner base particles K, for which, however, the colorant dispersion (3) is used in place of the colorant dispersion (1). The toner base particles M have a volume-average particle size D50 of 5.5 μm and a mean sphericity coefficient ML²/A of 135.

(Preparation of Toner Base Particles Y)

Toner base particles Y are prepared in the same manner as that for the toner base particles K, for which, however, the colorant dispersion (4) is used in place of the colorant dispersion (1). The toner base particles Y1 have a volume-average particle size D50 of 5.8 μm and a mean sphericity coefficient ML²/A of 133.

<Production of Carrier>

15 parts by weight of toluene, 2 parts by weight of styrene/methacrylate copolymer (component ratio, 90/10) and 0.2 parts by weight of carbon black (R330 by Cabot Corporation) are stirred and dispersed in a stirrer for 20 minutes to prepare a coating liquid. The coating liquid and 100 parts by weight of ferrite particles (having a volume-average particle size of 55 μm) are put into a vacuum degassing kneader, and stirred at 60° C. for 30 minutes. Then, this is degassed with further heating under reduced pressure, and its contents are dried to give a carrier. The carrier have a volume-intrinsic resistivity value of 1×10¹⁰ Ωcm in an applied electric field of 1000 V/cm.

<Preparation of K, C, M, Y Toners>

100 parts by weight of each of the toner base particles K, C, M and Y are mixed with 1 part by weight of rutile-type titanium oxide (having a particle size of 20 nm, processed with n-decyltrimethoxysilane), 2.0 parts by weight of silica (having a particle size of 40 nm, prepared according to a vapor-phase oxidation process and processed with silicone oil), 1 part by weight of cerium oxide (having a volume-average particle size of 0.7 μm), and 0.3 parts by weight of a mixture prepared by mixing higher fatty acid alcohol (higher fatty acid alcohol having a molecular weight of 700), zinc stearate and calcium carbonate (having a volume-average particle size of 0.1 μm) in a ratio (by weight) of 5:1:1 and grinding them with a jet mill into particles having a volume-average particle size of 8.0 μm, in a 5-liter Henschel mixer at a peripheral speed of 30 m/sec for 15 minutes. Next, this is screened through a 45 μm-mesh sieve to remove coarse particles; and K (black), C (cyan), M (magenta) and Y (yellow) toners all with external additives on their surfaces are obtained.

<Preparation of Developer>

5 parts by weight of each toner of K, C, M and Y with external additives on their surfaces as above is stirred with 100 parts by weight of the carrier as above, in a V-blender at 40 rpm for 20 minutes. Next, this is screened through a 212 μm-mesh sieve to obtain a developer.

[Production of I-type Hydroxygallium Phthalocyanine]

30 parts by weight of 1,3-diiminoisoindoline and 9.1 parts by weight of gallium trichloride are added to 230 parts by weight of dimethylsulfoxide, and reacted with stirring at 160° C. for 6 hours to give a reddish violet crystal. The resulting crystal is washed with dimethylsulfoxide and then with ion-exchanged water, and dried to give 29 parts by weight of a crude crystal of I-type chlorogallium phthalocyanine. Next, 10 parts by weight of the crude crystal of I-type chlorogallium phthalocyanine is fully dissolved in 300 parts by weight of sulfuric acid (concentration 97% by weight) heated at 60° C., and the resulting solution dropwise put into a mixture of 600 parts by weight of 25% aqueous ammonia and 200 parts by weight of ion-exchanged water, and a crystal of hydroxygallium phthalocyanine is thus deposited. The crystal is taken out through filtration and washed with ion-exchanged water, and then dried to give 8 parts by weight of I-type hydroxygallium phthalocyanine pigment.

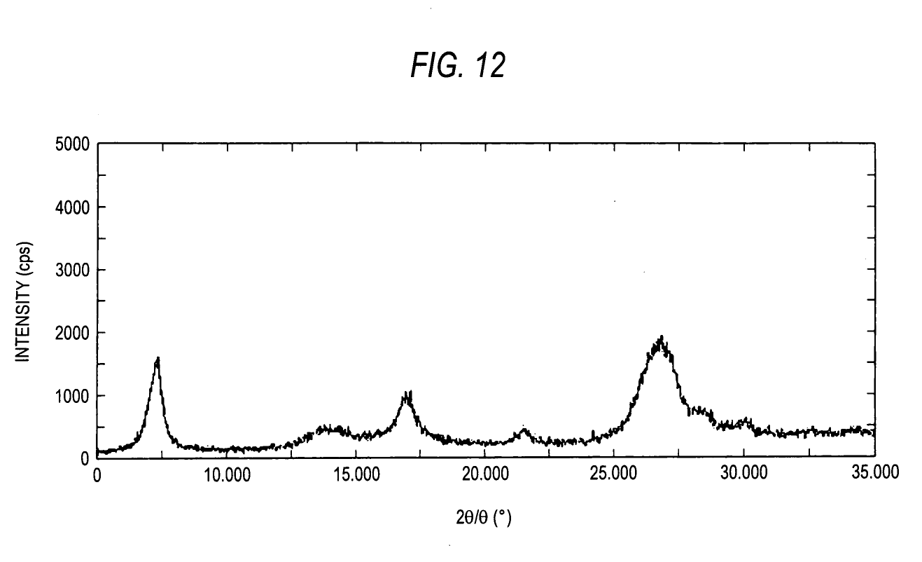

Thus obtained, the I-type hydroxygallium phthalocyanine pigment is analyzed for X-ray diffractiometry. The result is shown in FIG. 12. In this Example, the X-ray diffraction diffractiometry is carried out according to a powder method using a CuKα characteristic X ray (wavelength, 1.54178 angstroms), under the condition mentioned below.

Instrument used: Rigaku Denki's X-ray diffractiometer Miniflex,

X-ray tube: Cu,

Tube current: 15 mA,

Scanning speed: 5.0 deg./min,

Sampling distance: 0.02 deg.,

Start angle (2θ): 5 deg.,

Stop angle (2θ): 35 deg.,

Step angle (2θ): 0.02 deg.

[Production of Hydroxygallium Phthalocyanine Pigment HPC-1]

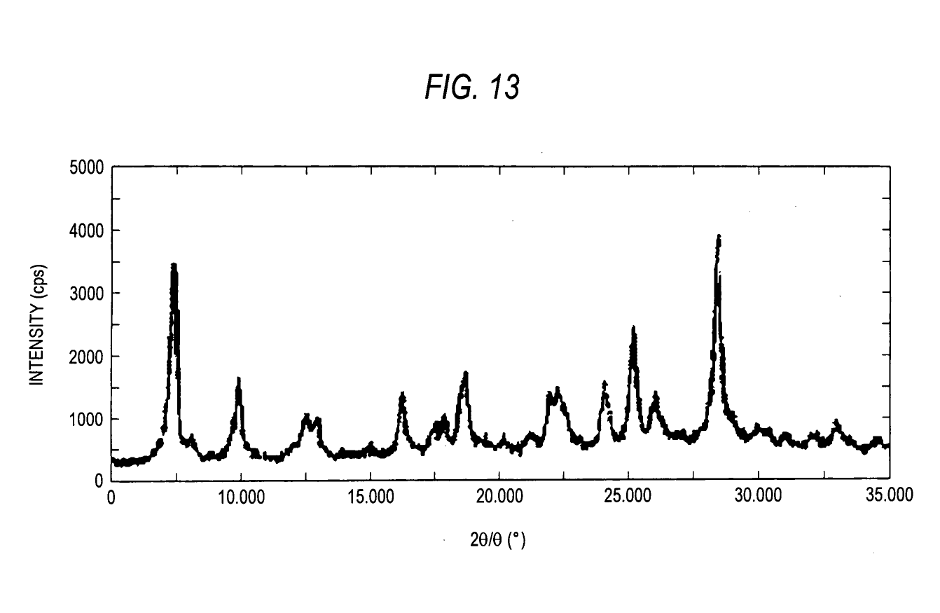

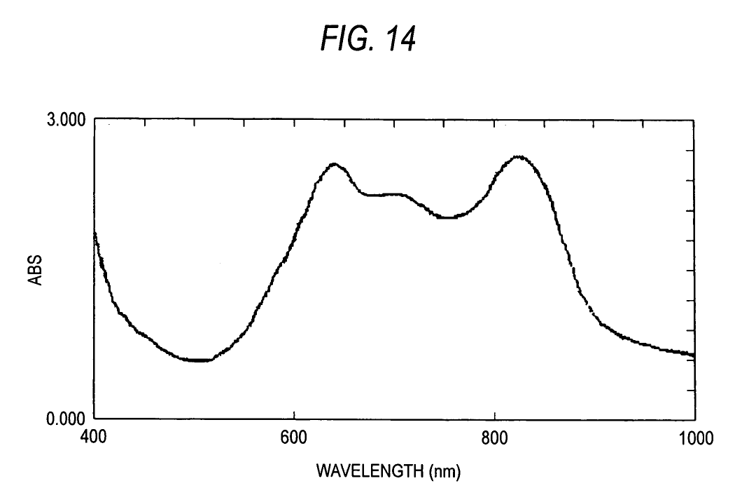

6 parts by weight of the I-type hydroxygallium phthalocyanine pigment obtained in the previous step is wet-ground in a glass ball mill along with 80 parts by weight of N,N-dimethylformamide and 350 parts by weight of spherical glass beads having an outer diameter of 1 mm put therein, at 25° C. for 168 hours. In this stage, the degree of crystal conversion is monitored by measuring the absorption wavelength of the wet-ground liquid, thereby confirming that the maximum peak wavelength (λmax) in the absorption spectrum within a wavelength of from 600 to 900 nm of the wet-ground hydroxygallium phthalocyanine pigment is 823 nm. Next, the crystal thus obtained is washed with acetone and dried. 5.5 parts by weight of hydroxygallium phthalocyanine pigment is thus obtained, having diffraction peaks at a Bragg angle (2θ±0.20) of 7.5°, 9.9°, 12.5°, 16.3°, 18.6°, 25.1° and 28.3° in the X-ray diffraction spectrum thereof with a CuKα characteristic X ray. Thus obtained, the hydroxygallium phthalocyanine pigment is referred to as HPC-1. The X-ray diffraction spectrum of the hydroxygallium phthalocyanine pigment HPC-1 is shown in FIG. 13; and the absorption spectrum thereof is in FIG. 14. The absorption spectrometry is carried out by the use of a Hitachi's spectrometer, Model U-2000. The sample for the measurement is prepared by ultrasonically dispersing 1 mg of the hydroxygallium phthalocyanine pigment in 8 ml of n-butyl acetate at room temperature. The specific surface area of the pigment HPC-1 is measured by the use of a BET-type specific surface area meter (Shimadzu's Flowsoap II2300 by Shimadxu Corporation), and it is 62.57 m²/g.

### Example 1

A 30-mmφ cylindrical aluminium substrate is polished with a centerless polishing device to thereby have a ten point average surface roughness Rz=0.55 μm. Thus processed for centerless polishing, the cylindrical aluminium substrate is washed as follows: This is degreased, then etched with an aqueous 2 weight. % sodium hydroxide solution for 1 minutes, neutralized and washed with pure water in that order. Next, the aluminium substrate is subjected to anodic oxidation with a 10 weight. % sulfuric acid solution (current density, 1.0 A/dm²) to thereby form an oxide film on its surface. After washed with water, this is dipped in a 1 weight. % nickel acetate solution at 80° C. for 20 minutes for sealing the anodic oxide film. Further, this is washed with pure water and dried. The process gave an aluminium substrate with an approximately 6.5 μm-thick anoxic oxide film formed on its surface.

Next, 1 part by weight of chlorogallium phthalocyanine, which has strong diffraction peaks at a Bragg angle (2θ±0.2°) of 7.4°, 16.6°, 25.5° and 28.3° in the X-ray diffraction spectrum thereof, 1 part by weight of polyvinylbutyral (S-LEC BM-S, by Sekisui Chemical Co., Ltd) and 100 parts by weight of n-butyl acetate are mixed, and processed and dispersed in a paint shaker along with glass beads therein for 1 hour to prepare a charge generation layer-forming coating liquid. The coating liquid is applied to the oxide film-coated aluminium substrate by dipping the substrate in the liquid, and dried under heat at 110° C. for 8 minutes to form a charge generation layer having a thickness of about 0.15 μm on the substrate.

Next, 1.5 parts by weight of a benzidine compound of the following formula (IX), 1.0 part by weight of the above-mentioned compound (I-12), 3 parts by weight of a polymer compound having structural units of the following formula (X) (having a viscosity-average molecular weight of 50,000), and 0.005 parts by weight of dodecylbenzenesulfonic acid are dissolved in a mixture of 6 parts by weight of chlorobenzene and 14 parts by weight of tetrahydrofuran to prepare a charge transport layer-forming coating liquid.

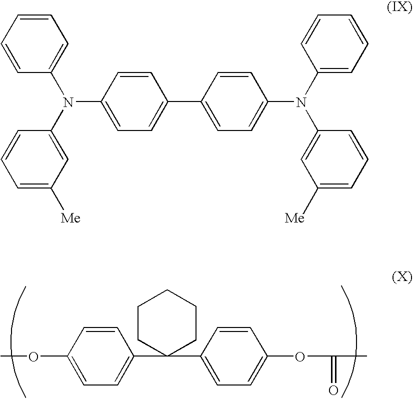

The coating liquid is applied onto the charge generation layer by dipping the substrate in the solution, and cured by heating it at 110° C. for 60 minutes to thereby form thereon a charge transport layer having a thickness of 25 μm. The process gave an electrophotographic photoreceptor.

### Example 2

A honed, 30-mmφ cylindrical aluminium substrate is prepared. Next, 100 parts by weight of a zirconium compound (Orgatix ZC540 by Matsumoto Chemical Industry Co., Ltd), 10 parts by weight of a silane compound (A 1100 by Nippon Unicar Co., Ltd), 400 parts by weight of isopropanol and 200 parts by weight of butanol are mixed to prepare an undercoat layer-forming coating liquid. The coating liquid is applied to the aluminium substrate by dipping the substrate therein, and dried under heat at 150° C. for 10 minutes to form an undercoat layer having a thickness of about 0.1 μm on the substrate.

Next, 1 part by weight of the above-mentioned hydroxygallium phthalocyanine (HPC-1), which has strong diffraction peaks at a Bragg angle (2θ±0.2°) of 7.5°, 9.9°, 12.5°, 16.3°, 18.6°, 25.1° and 28.3° in the X-ray diffraction spectrum thereof, 1 part by weight of polyvinylbutyral (S-LEC BM-S, by Sekisui Chemical Co., Ltd) and 100 parts by weight of n-butyl acetate are mixed, and processed and dispersed in a paint shaker along with glass beads therein for 1 hour to prepare a charge generation layer-forming coating liquid. The coating liquid is applied onto the undercoat layer formed on the substrate by dipping the substrate in the liquid, and dried under heat at 110° C. for 10 minutes to form thereon a charge generation layer having a thickness of about 0.15 μm.

Next, 2.0 parts by weight of a charge-transporting material of the following formula (XI), 1.0 part by weight of the above-mentioned compound (I-10), 3 parts by weight of a polymer compound having structural units of formula (X) (having a viscosity-average molecular weight of 80,000), and 0.005 parts by weight of dodecylbenzenesulfonic acid are dissolved in 20 parts by weight of chlorobenzene to prepare a charge transport layer-forming coating liquid.

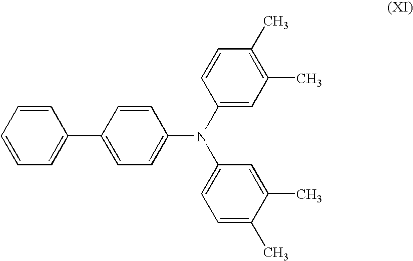

The coating liquid is applied onto the charge generation layer by dipping the substrate in the solution, and cured by heating it at 110° C. for 60 minutes to thereby form thereon a charge transport layer having a thickness of 25 μm. The process gave an electrophotographic photoreceptor.

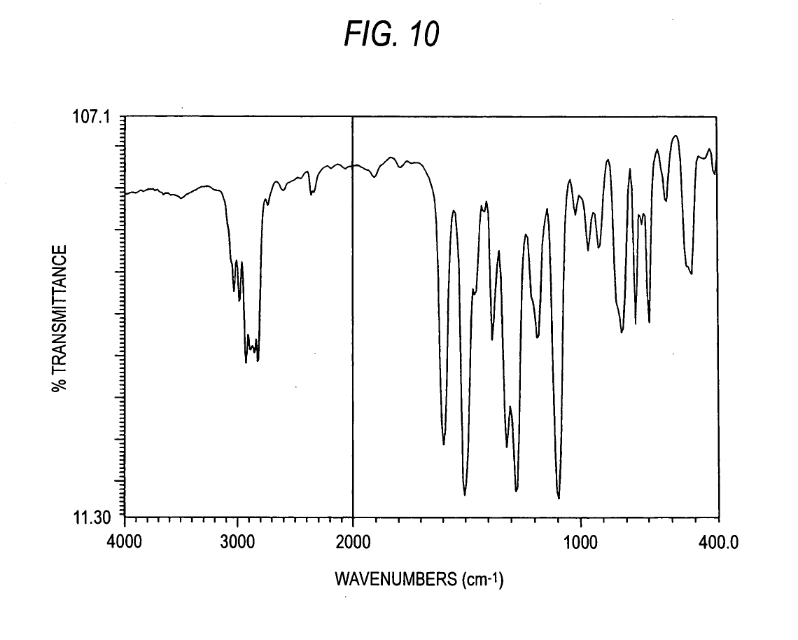

The compound (I-10) is prepared as follows: 100 g of 4,4′-bishydroxymethyltriphenylamine is dissolved in 600 ml of tetrahydrofuran, and 120 g of potassium t-butoxide is added thereto and stirred for 1 hour. A solution prepared by dissolving 160 g of methyl iodide in 80 ml of tetrahydrofuran is gradually and dropwise added to it, taking 2 hours. After the addition, this is well stirred for 2 hours, and then transferred into a liquid-liquid separation funnel, to which is added 500 ml of toluene. This is washed four times with 500 ml of distilled water. The toluene layer is dried, and the solvent is evaporated away. Then, this is purified through silica gel column chromatography to obtain 102 g of the compound (I-10). FIG. 10 shows the R spectrum of the thus-obtained compound (I-10). The IR spectrum is determined with an IR spectrophotometer (HORIBA FT-730, by Horiba Ltd).

### Example 3

100 parts by weight of zinc oxide (TAYCA CORPORATION's trial product, having a specific surface area of 16 m²/g and a mean particle size of 70 nm) and 500 parts by weight of toluene are stirred and mixed, and 1.5 parts by weight of a silane coupling agent (KBM603 by Shin-Etsu Chemical Co., Ltd) is added thereto and stirred for 2 hours. Then, toluene is evaporated away under reduced pressure, and this is baked at 150° C. for 2 hours. 60 parts by weight of the surface-treated zinc oxide, 15 parts by weight of a curing agent, blocked isocyanate (Sumidur 3175 by Sumitomo Bayer Urethane), and 15 parts by weight of a butyral resin (S-LEC BM-1 by Sekisui Chemical Co., Ltd) are dissolved in 85 parts by weight of methyl ethyl ketone. 38 parts by weight of the resulting solution is mixed with 25 parts by weight of methyl ethyl ketone, and dispersed in a sand mill along with 1-mmφ glass beads therein for 2 hours to prepare a dispersion. To the resulting dispersion, added are 0.005 parts by weight of a catalyst, dioctyltin dilaurate, and 0.01 parts by weight of silicone oil (SH29PA by Dow Corning Toray Silicone Co., Ltd) to prepare an undercoat layer-forming coating liquid. The coating liquid is applied onto a 30-mmφ cylindrical aluminium substrate by dipping the substrate in the liquid, and dried under heat at 160° C. for 100 minutes to form an undercoat layer having a thickness of 20 μm on the substrate.

Next, 1 part by weight of the above-mentioned hydroxygallium phthalocyanine (BPC-1), which has strong diffraction peaks at a Bragg angle (2θ±0.2°) of 7.5°, 9.9°, 12.5°, 16.3°, 18.6°, 25.1° and 28.30 in the X-ray diffraction spectrum thereof, 1 part by weight of polyvinylbutyral (Eslec BM-S, by Sekisui Chemical) and 100 parts by weight of n-butyl acetate are mixed, and processed and dispersed in a paint shaker along with glass beads therein for 1 hour to prepare a charge generation layer-forming coating liquid. The coating liquid is applied onto the undercoat layer formed on the substrate by dipping the substrate in the liquid, and dried under heat at 110° C. for 10 minutes to form thereon a charge generation layer having a thickness of about 0.15 μm.

Next, 1.0 part by weight of the compound (I-1), 2.0 parts by weight of the compound (I-10), 3 parts by weight of a polymer compound having structural units of formula (X) (having a viscosity-average molecular weight of 46,000), and 0.005 parts by weight of dodecylbenzenesulfonic acid are dissolved in 20 parts by weight of chlorobenzene to prepare a charge transport layer-forming coating liquid. The coating liquid is applied onto the charge generation layer by dipping the substrate in the liquid, and cured by heating it at 110° C. for 60 minutes to thereby form thereon a charge transport layer having a thickness of 25 μm. The process gave an electrophotographic photoreceptor.

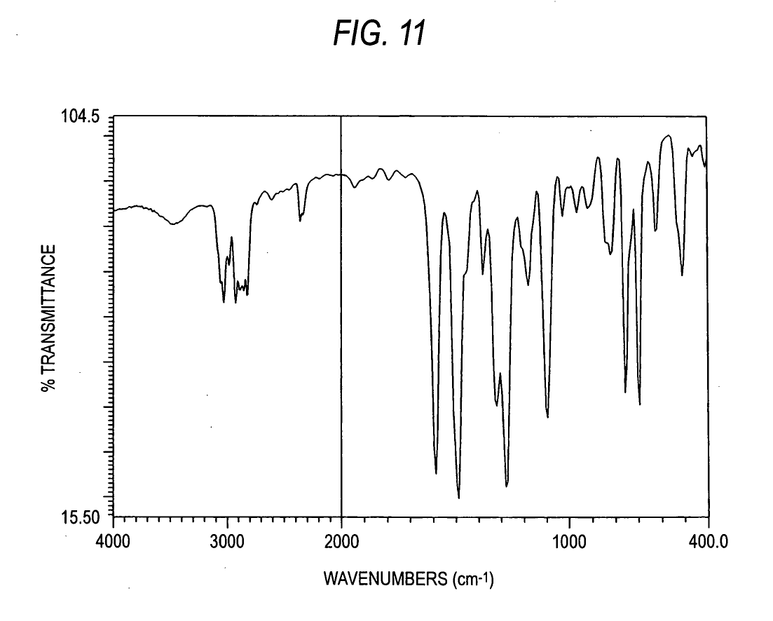

The compound (I-1) is prepared as follows: 100 g of 4-hydroxymethyltriphenylamine is dissolved in 600 ml of tetrahydrofuran, and 60 g of potassium t-butoxide is added thereto and stirred for 1 hour. A solution prepared by dissolving 80 g of methyl iodide in 40 ml of tetrahydrofuran is gradually and dropwise added to it, taking 2 hours. After the addition, this is well stirred for 2 hours, and then transferred into a liquid-liquid separation funnel, to which is added 500 ml of toluene. This is washed four times with 500 ml of distilled water. The toluene layer is dried, and the solvent is evaporated away. Then, this is purified through silica gel column chromatography to obtain 82 g of the compound (I-1). FIG. 11 shows the IR spectrum of the thus-obtained compound (I-1). The IR spectrum is determined with an IR spectrophotometer (HORIBA FT-730, by Horiba Ltd).

### Comparative Example 1

An electrophotographic photoreceptor is fabricated in the same manner as in Example 1, for which, however, 1.0 part by weight of the charge-transporting compound of formula (XI) is used in place of 1.0 part by weight of the compound (I-12) in preparing the charge transport layer-forming coating liquid.

### Comparative Example 2

An electrophotographic photoreceptor is fabricated in the same manner as in Example 2, for which, however, 3.0 parts by weight of the charge-transporting compound of formula (M) is used in place of 1.0 part by weight of the compound (I-10) in preparing the charge transport layer-forming coating liquid.

### Comparative Example 3

An electrophotographic photoreceptor is fabricated in the same manner as in Example 3, for which, however, 3.0 parts by weight of the benzidine compound of formula (IX) is used in place of 1.0 part by weight of the compound (I-1) and 2.0 parts by weight of the compound (I-10) in preparing the charge transport layer-forming coating liquid.

### Comparative Example 4

Fabricating an electrophotographic photoreceptor is tried in the same manner as in Example 2, for which, however, 1.0 part by weight of a triphenylamine compound of the following formula (XII) is used in place of 1.0 part by weight of the compound (I-10). In this, however, the charge transport layer formed is cloudy and is not transparent. 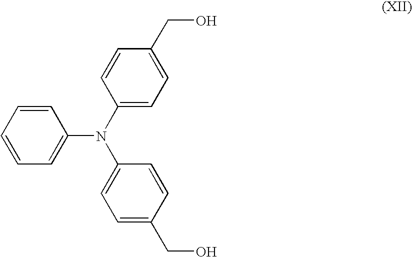
[Evaluation Test for Characteristics of Electrophotographic Photoreceptors]

Any of the electrophotographic photoreceptors fabricated in Examples 1 to 3 and Comparative Examples 1 to 3 is combined with the above-mentioned developer, and mounted on a printer (DocuCentre Color 400 CP Model, manufactured by Fuji Xerox Co., Ltd) to construct an image-forming apparatus. The thus-constructed image-forming apparatus is tested as follows: In this, the photoreceptor surface is charged at −700V, at room temperature and humidity (20° C., 50% RH), and exposed to 780-nm flash light of 4.9 mJ/m². After 50 milliseconds, the surface potential of the photoreceptor is measured. This operation is repeated 10,000 times, and the difference (ΔV_{L}) between the surface potential after once exposure and that after 10,000 times exposure is determined. The difference indicates the stability of the residual potential of the photoreceptor. The potential V₀ of the charged photoreceptor surface is measured, and after 1 second, the surface potential V₁ thereof is again measured. The dark decay ratio (DDR) (%) is obtained as {(V₀−V₁)/V₀}×100, and it indicates the chargeability of the photoreceptor.

An image formation test for 10,000 copies is carried out in a low-temperature low-humidity environment (10° C., 20% RH), and then an image formation test for 10,000 copies is also carried out in a high-temperature high-humidity environment (28° C., 75% RH). After the tests for 20,000 copies in all, the print quality is visually checked for the presence or absence of image defects. In addition, after the tests for 20,000 copies, the photoreceptor is checked for the abrasion, and the unit abrasion per 1000 revolutions is computed. The results are given in Table 23.

TABLE 23

| | | | Abrasion | |
|---|---|---|---|---|
| | ΔV_{L} (V) | DDR (%) | (nm/K cycle) | Image Quality |
| Example 1 | 22 | 8.7 | 50 | no defect |
| Example 2 | 25 | 8.4 | 45 | no defect |
| Example 3 | 27 | 8.6 | 39 | no defect |
| Comparative | 33 | 8.9 | 69 | streaky defects |
| Example 1 | | | | |
| Comparative | 35 | 9.1 | 60 | streaky defects |
| Example 2 | | | | |
| Comparative | 38 | 9.2 | 61 | streaky defects |
| Example 3 | | | | |

The results in Table 23 obviously confirm that the electrophotographic photoreceptors of the invention (Examples 1 to 3) are better than the electrophotographic photoreceptors of Comparative Examples 1 to 3 in that the former effectively prevent the charging potential fluctuation in repeated charging and exposure and that the former are free from image defects. They further confirm that the electrophotographic photoreceptors of the invention (Examples 1 to 3) are also better than the electrophotographic photoreceptors of Comparative Examples 1 to 3 in that the abrasion of the former in repeated image formation is smaller than that of the latter.

### Example 4

An undercoat layer and a charge generation layer are successively formed on an aluminium substrate in the same manner as in Example 3, for which, however, an 84-mmφ aluminium substrate is used in place of the 30-mmφ cylindrical aluminium substrate in Example 3. Next, 3 parts by weight of the benzidine compound of formula (IX), and 3 parts by weight of a polymer compound having structural units of formula (X) (having a viscosity-average molecular weight of 46,000) are dissolved in 20 parts by weight of chlorobenzene to prepare a charge transport layer-forming coating liquid. The resulting coating liquid is applied onto the charge generation layer by dipping the substrate in the liquid, and heated at 110° C. for 60 minutes to form thereon a charge transport layer having a thickness of 20 μm.

Next, 5.5 parts by weight of the compound (I-10), 7 parts by weight of a resol-type phenolic resin (PL-2215 by Gunei Chemical Industry Co., Ltd), 0.01 parts by weight of methylphenylpolysiloxane and 0.01 parts by weight of zinc phenolsulfonate are dissolved in 15 parts by weight of isopropanol and 5 parts by weight of methyl ethyl ketone to prepare a protective layer-forming coating liquid. The coating liquid is applied onto the charge transport layer by dipping the substrate in the liquid, and cured by heating it at 140° C. for 40 minutes to thereby form thereon a protective layer having a thickness of 3 μm. The process gave an electrophotographic photoreceptor.

### Example 5

An electrophotographic photoreceptor is constructed in the same manner as in Example 4, for which, however, 5.5 parts by weight of the compound (I-13) is used in place of 5.5 parts by weight of the compound (I-10) in preparing the protective layer-forming coating liquid.

### Example 6

30 parts by weight of phenol, 100 parts by weight of formalin, and 3 parts by weight of triethylamine are mixed, and heated and stirred at 80° C. for 4 hours. Next, the reaction product is concentrated in a rotary evaporator at 40° C. until it gave no distillate, and 50 parts by weight of a phenolic resin A is thus obtained.

An electrophotographic photoreceptor is constructed in the same manner as in Example 4, for which, however, 5 parts by weight of the phenolic resin A is used in place of 7 parts by weight of the resol-type phenolic resin (PL-2215 by Gunei Chemical Industry Co., Ltd) in preparing the protective layer-forming coating liquid.

### Example 7

In the same manner as in Example 4, an undercoat layer, a charge generation layer and a charge transport layer are successively formed on an aluminium substrate.

Next, 10 parts by weight of tin oxide particles (S-2000 by Mitsubishi Material Corporation), 0.5 parts by weight of trifluoropropyltrimethoxysilane and 50 parts by weight of toluene are mixed and heated and stirred at 90° C. for 2 hours. Next, toluene is evaporated away, and then this is heated at 130° C. for 1 hour.

1 part by weight of the thus-processed tin oxide particles, 5.5 parts by weight of the compound (I-10), 7 parts by weight of a resol-type phenolic resin (PL-4852 by Gunei Chemical Industry Co., Ltd), 0.01 parts by ms of methylphenylpolysiloxane and 0.01 parts by weight of zinc phenolsulfonate are dissolved in 15 parts by weight of isopropanol and 5 parts by weight of methyl ethyl ketone. 20 parts by weight of 2-mmφ glass beads are added to the resulting solution, and this is dispersed in a paint shaker for 1 hour. Then, the glass beads are removed through filtration, and a protective layer-forming coating liquid is thus prepared. The coating liquid is applied onto the charge transport layer by dipping the substrate in the liquid, and cured by heating it at 140° C. for 40 minutes to thereby form thereon a protective layer having a thickness of 3 μm. The process gave an electrophotographic photoreceptor.

### Comparative Example 5

An electrophotographic photoreceptor is constructed in the same manner as in Example 4, for which, however, 5.5 parts by weight of a compound of the following formula (XI) is used in place of 5.5 parts by weight of the compound (I-10) in preparing the protective layer-forming coating liquid.

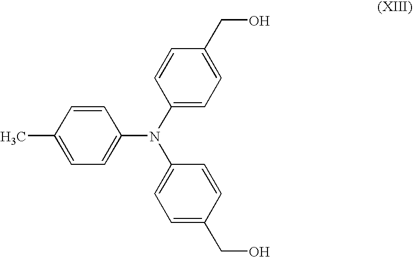

### Comparative Example 6

An electrophotographic photoreceptor is constructed in the same manner as in Example 4, for which, however, 5.5 parts by weight of a compound of the following formula (XIV) is used in place of 5.5 parts by weight of the compound (I-10) in preparing the protective layer-forming coating liquid.

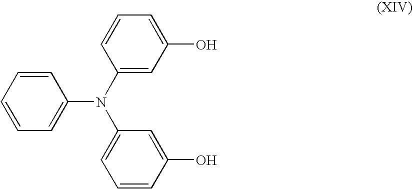

### Comparative Example 7

An electrophotographic photoreceptor is constructed in the same manner as in Example 4, for which, however, 5.5 parts by weight of the compound of formula (XIII) is used in place of 5.5 parts by weight of the compound (I-10) in preparing the protective layer-forming coating liquid.

[Evaluation Test for Characteristics of Electrophotographic Photoreceptors]

Any of the electrophotographic photoreceptors fabricated in Examples 4 to 7 and Comparative Examples 5 to 7 is combined with the above-mentioned developer, and mounted on a printer (DocuCentre Color 500 Model, manufactured by Fuji Xerox Co., Ltd) to construct an image-forming apparatus, in which the exposing device is reformed into a multi-beam surface-emitting laser having an oscillation wavelength of 780 nm. The thus-constructed image-forming apparatus is tested as follows: In this, the photoreceptor surface is charged at −700V, at room temperature and humidity (20° C., 50% RH), and exposed to 780-nm flash light of 4.9 mJ/m². After 50 milliseconds, the surface potential of the photoreceptor is measured. This operation is repeated 10,000 times, and the difference (ΔV_{L}) between the surface potential after once exposure and that after 10,000 times exposure is determined. The difference indicates the stability of the residual potential of the photoreceptor. The potential V₀ of the charged photoreceptor surface (−700 V) is measured, and after 1 second, the surface potential V₁ thereof is again measured. The dark decay ratio (DDR) (%) is obtained as {(V₀−V₁)/V₀}×100, and it indicates the charging potential stability of the photoreceptor.

An image formation test for 10,000 copies is carried out in a low-temperature low-humidity environment (10° C., 20% RH), and then an image formation test for 10,000 copies is also carried out in a high-temperature high-humidity environment (28° C., 75% RH). After the tests, the photoreceptor is visually checked for the presence or absence of deposit thereon. Thus tested, the photoreceptors are evaluated in three ranks; A (no deposit), B (a little deposit, at most about 30% of the entire surface), and C (much deposit, more than about 30% of the entire surface).

The cleanability of the photoreceptors is evaluated as follows: After the image formation tests for 20,000 copies in all, the photoreceptor is visually checked for the presence or absence of deposit thereon and for its influence on the image quality. Thus tested, the photoreceptors are evaluated in three ranks; A (neither deposit nor image defect), B (a little deposit and partial streaky defects, at most about 10% of the entire surface), and C (much deposit and many image defects in a broad range, more than about 10% of the entire surface).

Further, after the image formation tests for 20,000 copies, the copies are visually checked for the presence or absence of image defects, therein. Further, after the image formation tests for 20,000 copies, the photoreceptor is checked for the abrasion, and the unit abrasion per 1000 revolutions is computed. The results are given in Table 24.

TABLE 24

| | | | | | Abrasion | |
|---|---|---|---|---|---|---|
| | ΔV_{L} (V) | DDR (%) | Deposit | Cleanability | (nm/K cycle) | Image Quality |
| Example 4 | 28 | 7.9 | A | A | 1.9 | no defect |
| Example 5 | 30 | 7.7 | A | A | 1.7 | no defect |
| Example 6 | 29 | 8.0 | A | A | 1.5 | no defect |
| Example 7 | 20 | 7.6 | A | A | 1.3 | no defect |
| Comparative | 35 | 8.8 | A | B | 4.0 | streaky defects, |
| Example 5 | | | | | | density reduction |
| Comparative | 41 | 8.9 | A | B | 3.4 | streaky defects, |
| Example 6 | | | | | | density reduction |
| Comparative | 34 | 9.2 | B | B | 3.2 | streaky defects, |
| Example 7 | | | | | | black pepper |

The results in Table 24 obviously confirm that the electrophotographic photoreceptors of the invention (Examples 4 to 7) are better than the electrophotographic photoreceptors of Comparative Examples 5 to 7 in that the former effectively prevent the residual potential fluctuation and the dark decay in repeated charging and exposure and that the former are free from image defects. They further confirm that the electrophotographic photoreceptors of the invention (Examples 4 to 7) are also better than the electrophotographic photoreceptors of Comparative Examples 5 to 7 in that the former prevent deposit formation thereon in repeated image formation and have good cleanability. In addition, they further confirm that the electrophotographic photoreceptors of the invention (Examples 4 to 7) are better than the electrophotographic photoreceptors of Comparative Examples 5 to 7 in that the abrasion of the former is smaller than that of the latter.

The compound of formula (I) may serve as a charge-transporting compound in the electrophotographic photoreceptor, and even when alone, it may cure by itself when heated in the presence of an acid catalyst, and may exhibit stable electric properties. Accordingly, in the electrophotographic photoreceptor of the invention, since the photosensitive layer has a first functional layer of a cured product of a composition that contains the compound of formula (I), the photoreceptor may sufficiently prevent the fluctuation of the residual potential and the charging potential thereof while used for long and therefore may stably form images of good quality for a long period of time.

Preferably, the first functional layer is the outermost surface layer to be disposed remotest from the conductive support. When the first functional layer is the outermost surface layer, then the fluctuation of the charging potential of the photoreceptor used for long may be more sufficiently prevented and, owing to the curing of the compound of formula (I) therein, the photoreceptor may have better mechanical strength. Accordingly, the invention may provide an electrophotographic photoreceptor having a longer life and better abrasion resistance and capable of stably forming images of good quality for a long period of time.

In addition, when the outermost surface layer is a protective layer, then the compound of formula (I) therein may react with the reactive group of any other crosslinking resin in the protective layer to form a strong crosslinked structure, and therefore, both the electric properties and the abrasion resistance of the photoreceptor may be all bettered. On the other hand, even when the outermost layer is a charge transport layer, the compound of formula (I) that serves as a charge-transporting material therein is curable by itself; and when mixed with a conventional thermoplastic resin, then both the electric properties and the abrasion resistance of the photoreceptor may be all bettered.

Preferably, the compound of formula (I) is a compound of the following formula (II): 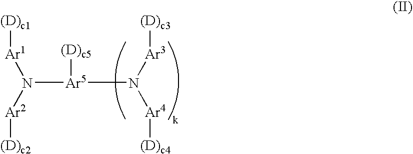
[In formula (II), Ar¹ to Ar⁴ each independently represent a substituted or unsubstituted aryl group; Ar⁵ represents a substituted or unsubstituted aryl or arylene group; c1, c2, c3, c4 an c5 each independently indicate 0 or 1; k indicates 0 or 1; D represents a monovalent organic group of the following formula (III); and the sum total of c1, c2, c3, c4 and c5 is from 1 to 4.]
-L-O—R (III)
[In formula (III), R represents a monovalent organic group; and L represents an alkylene group.]

When the photosensitive layer has a first functional layer of a cured product of a composition that contains the compound of formula (II), then the photoreceptor may more sufficiently prevent the fluctuation of the residual potential and the charging potential thereof while used for long and therefore may stably form images of good quality for a longer period of time. In addition, the mechanical strength of the first functional layer may be more sufficiently increased.

Preferably, the compound of formula (I) is a compound of the following formula (IV): 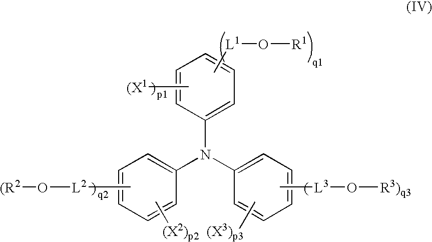
[In formula (IV), X¹, X² and X³ each independently represent a halogen atom, an alkyl group having from 1 to 10 carbon atoms, an alkoxyl group having from 1 to 10 carbon atoms, a substituted or unsubstituted aryl group, an aralkyl group having from 7 to 10 carbon atoms, a substituted or unsubstituted styryl group, a substituted or unsubstituted butadiene group, or a substituted or unsubstituted hydrazone group; R¹, R² and R³ each independently represent a monovalent organic group having from 1 to 18 carbon atoms; L¹, L² and L³ each independently represent an alkylene group; p1, p2 and p3 each independently indicate an integer of from 0 to 2; q1, q2 and q3 each independently indicate 0 or 1, satisfying (q1+q2+q3)≧1.]

When the photosensitive layer has a first functional layer of a cured product of a composition that contains the compound of formula (IV), then the photoreceptor may more sufficiently prevent the fluctuation of the residual potential and the charging potential thereof while used for long and therefore may stably form images of good quality for a longer period of time. In addition, the mechanical strength of the first functional layer may be more sufficiently increased.

Preferably in formula (IV), R¹, R² and R³ each independently represent a monovalent hydrocarbon croup having from 1 to 18 carbon atoms and optionally substituted with a halogen atom, or a group of —(CH₂)r-O—R4; R⁴ represents a hydrocarbon group having from 1 to 6 carbon atoms; and r indicates an integer of from 1 to 12. More preferably in formula (IV), R¹, R² and R³ each independently represent an alkyl group having from 1 to 4 carbon atoms, or a group of —(CH₂)r-O—R⁴; R⁴ represents a hydrocarbon group having from 1 to 6 carbon atoms; and r indicates an integer of from 1 to 12. Even more preferably, r is an integer offrom 1 to 4.

Containing the compound of formula (IV) that satisfies the above-mentioned conditions, the photoreceptor may more sufficiently prevent the fluctuation of the residual potential and the charging potential thereof while used for long and therefore may stably form images of good quality for a longer period of time. In addition, the mechanical strength of the first functional layer may be more sufficiently increased.

Preferably in formula (IV), L¹, L² and L³ are methylene groups. When L¹, L² and L³ are methylene groups therein, the compound of formula (IV) may cure more readily and may form a denser crosslinked structure. Accordingly, the photoreceptor may more sufficiently prevent the fluctuation of the residual potential and the charging potential thereof while used for long, and the mechanical strength of the first functional layer of a cured product of a composition that contains the compound of the type may be increased more significantly.

Also preferably in formula (IV), q1, q2 and q3 satisfy (q1+q2+q3)≧2. Satisfying the condition, the compound of formula (IV) may cure more readily and may form a denser crosslinked structure. Accordingly, the photoreceptor may more sufficiently prevent the fluctuation of the residual potential and the charging potential thereof while used for long, and the mechanical strength of the first functional layer of a cured product of a composition that contains the compound of the type may be increased more significantly. The compound of formula (IV) satisfying the condition may form a dense crosslinked structure by itself, even when alone. However, when the photosensitive layer containing it must be controlled in point of the film-forming property, the mechanical strength, the electric properties and the surface cleanability thereof, then the compound of the type may be more effectively mixed with any other compound of formula (IV) that satisfies (q1+q2+q3)≧1.

Preferably, the composition for the electrophotographic photoreceptor of the invention further contains a crosslinking resin. When the composition further contains a crosslinking resin, then the crosslinking resin may react and cure with the compound of formula (I) therein to form a further denser crosslinked structure, and therefore, the photoreceptor may more sufficiently prevent the fluctuation of the residual potential and the charging potential thereof while used for long and the mechanical strength of the first functional layer may be increased more significantly. Also in this case, when the photosensitive layer containing such a crosslinking resin must be controlled in point of the film-forming property, the mechanical strength, the electric properties and the surface cleanability thereof, then it is effective and desirable that any other compound of formula (I) is further mixed in the layer.

Preferably, the crosslinking resin is a phenolic resin or an epoxy resin. When the composition for the first functional layer contains such a crosslinking resin, then the crosslinking resin may react and cure with the compound of formula (I) therein to form a further denser crosslinked structure, and therefore, the mechanical strength of the layer may be increased more significantly. When containing a phenolic resin or an epoxy resin, the electrophotographic photoreceptor of the invention may more sufficiently prevent the fluctuation of the residual potential and the charging potential thereof while used for long.

Preferably, the composition for the electrophotographic photoreceptor of the invention further contains conductive particles. Accordingly, the increase in the residual potential of the photoreceptor while used for long may be more sufficiently prevented.

Preferably in the electrophotographic photoreceptor of the invention, the photosensitive layer has a second functional layer that contains a hydroxygallium phthalocyanine pigment having a maximum peak wavelength within a range of from 810 to 839 nm in its absorption spectrum within a wavelength range of from 600 to 900 nm.

Heretofore, various studies have been made for photoconductive substances usable in electrophotographic photoreceptors for improving the electrophotographic properties thereof. In particular, there are many reports relating to phthalocyanine compounds in point of the relationship between their crystal forms and electrophotographic properties. It is generally known that phthalocyanine compounds are grouped into some crystal forms depending on the difference in their production methods and treatment methods, and that phthalocyanine compounds have different photoelectric conversion properties depending on the difference in their crystal forms. Regarding the crystal forms of phthalocyanine compounds, for example, metal-free phthalocyanine crystals include α-type, β-type, π-type, γ-type and X-type crystal forms. In addition, there are also many reports relating to gallium phthalocyanine pigments in point of their crystal forms and electrophotographic properties. Of such hydroxygallium phthalocyanine pigments, those having a maximum peak wavelength within a range of from 810 to 839 nm in their absorption spectra within a wavelength range of from 600 to 900 nm may be applied to the electrophotographic photoreceptor of the invention. When the hydroxygallium phthalocyanine pigment of the type is applied to the electrophotographic photoreceptor of the invention, then it exhibits excellent properties as a photoconductive substance for the electrophotographic photoreceptor and may suppress the dark decay of the photoreceptor, and therefore the fluctuation of the charging potential of the photoreceptor thus comprising such a hydroxygallium phthalocyanine pigment may be low. As a result, the photoreceptor may ensure stable image quality for a lone period of time, capable of preventing various image defects such as fogging, black pepper, white spots, ghosts and density unevenness. The second functional layer that contains the above-mentioned specific hydroxygallium phthalocyanine pigment may be the same layer as the above-mentioned first functional layer, or may be different from it. When the pigment has plural peaks in its absorption spectrum within a wavelength range of from 600 to 900 nm, then the above-mentioned maximum peak wavelength of the pigment means the peak wavelength for the maximum absorbance of the plural peaks thereof.

Preferably, the hydroxygallium phthalocyanine pigment has diffraction peaks at a Bragg angle (2θ±0.2°) of 7.5°, 9.9°, 12.5°, 16.3°, 18.6°, 25.1° and 28.3° in the X-ray diffraction spectrum thereof with a CuKα characteristic X ray. When the hydroxygallium phthalocyanine pigment has the above-mentioned diffraction peaks and when it is in the second functional layer that constitutes the electrophotographic photoreceptor of the invention, then the dark decay of the photoreceptor may be lowered and therefore the fluctuation of the charging potential thereof is low. Accordingly, the photoreceptor may ensure stable image quality for a lone period of time, capable of more sufficiently preventing various image defects such as fogging, black pepper, white spots, ghosts and density unevenness.

Preferably in the electrophotographic photoreceptor of the invention that has the second functional layer containing the above-mentioned hydroxygallium phthalocyanine pigment, the absorption spectrum of the photosensitive layer has an absorption peak wavelength within a range of from 810 to 839 nm. Since the dark decay of the electrophotographic photoreceptor of the type may be lowered, the fluctuation of the charging potential thereof may be low, and therefore the photoreceptor may ensure stable image quality for a lone period of time, capable of more sufficiently preventing various image defects such as fogging, black pepper, white spots, ghosts and density unevenness.

The invention also provides a process cartridge comprising the above-mentioned electrophotographic photoreceptor of the invention, and at least one selected from a charging device for charging the electrophotographic photoreceptor, a developing device for developing an electrostatic latent image formed on the electrophotographic photoreceptor, with a toner to thereby form a toner image, and a cleaning device for removing the toner that remains on the surface of electrophotographic photoreceptor.

The invention further provides an image-forming apparatus comprising the electrophotographic photoreceptor of the invention, a charging device for charging the electrophotographic photoreceptor, an exposing device for exposing the charged electrophotographic photoreceptor to light to thereby form an electrostatic latent image thereon, a developing device for developing the electrostatic latent image with a toner to form a toner image, and a transfer device for transferring the toner image from the electrophotographic photoreceptor onto a transfer medium.

Since the process cartridge and the image-forming apparatus of the invention comprise the electrophotographic photoreceptor of the invention that has the above-mentioned excellent properties, they may stably form images of good quality for a long period of time.

The invention provides an electrophotographic photoreceptor capable of sufficiently preventing the fluctuation of the residual potential and the charging potential thereof while used for long and therefore capable of stably forming images of good quality for a long period of time, and provides a process cartridge and an image-forming apparatus comprising the photoreceptor.

The entire disclosure of Japanese Patent Application No. 2005-373131 filed on Dec. 26, 2005 including specification, claims, drawings and abstract is incorporated herein by reference in its entirety.

What is claimed is:

1. An electrophotographic photoreceptor comprising:
a conductive support; and
a photosensitive layer,
wherein the photosensitive layer comprises a first functional layer comprising
a cured product of a composition that contains a compound represented by formula (I):
F [symbol] L-O—R)ₙ (I)
wherein in formula (I), F represents a hole-transporting n-valent organic group;
R represents a monovalent organic group;
L represents an alkylene group; and
n indicates an integer of from 1 to 4.

2. The electrophotographic photoreceptor according to claim 1,
wherein the first functional layer is the outermost surface layer disposed remotest from the conductive support.

3. The electrophotographic photoreceptor according to claim 1,
wherein the compound represented by formula (I) is a compound represented by formula (II): 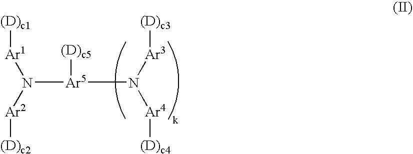
wherein in formula (II), Ar¹ to Ar⁴ each independently represents a substituted or unsubstituted aryl group;
Ar⁵ represents a substituted or unsubstituted aryl or arylene group;
c1, c2, c3, c4 and c5 each independently indicates 0 or 1;
k indicates 0 or 1;
D represents a monovalent organic group represented by formula (III); and
a sum total of c1, c2, c3, c4 and c5 is from 1 to 4:
-L-O—R (III)
wherein in formula (III), R represents a monovalent organic group; and
L represents an alkylene group.

4. The electrophotographic photoreceptor according to claim 1,
wherein the compound represented by formula (I) is a compound represented by formula (IV): 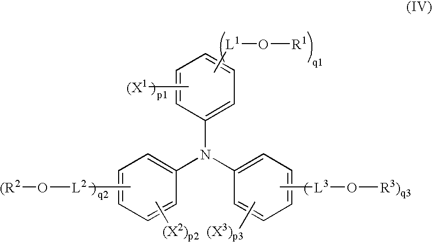
wherein in formula (IV), X¹, X² and X³ each independently represents a halogen atom, an alkyl group having from 1 to 10 carbon atoms, an alkoxyl group having from 1 to 10 carbon atoms, a substituted or unsubstituted aryl group, an aralkyl group having from 7 to 10 carbon atoms, a substituted or unsubstituted styryl group, a substituted or unsubstituted butadiene group or a substituted or unsubstituted hydrazone group;
R¹, R² and R³ each independently represents a monovalent organic group having from 1 to 18 carbon atoms;
L¹, L² and L³ each independently represents an alkylene group;
p1, p2 and p3 each independently indicates an integer offrom 0 to 2;
q1, q2 and q3 each independently indicates 0 or 1, satisfying (q1+q2+q3)≧1.

5. The electrophotographic photoreceptor according to claim 4,
wherein in formula (IV), R¹, R² and R³ each independently represents a monovalent hydrocarbon group having from 1 to 18 carbon atoms and optionally substituted with a halogen atom, or a group represented by —(CH₂)r-O—R⁴;
R⁴ represents a hydrocarbon group having from 1 to 6 carbon atoms; and
r indicates an integer of from 1 to 12.

6. The electrophotographic photoreceptor according to claim 4,
wherein in formula (IV), R¹, R² and R³ each independently represents a monovalent hydrocarbon group having from 1 to 4 carbon atoms, or a group represented by —(CH₂)r-O—R⁴;
R⁴ represents a hydrocarbon group having from 1 to 6 carbon atoms; and
r indicates an integer of from 1 to 12.

7. The electrophotographic photoreceptor according to claim 4,
wherein in formula (IV), L¹, L² and L³ are methylene groups.

8. The electrophotographic photoreceptor according to claim 4,
wherein in formula (IV), q1, q2 and q3 satisfy (q1+q2+q3)≧2.

9. The electrophotographic photoreceptor according to claim 1,
wherein the composition further contains a crosslinking resin.

10. The electrophotographic photoreceptor according to claim 9,
wherein the crosslinking resin is a phenolic resin or an epoxy resin.

11. The electrophotographic photoreceptor according to claim 1,
wherein the photosensitive layer further comprises a second functional layer that contains a hydroxygallium phthalocyanine pigment having a maximum peak wavelength within a range of from 810 to 839 nm in its absorption spectrum within a wavelength range of from 600 to 900 nm.

12. The electrophotographic photoreceptor according to claim 11,
wherein the hydroxygallium phthalocyanine pigment has diffraction peaks at a Bragg angle (2θ±0.2°) of 7.5°, 9.9°, 12.5°, 16.3°, 18.6°, 25.1° and 28.3° in a X-ray diffraction spectrum thereof with a CuKα characteristic X ray.

13. The electrophotographic photoreceptor according to claim 11,
wherein an absorption spectrum of the photosensitive layer has an absorption peak wavelength within a range of from 810 to 839 nm.

14. A process cartridge comprising:
an electrophotographic photoreceptor comprising:
a conductive support; and
a photosensitive layer,
wherein the photosensitive layer comprises a first functional layer comprising a cured product of a composition that contains a compound represented by formula (I); and
at least one selected from a charging device that charges the electrophotographic photoreceptor, a developing device that develops an electrostatic latent image formed on the electrophotographic photoreceptor with a toner to thereby form a toner image and a cleaning device that removes a toner that remains on a surface of the electrophotographic photoreceptor:
F [symbol] L-O—R)ₙ (I)
wherein in formula (I), F represents a hole-transporting n-valent organic group;
R represents a monovalent organic group;
L represents an alkylene group; and
n indicates an integer of from 1 to 4.

15. An image-forming apparatus comprising:
an electrophotographic photoreceptor comprising:
a conductive support; and
a photosensitive layer,
wherein the photosensitive layer comprises a first functional layer comprising a cured product of a composition that contains a compound represented by formula (I);
a charging device that charges the electrophotographic photoreceptor;
an exposing device that exposes a charged electrophotographic photoreceptor to light to thereby form an electrostatic latent image thereon;
a developing device that develops the electrostatic latent image with a toner to form a toner image; and
a transfer device that transfers the toner image from the electrophotographic photoreceptor onto a transfer medium:
F [symbol] L-O—R)ₙ (I)
wherein in formula (I), F represents a hole-transporting n-valent organic group;
R represents a monovalent organic group;
L represents an alkylene group; and
n indicates an integer of from 1 to 4.

16. The image-forming apparatus according to claim 15,
wherein the electrophotographic photoreceptor is fixed to a body of the image-forming apparatus, and at least one of the charging device and the developing device is detachable from the body.

17. The image-forming apparatus according to claim 15,
wherein the transfer device has an intermediate transfer medium.

18. The image-forming apparatus according to claim 15,
wherein the exposing device is a multi-beam surface-emitting laser.
